(19) United States
(12) Patent Application Publication
(10) Pub. No.: US 2018/0040064 A1
(43) Pub. Date: Feb. 8, 2018

(54) NETWORK-BASED AUTOMATED PREDICTION MODELING

(71) Applicant: Xero Limited, San Francisco, CA (US)

(72) Inventors: Alastair Grigg, Hamilton (NZ); Martin Kemka, Melbourne (AU)

(21) Appl. No.: 15/667,278

(22) Filed: Aug. 2, 2017

Related U.S. Application Data
(60) Provisional application No. 62/371,168, filed on Aug. 4, 2016.
(60) Provisional application No. 62/371,161, filed on Aug. 4, 2016.

(51) Int. Cl. G06Q 40/02; G06Q 20/10; H04L 12/24; G06N 5/04

(52) U.S. Cl. CPC G06Q 40/025; G06N 5/04; G06Q 20/10; H04L 41/147; H04L 41/145; G06F 3/0482

(57) ABSTRACT

Methods, systems, and computer programs are presented for generating action scores based on the performance of entities to determine action probabilities. One method includes an operation for accessing data comprising transactions exchanged between entities. The method further includes generating performance values for each entity based on the data, and generating, for each entity, an action score that is an indication of past performance of the entity with respect to the performance values. The method further includes receiving a request, from a user, for action probabilities regarding an event associated with a first entity, each action probability being a probability that another entity responds to the event within a predetermined time frame, determining related entities associated with the event, and determining the action probability for each entity based on the action score of the related entity. The action probabilities are presented within a graphical user interface.

### CLAIM OF PRIORITY

This application claims priority from U.S. Provisional Patent Application No. 62/371,161, filed Aug. 4, 2016, and entitled “Network-Based Automated Prediction Modeling,” and from U.S. Provisional Patent Application No. 62/371,168, filed Aug. 4, 2016, and entitled “Network-Based Automated Prediction Modeling,” all of which are herein incorporated by reference in their entirety.

### TECHNICAL FIELD

The present disclosure generally relates to network-based automated action and timing prediction based on transaction analysis.

### BACKGROUND

Computer systems may generate numerical representation models for an individual, group, or business. These numerical representation models may be used in determining whether to take an action in relation to the entity for which the numerical representation model was generated. However, these numerical representations usually lack context. Further, these representations lack predictive value for actions taken by the individual for which the numerical representation was generated, especially with respect to timing of actions taken by the individual. Therefore, there is still a need in the art to improve generation of predictive models capable of identifying probabilities of actions and probabilities of actions occurring with respect to identified periods of time.

### BRIEF DESCRIPTION OF THE DRAWINGS

Various ones of the appended drawings merely illustrate example embodiments of the present disclosure and cannot be considered as limiting its scope.

FIG. 1 is a block diagram depicting an example action history system, according to some embodiments.

FIG. 2 is a block diagram depicting an example history application framework for the action history system, according to some embodiments.

FIG. 3 is a block diagram depicting an example hosting infrastructure for the action history system, according to some embodiments.

FIG. 4 is a block diagram depicting an example data center system of the action history system, according to some embodiments.

FIG. 5A illustrates the calculation of action scores, according to some example embodiments.

FIG. 5B illustrates the calculation of action probabilities based on the action scores, according to some example embodiments.

FIG. 5C is a block diagram depicting an example client device for accessing the action history system, according to some embodiments.

FIG. 6 is a flowchart of an example method for generating action scores and determining action probabilities based on the action scores, according to some embodiments.

FIG. 7 is a graphical user interface presenting action probabilities, according to some embodiments.

FIG. 8A is a flowchart of an example method for generating action scores and determining action probabilities based on the action scores, according to some embodiments.

FIG. 8B is a flowchart of a method for suggested predictive invoice roll-up, according to some example embodiments.

FIG. 9 is a flowchart of an example method for generating action scores and determining action probabilities based on the action scores, according to some embodiments.

FIG. 10 is a flowchart of an example method for generating action scores and determining action probabilities based on the action scores, according to some embodiments.

FIG. 11A is an example network diagram of related entities, according to some embodiments.

FIG. 11B is a health cycle stability chart, according to some example embodiments.

FIG. 11C a trade cycle stability chart, according to some example embodiments.

FIG. 12 is a depiction of a score-generation algorithm, according to some embodiments.

FIG. 13 is an example graphical depiction of candidate action probabilities, according to some embodiments.

FIG. 14 is an example graphical depiction with a color-coded indication of the action probabilities, according to some embodiments.

FIG. 15 is an example graphical depiction of action probabilities using a histogram for weekly receivables, according to some embodiments.

FIG. 16 is an example graphical depiction of action probabilities showing weekly risk banded receivables, according to some embodiments.

FIG. 17 is an example graphical depiction of action probabilities showing weekly predicted receivables, according to some embodiments.

FIG. 18 is an example graphical depiction of action probabilities using a stacked histogram for high- and low-risk invoices, according to some embodiments.

FIG. 19 is an example graphical depiction of action probabilities for the total number of invoices, according to some embodiments.

FIG. 20 illustrates a flow of an example method of analyzing lines of credit in response to generating an action score, according to some embodiments.

FIG. 21 illustrates a flow of an example method for providing offers based on action scores, according to some embodiments.

FIG. 22 illustrates a flow of an example method for performing an assessment in response to generating an action score, according to some embodiments.

FIG. 23 illustrates a flow of an example method for enabling health and trade analysis of users of the action history system, according to some embodiments.

FIG. 24 illustrates a flow of an example method for trade credit use, according to some embodiments.

FIG. 25 illustrates a flow of an example method for providing dynamic terms based on the action score, according to some embodiments.

FIG. 26 illustrates a flow of an example for performing factoring and discounting, according to some embodiments.

FIG. 27 illustrates a flow of an example for performing dynamic monitoring, according to some embodiments.

FIG. 28 illustrates a flow of an example method for offering choices to the user, according to some embodiments.

FIG. 29 illustrates a flow of an example method for setting rules and triggers to display information to the user, according to some embodiments.

FIG. 30 is a flowchart of a method for generating action scores based on the performance of entities to determine action probabilities by these entities, according to some example embodiments.

FIG. 31 is a block diagram depicting an example data flow for interactions between the banking platform and the accounting platform, according to some embodiments.

FIG. 32 illustrates the process for training and using the machine-learning program, according to some example embodiments.

FIG. 33 is a block diagram of a machine in the example form of a computer system within which a set of instructions may be executed for causing the machine to perform any one or more of the methodologies discussed herein, according to some embodiments.

### DETAILED DESCRIPTION

Example methods, systems, and computer programs are directed to generating action scores based on the performance of entities to determine action probabilities by these entities. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Sales receipt forecasting is an important problem for many businesses, especially for small businesses where cash flow may be crucial to the survival and ongoing operation of the business. Unless the business is collecting payment at a point of sale (POS) (e.g., retail POS), the timeliness of invoice payment is a major factor in the business's cash flow and overall financial performance.

Small businesses typically only have the payment history of an account to forecast the probability of on-time payment from that account. If the business has limited or no sales history with a client, then it is difficult for the business to forecast when the bill would be paid. The business may check the credit score with a credit bureau, but credit reports are biased towards scoring for representing the risk of non-payment or default, rather than identifying the risk of late payment. For example, a company with an excellent credit report may still pay its creditors an average past thirty days overdue.

Embodiments allow users to obtain accurate forecasting for sales receipts based on the payment history of clients, where the payment history includes not only the payments made to the business, but also the payments made to other businesses. This is possible because an accounting platform, also referred to herein as an “action history system,” may provide metrics (referred to herein as “action scores”) regarding payment history for the customer.

Additionally, the metrics obtained regarding payment patterns by users may be used by financial institutions to provide borrowing opportunities to clients based on their estimated cash flow, including a risk assessment. One of the major issues for lending to small and medium businesses (SMB) is the cumbersome loan application process required by traditional banks. In addition, many SMBs are denied financing due to lack of complete and accurate data. From the financial institutions' viewpoint, SMBs can have high-risk profiles and require detailed application information to property quantify individual SMB risk. Financial institutions (FIs) are traditionally tough for lending to SMBs due to the difficult-to-asses risk and the limited data available to differentiate individual SMB performance. Further, because of the high volume and low value of SMB loans (relative to corporate lending), FIs look to automate the decision process by using credit risk assessment algorithms. Credit bureaus and credit data companies are a source of SMB data; however, access to SMB balance sheet and financial data is difficult to obtain by FIs.

Calculating the action score for a business is a complex operation because it requires consideration of the live financial situation of the business (e.g., outstanding invoices), and a track record for the businesses related to the financial situation (e.g., how often does a customer pay on time). Thus, analysis of past history must be performed, as well as a live analysis of financial data for multiple entities. The platform may analyze live data and track record for thousands or millions of users, so efficiency in the analysis and exchange of data is imperative to manage the large amount of data and entities.

Collecting the live data is made possible by setting network connections (including interfaces) for exchanging data between multiple servers (e.g., servers from the accounting platform, banks, lenders, and users). In addition, the interfaces must be configured to allow users to enable the different links. For example, the user must allow the accounting platform to share user information with a lender in order to allow the lender to provide loans based on the actual cash-flow needs of the user.

Traditional credit scores only paint an overall picture, created over a long period of time, of the history of companies paying bills on time. However, the action scores paint a live picture, of real-time data, based on the expected cash flow and other financial parameters (e.g., receivables of a customer), as well as the level of risk associated with the cash flow.

In some example embodiments, an accounting platform providing accounting services to businesses (including SMBs) is able to access up-to-date accounting data of a business and calculate metrics to determine the financial health of the SMB, and in particular an estimated cash flow. These metrics are very valuable to FIs looking to manage loan risk because these metrics provide an up-to-date view of the financial situation of the business.

In some embodiments, the methods and systems disclosed herein enable generation of action scores and action probabilities based on communications data, also referred to herein as transactions, that include payment history across a plurality of suppliers, performance of a user's customers, sales invoices, timeliness of payments received by the user, performance indicators, and other user information. The action score generated may be used to determine timeliness of interactions of a user based on communications data from the user, communications data from other similar users, or a combination thereof. In some embodiments, the methods and systems described herein may generate scores and indexes of timeliness of actions, performance values, and performance indicators for individuals, entities, markets, competing businesses, and the like.

The action scores generated by the present disclosure may vary over time to reflect changes in the health and status of a business, and do so much faster than traditional prediction mechanisms. Action scores and action probabilities generated by the system may be used to establish patterns of behavior prior to interactions between individuals, in order to assist in decision making, such as for offering lines of credit, increasing or decreasing lines of credit, verifying traditional credit scores, establishing interest rates on a line of credit, or any suitable combination thereof. The action scores and action probabilities may also enable early estimation and determination of credit worthiness of a business prior to a determination of credit worthiness using traditional credit scores.

Users may enable access by other users to the users' action scores and action probabilities generated by the methods and systems described herein. For example, the user may enable creditors, businesses, and individuals to have access, via the accounting platform, to the action scores of the user. In addition to the user having access to the action scores and enabling their dispersal, the user has access to the data used to generate the action scores and the manner in which the action scores are calculated.

In one aspect, a method includes operations for accessing, by one or more processors of an action history system and via a network connection, data stored on a database, the data comprising transactions exchanged between a set of entities. Additionally, the method includes an operation for generating, by the action history system, a set of performance values for each entity based on the data. For each entity of the set of entities, an action score is generated based on at least one performance value of the set of performance values, the action score being an indication of performance of the entity with respect to the set of performance values. Further, the method includes operations for receiving a request, from a user, for one or more action probabilities regarding an event associated with a first entity, each action probability being a probability that a second entity responds to the event associated with the first entity within a predetermined time frame, for automatically determining the related entities associated with the event, for automatically determining the action probability for each entity of the related entities, the action probability being determined based on the action score of the related entity, and for automatically causing presentation of the action probabilities within a graphical user interface (GUI) of a display device.

In another aspect, a system comprises a memory having instructions, and one or more computer processors. The instructions, when executed by the one or more computer processors, cause the one or more computer processors to perform operations comprising: accessing, by an action history system via a network connection, data stored on a database, the data comprising transactions exchanged between a set of entities; generating, by the action history system, a set of performance values for each entity based on the data; for each entity of the set of entities, generating an action score based on at least one performance value of the set of performance values, the action score being an indication of performance of the entity with respect to the set of performance values; receiving a request, from a user, for one or more action probabilities regarding an event associated with a first entity, each action probability being a probability that a second entity responds to the event associated with the first entity within a predetermined time frame; automatically determining the related entities associated with the event; automatically determining the action probability for each entity of the related entities, the action probability being determined based on the action score of the related entity; and automatically causing presentation of the action probabilities within a graphical user interface (GUI) of a display device.

In another aspect, a non-transitory machine-readable storage medium includes instructions that, when executed by a machine, cause the machine to perform operations comprising: accessing, by an action history system via a network connection, data stored on a database, the data comprising transactions exchanged between a set of entities; generating, by the action history system, a set of performance values for each entity based on the data; for each entity of the set of entities, generating an action score based on at least one performance value of the set of performance values, the action score being an indication of performance of the entity with respect to the set of performance values; receiving a request, from a user, for one or more action probabilities regarding an event associated with a first entity, each action probability being a probability that a second entity responds to the event associated with the first entity within a predetermined time frame; automatically determining the related entities associated with the event; automatically determining the action probability for each entity of the related entities, the action probability being determined based on the action score of the related entity; and automatically causing presentation of the action probabilities within a graphical user interface (GUI) of a display device.

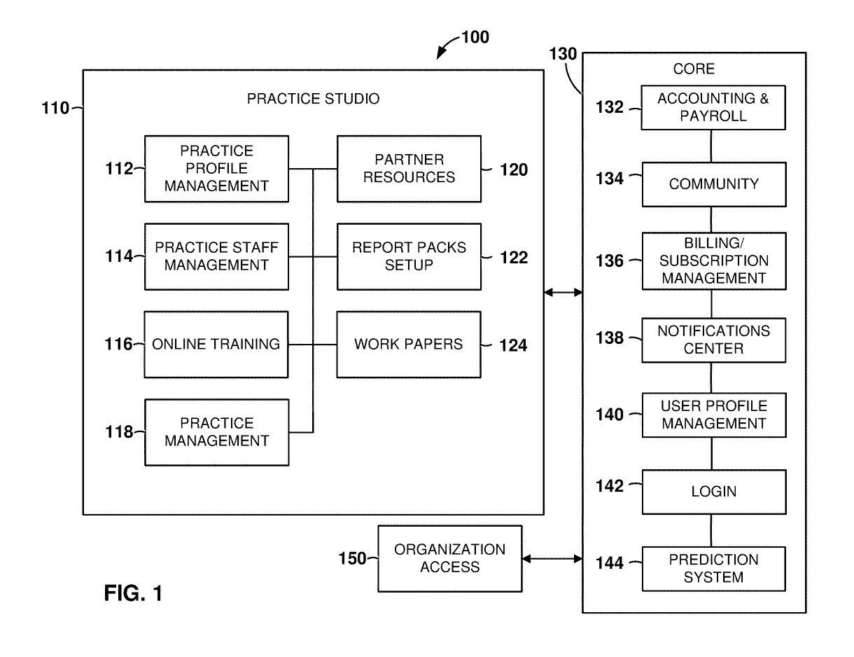

FIG. 1 is a block diagram depicting an example action history system 100, according to some embodiments. An action history system 100 may provide accounting tools to a particular entity that manages accounting for one or more businesses. The example action history system 100 may include a practice studio 110 that allows an entity to manage one or more businesses, and an organization access component 150 that provides a business with tools for managing accounting data for that particular business. The practice studio 110 may include a practice profile management component 112, a practice staff management component 114, an online training component 116, a practice management component 118, a partner resources component 120, a report packs setup component 122, and a work papers component 124. The practice studio 110 may be in communication with the core features 130. The core features 130 may include an accounting and payroll component 132, a community component 134, a billing/subscription management component 136, a notifications center component 138, a user profile management component 140, a login component 142, and a prediction system 144. The organization access component 150 may be in communication with the core features 130. The practice studio 110 and core features may be accessed by an entity using login component 142.

As shown in FIG. 1, features of the system 100 are divided into three areas based on the target user: the practice studio 110, the core features 130, and the organization access component 150. The practice studio 110 provides a suite of tools for accountants to interact with their clients and manage their practices. The core features 130 provide the core functionality and user tools common to both accountants and businesses. The organization access component 150 provides a user interface for individual businesses to access their data.

The practice studio 110 is the central login for accountants. For example, an accountant with multiple clients, each of which is a small business, may log in using practice studio 110 and gain access to the accounting data for the clients, messages from the clients, and so on.

The practice profile management component 112 allows an accounting practice to manage and view its profile settings. For example, an accounting practice may have a partner level (e.g., gold, silver, and bronze) representing the strength of its relationship with the provider for the action history system 100. The partner level may be based on the number of clients associated with the accounting practice in the action history system 100. For example, a bronze partner level may be assigned to accounting practices with at least 5 clients, a silver partner level assigned to accounting practices with at least 20 clients, and a gold partner level assigned to accounting practices with at least 100 clients. Additionally, the accounting practice may have one or more certifications provided by the action history system 100. The certifications may be provided automatically based on the completion of an online test and may expire after a predetermined period (e.g., one year) has elapsed. Other profile settings may include the name, address, telephone number, email address, and so forth of the accounting practice.

The practice staff management component 114 provides the ability for the manager of an accounting practice to control settings for the staff of the practice. For example, some staff members may have read-only access to data for certain clients, some staff members may have read-write access for certain clients, some staff members may be able to modify the access permissions for other staff members, and so on.

The online training component 116 provides training for accountants and their staff. In some cases, the provided training includes one or more video presentations and one or more online tests. Notification of passing a test at completion of a training may be provided. For example, a staff member may take a training course and, upon successful completion, the accountant supervising the staff member may receive a notification of the successful completion.

The practice management component 118 provides services for accountants. Access to the features provided by the practice management component 118 may be limited to accountants having a predetermined partner level with the action history system 100 provider. For example, access to the practice management component 118 may be limited to accountants at silver level or above. The services provided by the practice management component 118 may include workflow tools, customer relationship management (CRM) tools, lead generation tools, job management tools, invoice generation tools, and so forth.

The partner resources component 120 provides information regarding third-party partners. For example, a third party may provide tools that interact with the system 100 to provide useful functionality beyond that of the system 100 alone. The user may access the partner resources component 120 to learn about available third-party tools. For example, links to third-party websites, documentation, videos, and search tools may all be provided.

The report packs setup component 122 provides tools to allow accountants to create and generate standardized sets of reports. For example, a profit and loss statement and quarterly report could both be added to a pack. The accountant would then be able to easily generate both reports for any selected client or generate the reports for every client.

The work papers component 124 provides tools for accountants to interactively create financial reports. For example, an accountant may enter known data for a client into the work paper and then send the work paper to the client with an indication of data needed from the client. After the client enters the missing data into the work paper, the accountant may complete the report.

The core features 130 include components that are used both by accountants and organizations. The accounting and payroll component 132 provides the general ledger for organizations. The general ledger may be integrated with the organization's payroll, bypassing the separate step of entering payroll data into the general ledger each pay period. The general ledger may also be integrated with the organization's invoicing operations (e.g., an automated or semi-automated invoicing model configured to generate and transmit customer invoices), bypassing steps of entering invoicing data into the general ledger upon generation of the invoice. The accounting and payroll component 132 accesses banking data for each client business. The banking data may be imported either through a bank feed or a user- or accountant-created document. The accounting and payroll component 132 may also communicate with third-party tools via an application protocol interface (API). For example, banking data may include indications of funds transferred into an account of the user in fulfillment of a loan agreement and subsequent funds dispersal. The banking data may also include outgoing transactions and payments made from the user's bank account. In some embodiments, the banking data is imported periodically, at predetermined time intervals, or may be imported upon request by the user or one of the components of the action history system 100. In some instances, the banking data may be imported in real time such that when a transaction posts to the bank account of the user, the banking data is automatically imported or otherwise transferred to the accounting and payroll component 132. Upon receipt, the banking data may be passed to or otherwise stored on a database and made available to one or more components described herein.

The community component 134 provides a forum through which users may communicate. For example, a user with a question may post a topic in the forum and later receive a helpful response from another user. Information taken from the user profile (e.g., the user profile managed via the user profile management component 140) may appear along with forum posts by the user. For example, a user name, an image of the user, and the user's status as an accountant or member of an organization may each be shown.

The billing/subscription management component 136 allows a user to configure one or more billing accounts for each organization using the system 100. The system 100 may periodically charge a subscription fee for access (e.g., a monthly or annual subscription fee). The subscription fee may be automatically deducted from the one or more billing accounts.

The notifications center component 138 provides notifications to users. For example, users may send messages to each other, which appear as notifications. Notifications may also be created by the system 100 (e.g., by the accounting and payroll component 132) based on events. For example, a minimum account balance for a particular bank account may be set by a user via the accounting and payroll component 132. When the balance for that bank account drops below the minimum account balance, an automatic notification may be generated by the system 100 to inform the user.

The user profile management component 140 allows a user to manage the profile of the user's organization and the profiles of others based on permission settings. For example, an accountant may have permission to manage the profiles of the accountant's clients. The profile may include public-facing information such as a business name and address, and some other information.

The login component 142 verifies the identity of a user logging into the system 100 (e.g., via user name and password). Based on the user's identity, a user interface is presented that includes a list of organizations that a user has access to. For most small business clients, the list will consist of a single organization.

A prediction system 144 enables generation of an action score based on outward and inward communications data entered into the action history system 100. The prediction system 144 may interact with the accounting and payroll component 132, the billing/subscription management component 136, and the notifications center component 138, for example, to perform data processing operations on data corresponding to inflow and outflow financial transactions, as will be explained below in more detail.

The organization access component 150 accesses the core features 130 for a single organization. The organization access component 150 presents, after user verification by the login component 142, a user interface with options for a single organization without the additional features used only by the practice studio 110.

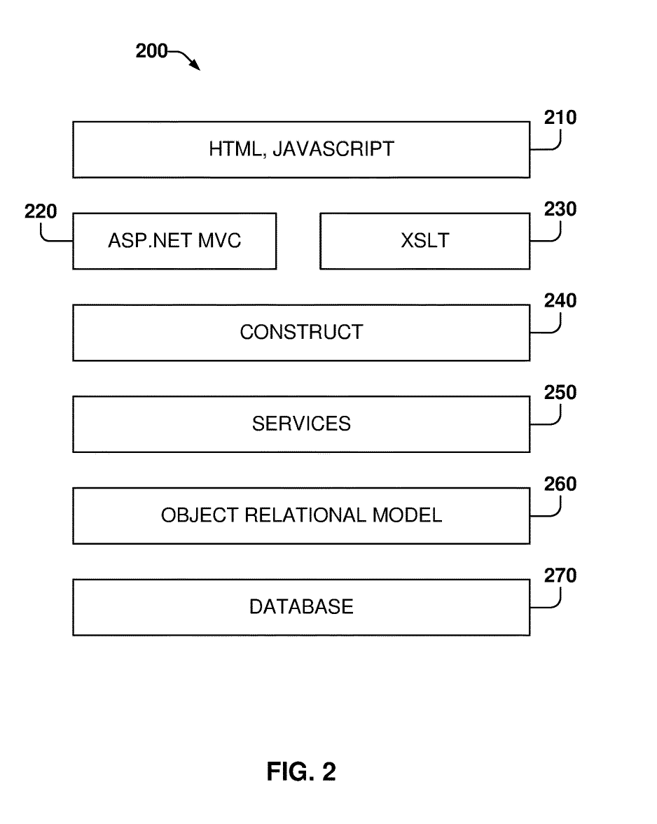

FIG. 2 is a block diagram depicting an example history application framework 200 for the action history system 100, according to some embodiments. The history application framework 200 may be an end-to-end web development framework enabling a “software as a service” (SaaS) product. The history application framework 200 may include a hypertext markup language (HTML) and/or JavaScript layer 210, ASP.Net Model-View-Controller (MVC) 220, extensible stylesheet language transformations (XSLT) 230, construct 240, services 250, object relational model 260, and a database 270.

The HTML and/or JavaScript layer 210 provides client-side functionality, such as UI generation, receipt of user input, and communication with a server. The client-side code may be created dynamically by the ASP.NET MVC 220 or the XSLT 230. Alternatively, the client-side code may be statically created or dynamically created using another server-side tool.

The ASP.Net MVC 220 and XSLT 230 provide server-side functionality, such as data processing, web page generation, and communication with a client. Other server-side technologies may also be used to interact with the database 270 and create an experience for the user.

The construct 240 provides a conduit through which data is processed and presented to a user. For example, the ASP.Net MVC 220 and XSLT 230 may access the construct 240 to determine the desired format of the data. Based on the construct 240, client-side code for presentation of the data is generated. The generated client-side code and data for presentation is sent to the client, which then presents the data.

The services 250 provide reusable tools that may be used by the ASP.Net 220, the XSLT 230, and the construct 240 to access data stored in the database 270. For example, aggregate data generated by calculations operating on raw data stored in the database 270 may be made accessible by the services 250.

The object relational model 260 provides data structures usable by software to manipulate data stored in the database 270. For example, the database 270 may represent a many-to-one relationship by storing multiple rows in a table, with each row having a value in common. By contrast, the software may prefer to access that data as an array, where the array is a member of an object corresponding to the common value. Accordingly, the object relational model 260 may convert the multiple rows to an array when the software accesses them and perform the reverse conversion when the data is stored.

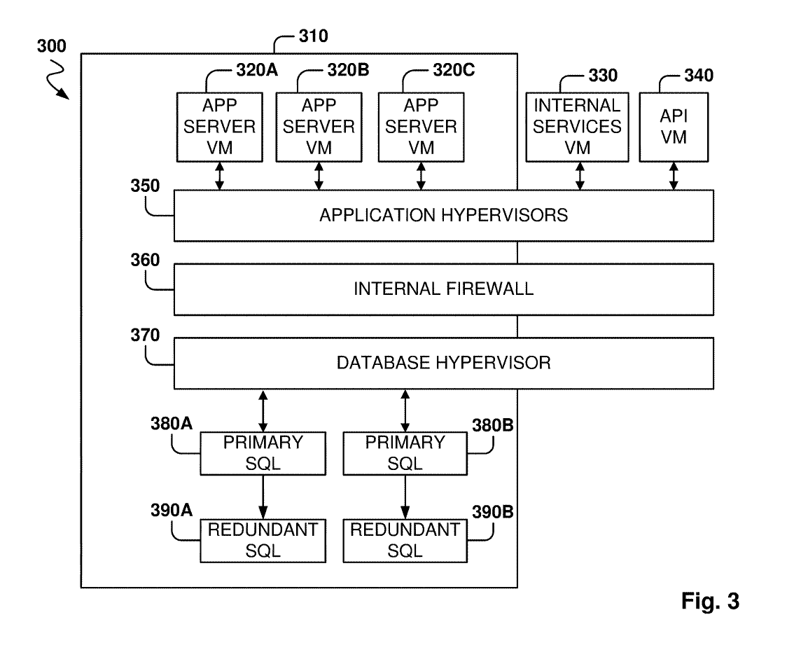

FIG. 3 is a block diagram depicting an example hosting infrastructure 300 for the action history system 100, according to some embodiments. The infrastructure 300 may be implemented using one or more pods 310. Each pod 310 includes application server virtual machines (VMs) 320 (shown as application server virtual machines 320a-320c in FIG. 3) that are specific to the pod 310 as well as application server virtual machines that are shared between pods 310 (e.g., the internal services VM 330 and the application protocol interface (API) VM 340). The application server virtual machines 320-340 communicate with clients and third-party applications via a web interface or an API. The application server virtual machines 320-340 are monitored by application hypervisors 350. In some example embodiments, the application server virtual machines 320a-320c and the API VM 340 are publicly-accessible while the internal services VM 330 is not accessible by machines outside of the hosting infrastructure 300. The app server VMs 320a-320c may provide end-user services via an application or web interface. The internal services VM 330 may provide back-end tools to the app server VMs 320a-320c, monitoring tools to the application hypervisors 350, or other internal services. The API VM 340 may provide a programmatic interface to third parties. Using the programmatic interface, the third parties may build additional tools that rely on the features provided by the pod 310.

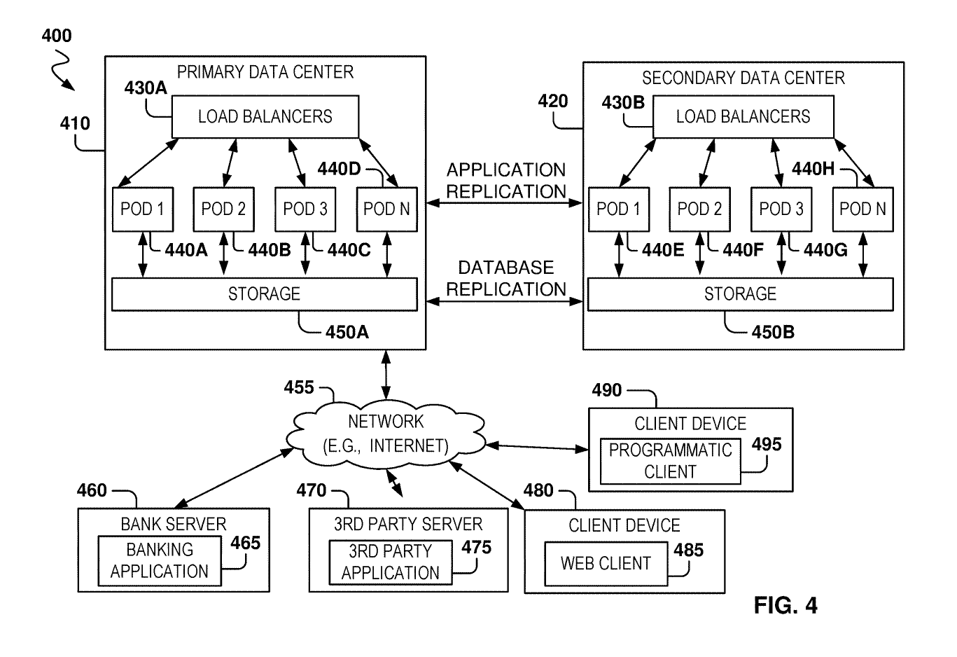

The internal firewall 360 ensures that only approved communications are allowed between the database hypervisor 370 and the publicly-accessible virtual machines 320-340. The database hypervisor 370 monitors the primary SQL servers 380a and 380b. The primary SQL servers 380a and 380b access the shared storage layer 450a or 450b (shown in FIG. 4) to read and write data generated by or used by the application server virtual machines 320-340. The redundant SQL servers 390a and 390b provide backup functionality for the primary SQL servers 380a and 380b, respectively. For example, the redundant SQL servers 390a and 390b may backup banking data (e.g., financial transactions associated with a bank account of a user), invoicing data (e.g., invoices, amounts, contact information for customers), payment data (e.g., received payments or indications of payments), information for active loans including terms of the loan, loan products available to the user, available loan products offered by a financial institution available to customers through the user, and other suitable data described herein.

The virtual machines 320-340 may be implemented using Windows 2008 R2, Windows 2012, or another operating system. The application and support servers supporting the virtual machines 320-340 may be built using spares for redundancy. The support servers may be shared across multiple pods 310. The application hypervisors 350, internal firewall 360, and database hypervisor 370 may span multiple pods 310 within a data center. In some example embodiments, each primary SQL server 380 and redundant SQL server 390 is configured to support 30,000-45,000 organizations. Accordingly, in embodiments using two such server pairs per pod 310, the pod capacity is 60,000-90,000 organizations. The redundant SQL servers 390 may take advantage of the “always on” resilience feature of SQL 2012.

FIG. 4 is a block diagram depicting an example data center system 400 of the action history system 100 interacting with other systems over a network, according to some embodiments. The primary data center 410 services customer requests and is replicated to the secondary data center 420. The secondary data center 420 may be brought online to serve customer requests in case of a fault in the primary data center 410. The primary data center 410 communicates over a network 455 with bank server 460, third-party server 470, client device 480, and client device 490. The bank server 460 provides banking data (e.g., via the banking application 465). The third-party server 470 is running third-party application 475. Client devices 480 and 490 interact with the primary data center 410 using web client 485 and programmatic client 495, respectively.

Within each data center 410 and 420, a plurality of pods, such as the pod 310 of FIG. 3, are shown. The primary data center 410 is shown containing pods 440A-440D. The secondary data center 420 is shown containing pods 440E-440H. The applications running on the pods 440A-440D of the primary data center 410 are replicated to the pods 440E-440H of the secondary data center 420. For example, EMC replication (provided by EMC Corporation) in combination with VMW or site recovery manager (SRM) may be used for the application layer replication. The database layer handles replication between the storage layer 450a of the primary data center 410 and the storage layer 450b of the secondary data center 420. Database replication provides database consistency and the ability to ensure that all databases are at the same point in time.

The data centers 410 and 420 use load balancers 430A and 430B, respectively, to balance the load on the pods within each data center. The storage 450 may be implemented using one or more EMC VNX storage area networks.

The bank server 460 interacts with the primary data center 410 to provide bank records for bank accounts of the client. Bank records may include payments from an account (e.g., outward transactions), receipts into the account (e.g., inward transactions), fund dispersals from financial institutions (e.g., incoming loan funds), late payment indications, overdraft indications, interest accrual, or any other suitable bank record. For example, the client may provide account credentials to the primary data center 410, which the primary data center 410 uses to gain access to the account information of the client. The bank server 460 may provide the banking records to the primary data center 410 for later reconciliation by the client using the client device 480 or 490.

The third-party server 470 may interact with the primary data center 410 and the client device 480 or 490 to provide additional features to a user of the client device 480 or 490. For example, a user may authorize the third-party server 470 to access the user's data stored in the primary data center 410. The third-party application 475 of the third-party server 470 may use the user's data to generate reports, provide macros, or otherwise improve the user's ability to access or manipulate the user's data. The third-party application 475 may communicate with the primary data center 410 via the network 455 using an API. The third-party application 475 may communicate with the client device 480 or 490 using a web or programmatic interface.

Calculating the action scores requires highly efficient, scalable, and cloud-based solutions that are manageable (e.g., centrally controlled by the action history system). The action history system must control the interactions among the different servers (e.g., data center servers, client server, bank servers, and third-party servers, such as financial institutions offering loans to users of the action history system) and analyze the data for thousands or millions of users.

The action history system also keeps track of the historical performance of the different users and other third parties, such as the probability of paying bills on time. Additionally, the action history system collects data from the bank servers (e.g., payments) and shares information with third parties that the user has enabled for access. This allows the third-parties to track, in real time, the user's financial performance and the ability to detect the short-term needs of users. Thus, the financial institutions are able to provide financial instruments to users (e.g., short-term loans) as well as tracking the performance of those loans. The financial institution may detect a potential problem with the loan of a user without having to wait for the user's default. This way, the financial institution is able to quickly react to critical situations and manage response accordingly.

The action history system algorithms are able to gather and process large amounts of information to provide valuable information to users and their financial partners. Further, the action history system provides mechanisms for communicating the action scores to the user and the user's partners.

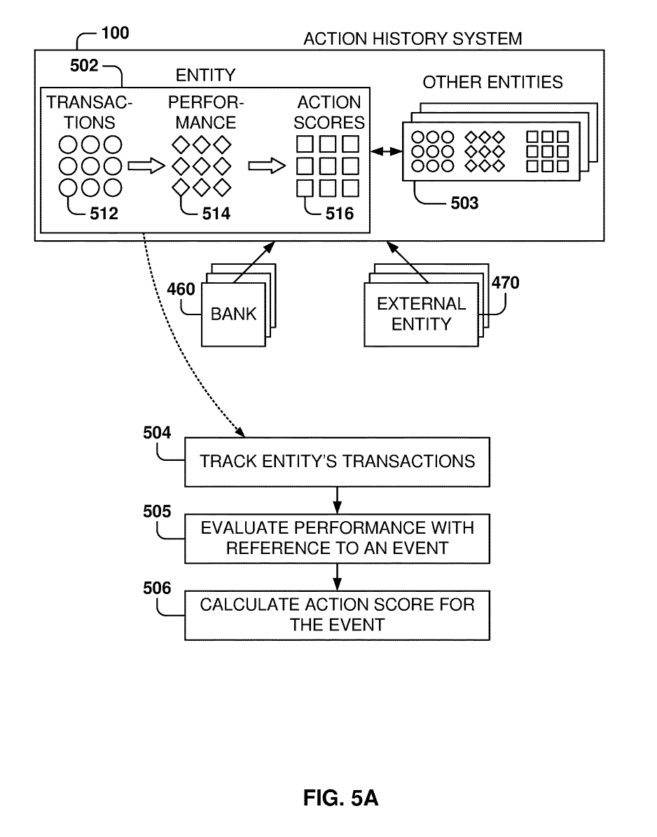

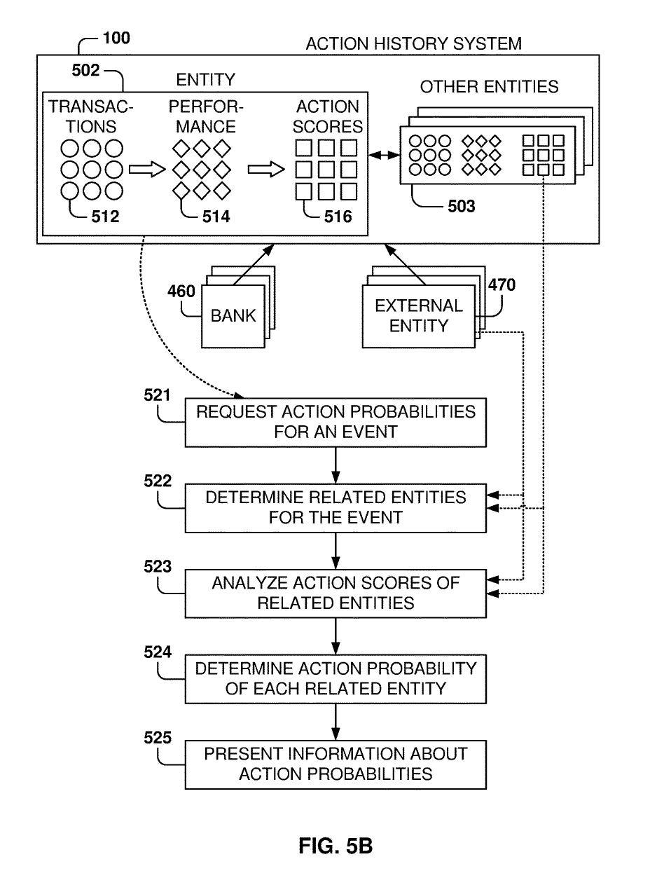

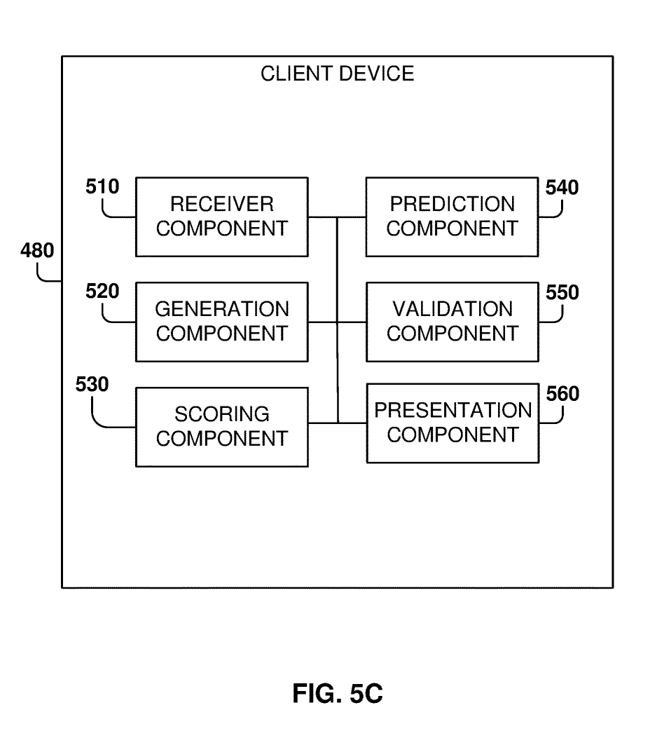

FIG. 5A illustrates the calculation of action scores, according to some example embodiments. In some example embodiments, the action history system 100 tracks the entities 502 and 503 to analyze the entities' performance and generate action scores. The action score is a value that provides an indication of the past performance of the entity with respect to the set of performance values. For example, the action history system 100 may track payment history of the entity to generate an action score that measures average time for paying invoices, percentage of times that invoices are paid after 30 days (or some other time), percentage of times that invoices are paid after 60 days, or other performance values.

The action history system 100 may track incoming payments for an entity and generate action scores to determine the average time for receiving payment, percentage of times that invoices go unpaid, percentage of times that payments are received after 30 days, etc.

In some example embodiments, the system 100 tracks the entity's transactions 512, both outward and inward communications, flowing from an account associated with the entity to other accounts and to communications initiated and sent by the entity. Further, the action history system 100 may also track interactions with bank servers 460 or other financial institutions, and other third-party servers 470, such as sellers and buyers that are not part of the action history system 100.

At operation 504, the action history system 100 tracks the transactions related to the entities 502, 503 in the system 100. From operation 504, the method flows to operation 505, where the performance of the transactions 512 are evaluated to generate performance metrics for each of the entities (e.g., how many invoices are paid on time by the entity in one month, how many invoices are paid by other entities to the entity in one month). In particular, some performance metrics may be generated based on a type of event (e.g., account receivables or account payables).

From operation 505, the method flows to operation 506 to calculate the action score 516 based on the specific event and the evaluated performance metrics 514. The action scores 516 may then be utilized to predict expected performance for current unfinished transactions and future transactions, as described in more detail below with reference to FIG. 5B.

In some embodiments, a network predictive cash flow (NPC) is an action score utilized to assess the future cash flow for the entity. The NPC predicts the sales cash flow of the entity, and in particular, the incoming cash resulting from sales of the entity.

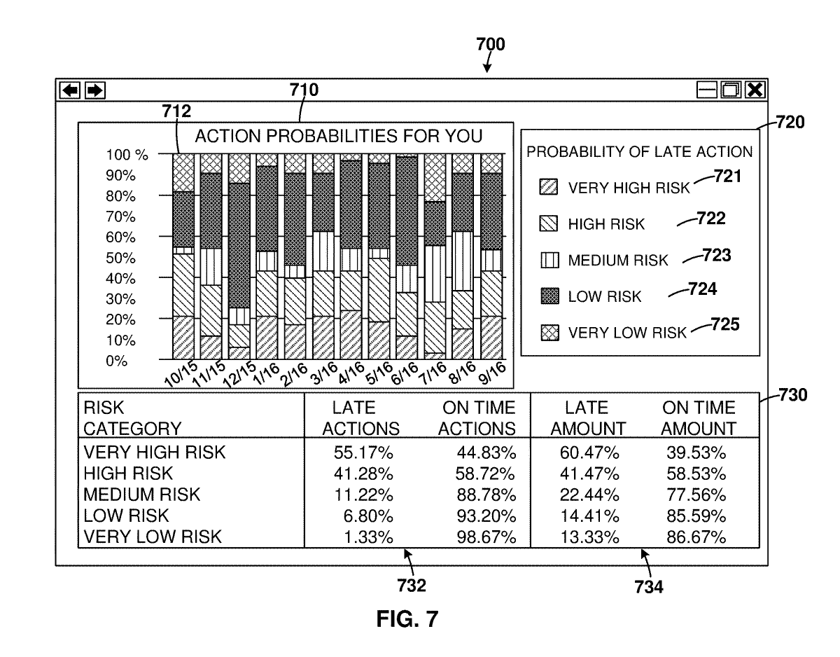

In some example embodiments, the accounting platform, or action history system 100 herein, provides an accounts-receivable report showing the status of sales invoices, including the historical payment performance for the buyer. The report indicates the historical sales payment behavior for the partners of the entity, and this historical data may be used to predict payment performance. One example report is described below with reference to FIG. 7. The NPC is an action score based on a predictive model that utilizes a network view of contact payments in order to predict the likelihood of late payments.

The NPC predictive model allows accountants and executives of the entity to set parameters and triggers for their clients as related to payments, for example, to predict when a client is going to be late with a payment and send an alert in order to take early action to try to avoid the late payment, such as by establishing a payment plan with the client.

Additionally, the NPC may be tracked over time to provide insights on the health of the sales receipts, and it may allow financial institutions to assist the entity with loans to cover late payments. In addition, the NPC may assist the entity to negotiate better terms with a financial institution by showing the history of the NPC and how the expected sales cash flow may be of low risk.

Another action score is the invoice trade score (ITS), which is generated by a predictive statistical model that looks at the payment performance of sales contacts (sales invoice recipients) across all platform customer organizations, e.g., a network view of sales invoice trade lines between platform customer organizations. An average score of each invoice score, across all the current accounts receivable (AR) invoices, weighted by debtor (invoice) values, provides an overall measure of that entity's receivables payment risk, as well as risk to the business cash flow and general financial stability.

There are several potential use cases for the ITS. First, there is a ‘smart’ AR report, which provides time-phased receivables cash flow values using invoice trade score to predict payment timing rather than simply the invoice due date. Second, there is extending the platform development API end-points to include the ITS as an additional attribute of each sales invoice, which can then be retrieved by authorized lending partners, along with an entity's accounting data to be used in their loan application risk assessment/approval for lending decision-making.

It is noted that the unique access and management of accounting data, by the accounting platform, enables better loan decisions and negotiations with financial institutions. For example, outside credit agencies do not have the network view on sales invoice payment performance that the platform can generate from its multi-tenant database of accounting data. Credit bureaus compile business bill payment performance across large billers (e.g., utilities and trade suppliers), but credit bureaus do not have the detailed information on the trading network as provided by the accounting platform.

Further, the credit bureau's credit scores are also sensitive to very late payments (more than 90 days), or non-payments (e.g., default), as grading bureaus look after score creditworthiness, not payment timeliness and the impact this might have on a business' cash flow.

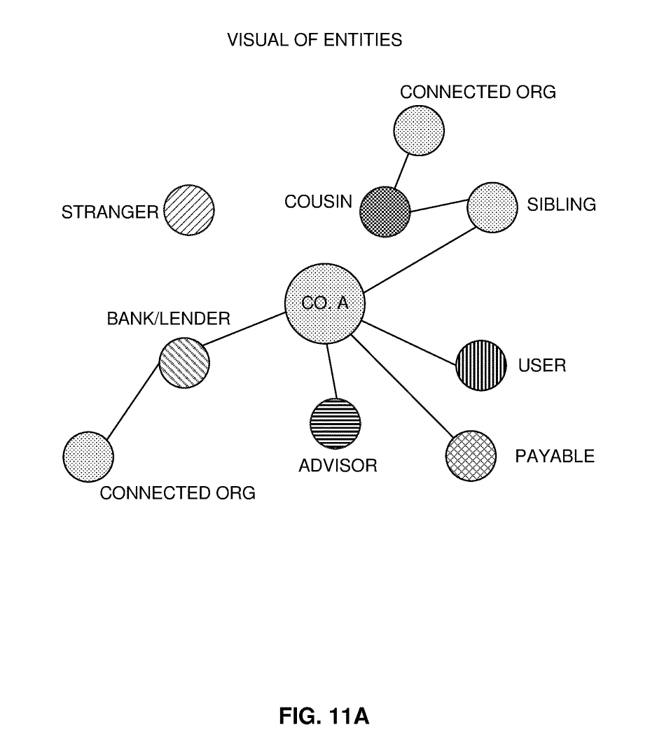

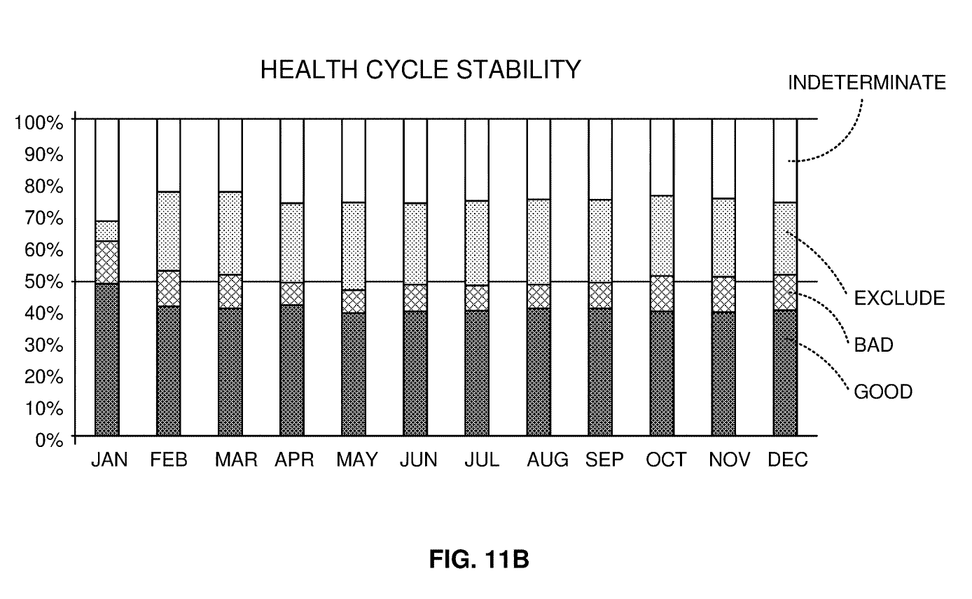

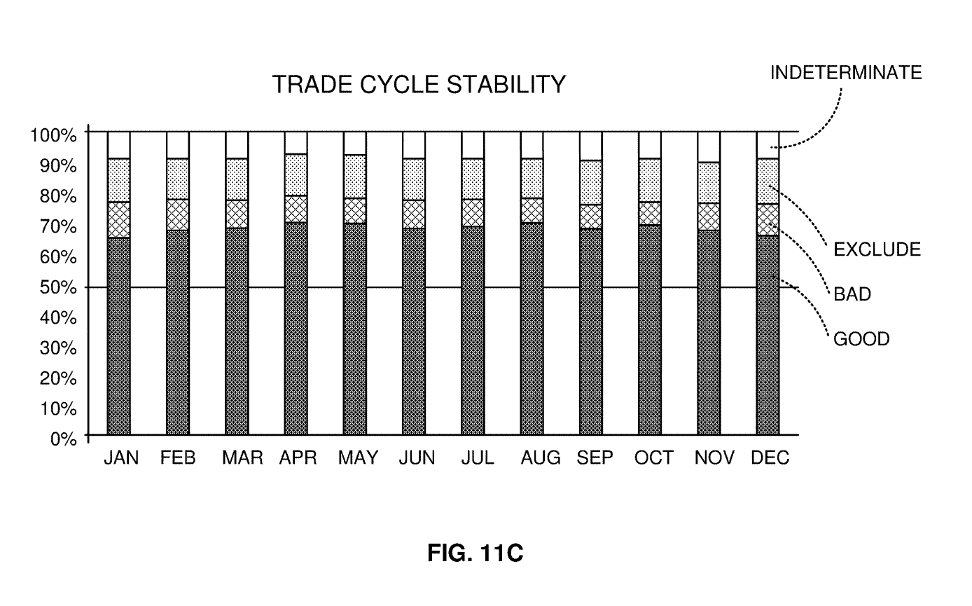

Another action score is the health action score (HAS), which is built on the transactions with direct entities (e.g., siblings of the entity, as described below in more detail with reference to FIG. 11A). The HAS predicts the probability that the entity will have a revenue below a predetermined threshold for a predetermined amount of time, e.g., the entity having three consecutive months of zero revenue, although other time periods and revenue thresholds may be utilized.

There may be several indications that a sibling company is in bad health, such as if the sibling stops trading with orders on hand, the sibling stops paying staff, the sibling stops paying taxes, or the sibling engages in an extraordinary high amount of transactions with directors of the company.

FIG. 5B illustrates the calculation of action probabilities based on the action scores, according to some example embodiments. At operation 521, a request is received to calculate action probabilities with reference to a given event. For example, the request may be to calculate action probabilities with reference to account receivables, where action probabilities indicate the probability that an action associated with the event (e.g., payment) takes place.

From operation 521, the method flows to operation 522, where a determination is made regarding the entities that are related to the event (e.g., payers with outstanding invoices). The entities may be other entities within the action history system 100, bank servers 460, or other third-party servers 470 (e.g., customers or suppliers).

At operation 523, one or more action scores are analyzed and calculated with regards to the related entities. In some example embodiments, the action scores may include the NPC, the HAS, and the ITS.

At operation 524, the action probabilities are calculated with reference to each related entity. In some example embodiments, the action is that payment is received within 30 days from invoice, but other time periods may be utilized. For example, other thresholds such as 15 or 45 days may be utilized if different levels of risk may be desired for assessment.

It is noted that determining if an entity is going to pay after 30 days is different from other traditional measurements that focus on payment or nonpayment (e.g., default). Thus, a traditional credit score may not help in assessing the risk of sales cash flow.

In some example embodiments, the action scores may be based on different parameters, or a combination thereof, such as invoice amount, invoice terms, number of invoices with one entity, abridged value of invoice, minimum value of invoices, maximum value of invoices, number of unpaid invoices, average payment terms, average payment performance, number of connections of the entity, number of changes in the connections over time, or distribution of sales volume by connection.

In some example embodiments, weights may be utilized to combine performance metrics and calculate weighted averages of these performance metrics. At operation 525, the information about the action probabilities is presented to a user.

FIG. 5C is a block diagram 500 illustrating components of a client device 480 or one of the components of the action history system 100 suitable for performing actions associated with the prediction system 144, according to some example embodiments. The client device 480 is shown as including a receiver component 510, a generation component 520, a scoring component 530, a prediction component 540, a validation component 550, and a presentation component 560, configured to communicate with each other (e.g., via a bus, shared memory, or a switch).

The receiver component 510 accesses a set of outward communication data and a set of inward communication data (e.g., transactions). The outward communication data may include financial transactions flowing from an account associated with a user to another account. The inward communication data may include financial transactions flowing into the account associated with the user from third parties. The financial transaction data may be received by the receiver component 510 via manual entry by the user, sets of invoices received from third-party systems (e.g., banks, creditors, customers, and the like), or any other suitable method. In some embodiments, the financial transaction data is received automatically by the receiver component 510 from a financial institution, a customer of a user of the action history system 100, a third party, or any other system integrated or otherwise in network communication with the action history system 100.

The generation component 520 generates performance values based on the outward and the inward communication data. The performance values may correspond to performance indicators or key performance indicators for a user, a vendor, a creditor, or any other suitable entity, as explained in more detail below. The performance values may indicate patterns of behavior, actions, timing of actions, or other suitable information for use in generating action scores and action probabilities.

The scoring component 530 generates an action score based on a performance value of the set of performance values. In some instances, the scoring component 530 incorporates at least a portion of the outward communication data and the inward communication data to generate the action score. For example, the scoring component 530 may generate the score based on a payment history for a business across all suppliers, the performance of customers of the vendor's business, the sales invoices generated and payment of the sales invoices by customers, or other suitable information indicative of the set of performance values.

The prediction component 540 generates predictions based on the performance values and action scores. The prediction component 540 may receive the performance values from the generation component 520 and the action scores from the scoring component 530. The set of predictions may be generated from the value of user or vendor data (e.g., ratios), the outward communications data, the inward communications data, or any suitable combination thereof. The set of predictions may be generated to model certain aspects or assumptions regarding behaviors of the user. For example, in some instances, the set of predictions may identify the vendor's predicted cash flow. The set of predictions may be used to trial different combinations of data entered into the action history system 100 for the vendor. In some embodiments, at least a portion of the predictions are generated as a set of action probabilities that indicate the probabilities that the user will perform respective actions (e.g., pay an invoice, pay a bill). In some instances, the action probabilities include a timing element that indicates the probability that the user will perform an action within a predefined time frame.

The validation component 550 validates the action scores by verifying the set of predictions (e.g., action probabilities) based on data indicative of prior financial transaction trends. The validation component 550 verifies the action score using data from previously entered outward communications data and inward communications data to test the quality of predictions. In some instances, the previously entered outward and inward communications data may include communications data for a user or set of users other than the user for which the action score was generated. In these instances, the validation component 550 may access and use previously entered sets of outward and inward communications data which is determined to be similar to the outward and inward communication data of the user for which the action score is generated. The previously entered communications data may be from a user who has been determined to be similar to the user for which the action score is generated.

The validation component 550 may perform the validation by determining whether one or more of the performance values, the previously entered set of outward communication data, and the previously entered set of inward communication data correspond to a model for expected values as depicted by the set of predictions (e.g., action probabilities). In some instances, the validation component 550 employs one or more statistical analysis methods to validate the action score. Further, in some embodiments the validation component 550 may validate the action score by verifying the set of predictions (e.g., action probabilities) for each additional set of outward communications data and set of inward communications data entered into the action history system 100 by the user.

The presentation component 560 causes presentation of one or more of the action score and the action probability on a user interface. The presentation component 560 may cause presentation of the action score and the action probability by displaying the action score and the action probability on a screen of a machine, transmitting the action score and the action probability to a machine with which the presentation component 560 is in communication, or any other suitable fashion. In some example embodiments, the presentation component 560 causes presentation of a risk of a specified action not being performed by the user, for which the action score was generated, in a specified time frame or period. The presentation component 560 may also cause presentation of health or performance aspects relating to outward and inward communication data for the user associated with the user interface on which the action scores, action probabilities, and risk indications are being presented.

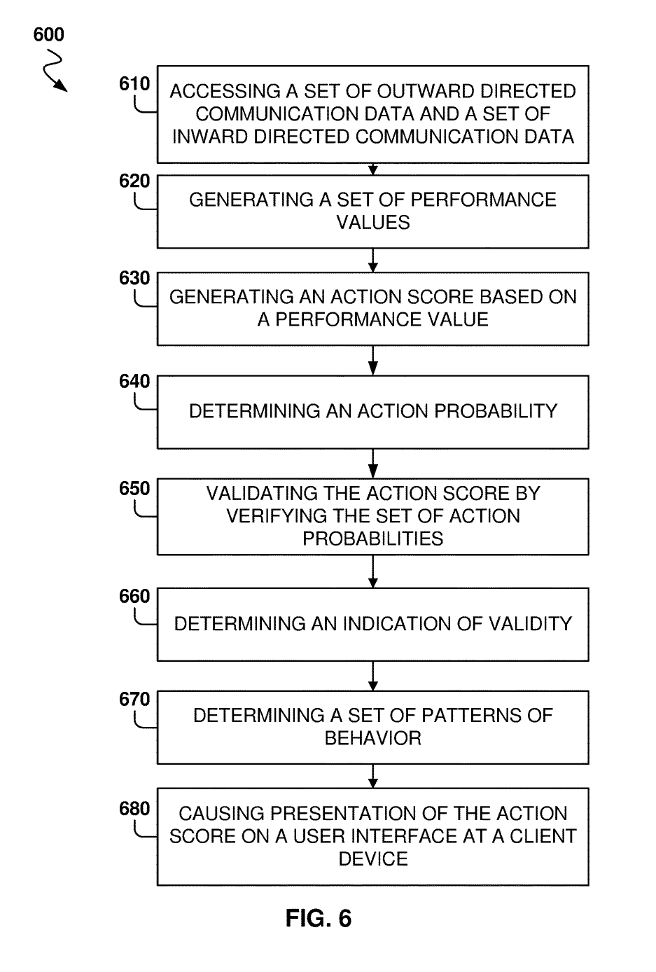

FIG. 6 is a flowchart of an example method 600 for generating action scores and determining action probabilities based on the action scores, according to some embodiments. While the various operations in this flowchart are presented and described sequentially, one of ordinary skill will appreciate that some or all of the operations may be executed in a different order, be combined or omitted, or be executed in parallel. The operations of the method 600 may be performed by a mobile device, a desktop device, or other user device using components such as those shown in FIG. 5C. Although the operations of the method 600 may be performed by various devices, for the sake of clarity, the method 600 will be described with reference to the action history system 100.

In operation 610, the receiver component 510 of the action history system 100 accesses a set of outward communications data and a set of inward communications data. The inward and outward communications data may be stored on a communications database and associated with a set of entities and accessed via a network connection (e.g., the Internet). In some embodiments, the inward and outward communications data comprises messaging data, such as text messages, emails, calendar appointments, and other electronic messages. The inward and outward communications data may be related to actions performed or scheduled by the entities with which the communications data is associated. In some instances, the action history system 100 is provided as a cloud computing environment. The action history system 100 may be configured to receive communications data from a plurality of distributed client devices. In response to receiving the communications data, the action history system 100 generates associations between the communications data and a set of entities associated with the plurality of distributed client devices. In some embodiments, the action history system 100 generates the associations within a communications database (e.g., database 270).

In some embodiments, the inward and outward communications data comprises financial transaction data. In some example embodiments, the action history system 100 receives a set of invoices (e.g., messages requesting an outflow of payment) associated with the set of outward communications data and the set of inward communications data. For example, the set of invoices may include a set of outflow invoices and a set of inflow invoices. In these embodiments, each outflow invoice may be indicative of an invoice, receipt, bill, or other notice of an amount due for which the entity (e.g., a user or a vendor) is expected to submit payment to a third party. Each inflow invoice may be indicative of an invoice, receipt, bill or other notice of an amount due for which a customer of the entity (e.g., the user or the vendor) is expected to submit payment to the entity. In at least some embodiments, certain of the invoices of the set of invoices may include a due date by which payment, of the amount due or a predetermined amount below the amount due, is to be tendered.

The set of outward communications data may include individual outward communications messages. For example, the set of outward communications data may comprise emails requesting some action or feedback, text messages requesting a reply, or outflow financial transactions indicative of the user or a vendor, represented by the user, making or initiating transactions indicative of a transfer of assets away from the entity. For example, individual outflow financial transactions may be in the form of a bill payment, a purchase of goods, a purchase of services, a payment on a line of credit, a payment against a loan, a settlement, or other transaction transferring assets away from the user or vendor. In some embodiments, some or all of the individual outflow financial transactions may occur automatically, or money representative of some or all of the individual outflow financial transactions may be paid from an account based on a predetermined agreement, such as a bank transfer initiated by a bank holding an account of the user, based on a predetermined payment arrangement.

The outflow financial transaction may include temporal characteristics, such as a time at which the financial transaction was transmitted, a time at which the financial transaction was received, a time at which the financial transaction was processed by a receiving institution, a time at which the financial transaction was posted to an account of an intended recipient of the outflow financial transaction, or a time at which the financial transaction was deducted from an account of the user.

In some embodiments, the temporal characteristic may be based on a relationship between the first outflow financial transaction and a first invoice. In these embodiments, the temporal characteristic may be indicative of a timeliness indicator of the first outflow financial transaction with respect to the first invoice. For example, the first temporal characteristic may be a first value indicative of a relative timeliness of the first outflow financial transaction, with the first value indicating the first outflow financial transaction was “on time,” “past due,” “overdue by 30 days,” “overdue by 60 days,” “overdue by 90 days,” or the like. Here, the first value may be a code for one of a predetermined set of options relating to the timeliness of payment of an invoice. In some embodiments, the temporal characteristic may be an integer indicating the association between the first outflow financial transaction and the first invoice. For example, the temporal characteristic may be initially set to zero, and, after passing a due date associated with the invoice, may increment to indicate the days the first outflow financial transaction is overdue.

The set of inward communications data may include individual inflow financial transactions indicative of the entity receiving a transaction indicating a transfer of assets to the entity or to a financial account associated with the entity. For example, the individual inflow financial transactions may be in the form of a payment to the user or vendor, a purchase of goods from the user or vendor, a purchase of services from the user or vendor, a repayment or partial repayment of a debt or line of credit issued by the user or vendor, or other transactions transferring assets to the user or vendor.

The set of inflow financial transaction data may include one or more characteristics. For example, a first inflow financial transaction may include temporal characteristics, such as times at which the financial transaction was transmitted, received, processed, or posted to an account associated with the entity.

In some embodiments, similar to that described with reference to the first outflow financial transaction, the temporal characteristic of the first inflow financial transaction may be based on an association between the first inflow financial transaction and a second invoice. The second temporal characteristic may indicate a timeliness of the first inflow financial transaction with respect to the second invoice. In some embodiments, the second temporal characteristic may be a second value of a timeliness of the first inflow financial transaction. The second value may indicate a code for one of a predetermined set of timeliness options, such as “on time,” “past due,” “overdue by 30 days,” “overdue by 60 days,” or “overdue by 90 days,” for example. In some embodiments, the second value may directly indicate the timeliness of the first inflow financial transaction as an integer value for a number of days beyond a due date associated with the invoice.

The outward and inward communications data may be received over a period of time. For example, the receiver component 510 may receive communication (e.g., a single outward or inward communication data message, a message, a transaction) or multiple communications at regular intervals (e.g., weekly, bimonthly, monthly, quarterly). In some instances, the receiver component 510 receives communications intermittently without a specified interval or pattern. Upon receiving a communication, a message, or a transaction, the receiver component 510 transmits the communication to a communication database. The communication database may be the database 270 or may be a database associated with one or more other components described in FIGS. 1-4 and 5A-5C. In these embodiments, the receiver component 510 continually updates the database in real time with additional communications data as the data is received by the receiver component 510.

In operation 620, the generation component 520 of the action history system 100 generates a set of performance values based on outward communications data and inward communications data. The set of performance values may include one or more performance values. As discussed in more detail below, the performance values may be generated by analyzing interrelations between one or more messages or transactions of the outward communications data and messages or transactions of the inward communications data. In some embodiments, the performance values are dynamically generated by the action history system 100.

In some example embodiments, the creation or sending of an invoice may be a trigger event for starting the count to track if the invoice is paid on time. From this trigger event, the days until payment may be predicted. This can be used at this decision point to change the terms of payment by using a type of recommendation scale (e.g., green, orange, and red indicators).

The action history system 100 may dynamically generate the performance values by automatically updating the performance values as outward communications data or inward communications data is received from the distributed client devices. In some embodiments, the dynamic generation of the performance values is performed periodically, polling the communications database for new communications data based on a predetermined time schedule. In some instances, the dynamic generation of the performance values is performed in real-time by automated functions, such as preprogrammed system interrupts. In these instances, upon receiving outward or inward communications data, the action history system 100 may generate a system interrupt causing regeneration of the performance values associated with the entities for the newly received communications data.

In some embodiments, the performance values may correspond to actions taken, quantifications of actions, or quantifications of behavior. In some embodiments, the performance values may be performance indicators or key performance indicators for the entity. For example, the performance values may be an integer quantifying performance indicators for the entity (e.g., a vendor).

The performance indicators or key performance indicators may include net profit, net profit margin, gross profit margin, operating profit margin, (EBITDA), revenue growth rate, total shareholder return, economic value added, return on investment, return on capital employed, return on assets, return on equity, debt-to-equity ratio, cash conversion cycle, working capital ratio, operating expense ratio, CAPEX to Sales Ratio, price earnings ratio, customer retention rate, customer profitability score, customer turnover rate, customer lifetime values, capacity utilization rate, process waste level, order fulfillment cycle time, delivery in full and on-time rate, on-time payment, late payment, partial payment, full payment, and the like.

In some embodiments, in addition to the outward and inward communications data, the performance values may be generated based on entity information (e.g., vendor information), entered into the action history system 100, for the entity. The entity information may include customer lists, customer numbers, rate of customer purchases, quantity of repeat customer purchases, employee lists, quantity of employees, product waste, product shrinkage, new product development timelines, new product development costs, etc. In these embodiments, the performance indicators, represented by the performance values, may include project schedule variance, project cost variance, innovation pipeline strength, return on innovation investment, time to market, first pass yield, overall equipment effectiveness, process or machine downtime level, customer retention rate, customer profitability score, customer lifetime value, customer turnover rate, human capital value added, revenue per employee, average employee tenure, salary competitiveness ratio, training return on investment, and the like.

Further, in some embodiments, the performance values may be generated based on information of the market, local and global, of the vendor, in addition to the outward communications data and the inward communications data. With the addition of the market information, the action history system 100 may determine performance values indicative of performance indicators, such as market growth rate, market share, cost per lead, conversion rate, and others.

As referenced above, in some embodiments, the performance values may be generated using portions of the outward communications data (e.g., a set of first transactions including outflow financial transaction data) and portions of the inward communications data (e.g., a set of second transactions including inflow financial transaction data). In some embodiments, the performance values may be generated using varying comparisons between two sets of transactions. For example, first transactions may be added together, second transactions may be added together, and the sum of the first transactions may be subtracted from the sum of the second transactions to generate a performance indicator based on a performance value.

In some embodiments, the performance values may be generated by determining ratios between sets of transactions. Although the performance values are described as being generated in conjunction with ratios and arithmetic operations being applied to sets of transactions, it should be understood that the performance values may be generated based on the first transactions and the second transactions in any suitable manner.

In operation 630, the scoring component 530 generates an action score based on a performance value. In some example embodiments, the action score is the NPC, which is a representation of the cash flow of an entity based on the communications (e.g., transactions) of the entity with users of the action history system 100. In some instances, the NPC may be understood as a predictive model that uses a network view of payments to predict the likelihood of future payments by a user. In some instances, the users may separately report indications of payment from the entity to the action history system 100, and the indications may be used, at least in part, to calculate one or more performance values for the specified entity.

The action scores may be generated for entities associated with outward communications data, inward communications data, or a performance value. In some embodiments, the action history system 100 may generate the action score based on the performance value of the set of performance values. For example, the action history system 100 may determine net profit, debt/equity ratio, cash flow, and other key performance indicators, as represented by the performance values, based on the financial transactions. The action history system 100 may then generate the action score based on one or more of the performance values. The performance value may reflect a value indicative of the inflow financial transaction data, the outflow financial transaction data, and the action score. In some embodiments, the action history system 100 may generate the action score based on a combination of the performance value, the inflow financial transaction data, and the outflow financial transaction data.

In some embodiments, the scoring component 530 of the action history system 100 may generate the action score based on a portion of the inward communications data (e.g., the inflow financial transaction data) and a portion of the outward communications data (e.g., the outflow financial transaction data). For example, the action history system 100 may generate the action score based on a payment history for the entity across all suppliers, using at least a portion of the outflow financial transaction data. Further, the action history system 100 may generate the action score based on the performance of customers of the entity. For example, the action history system 100 may generate the action score based on the sales invoices generated and the payments of the sales invoices by customers.

The scoring component 530 may generate the action score, at least in part, based on the relations between entities associated with the outward and the inward communications data. For example, entities may be tagged by relationships such as sibling, cousin, or stranger. In some example embodiments, the following relationships are identified: sibling, cousin, stranger, payable, advisor, bank, and lender.

Sibling entities of a user are those entities that have engaged in communications with the user. The sibling entities may be defined for the entity requesting scores and predictions. The action history system 100 may have access to the outward and inward communications data for sibling companies.

Cousin entities of a user are defined as those entities unassociated with the user in the action history system 100 but that are associated with a sibling entity. The cousin has a receivable invoice from more than one platform entities.

Stranger entities may include entities that are not members of the platform and that have received transmissions (e.g., a discrete instance of communications data) from no more than one sibling entity. Because there is a small amount of information that is available from stranger entities, they should be treated separately from the cousin entities. A payable entity is a contact with an Accounts Payable link. An advisor is a person that gives advice to the entity, such as an accountant.

FIG. 11A is an example network diagram of related entities, according to some embodiments. FIG. 11A illustrates example relationships for a sample company named Company A. The relationships include siblings, cousins, connected organizations (e.g., connected to cousins), users (a type of sibling), a bank (a type of sibling), an advisor, a payable (a type of sibling), and a stranger.

Using the defined relationships between entities, the scoring component 530 may identify entities in a specified relationship to the requesting entity and for one or more action categories. In some embodiments, the categories include positive, negative, indeterminate, and exclusions. The positive category may include entities that have demonstrated desirable behavior, as evidenced by outward and inward communications data falling within prescribed parameters. The negative category may include entities that have demonstrated undesirable behavior based on the communications data, such as paying invoices late, high levels of debt, etc.

The indeterminate category includes entities that cannot be tagged as either good or bad. The exclusion category includes entities with one or more attributes identified for excluding the entity from being scored. In some instances, attributes excluding entities from scoring may include lacking communications data within the action history system 100, communications data which is not suitably directed to a single entity (e.g., invoices having multiple entity names designated as responsible for payment), communications data in which the most recent communications data includes only consolidations of previous communications data, or other communications data which fails to identify new or unique actions or behaviors.

The accounting platform (i.e., the action history system 100) is able to build an accurate picture of the entity's network because the accounting platform has access to accounting data, which includes the accounting transactions, as well as contacts identified by each entity in the platform and employees. These contacts, identified in the platform, allow the platform to create a detailed picture of the network of all the entities associated with the platform. Further, the information is updated in real time and available via a secure API.

Further, bank integration (automated exchange of communications) between the bank and the action history system 100 enables quick and accurate access to relevant financial data, such as payments made and invoices sent. Banks, as well as other financial institutions, may get access to detailed entity data to better understand risks for lending to companies.

Using the defined relationships between entities and designations within the action categories, in response to a request from a first entity, the scoring component 530 may identify action categories for a set of second entities. The action categories may be identified for each instance of communications data within the set of outward and inward communications data. For example, where the outward and inward communications data are financial transactions (e.g., invoices and payments), the scoring component 530 may assign an action category for each transaction. The scoring component 530 may use values assigned for each action category to generate an action score for each entity of the set of second entities.

In some embodiments, the scoring component 530 automatically analyzes the communications data and the action categories to identify predictive sets of communications data and action categories. The predictive sets of communications data and action categories may be grouped instances of communications data. For example, where the instances of communications data are financial transactions transmitted with a time characteristic (e.g., early, on time, or late), the scoring component 530 may group instances into a predictive set based on the time characteristic. For instance, the scoring component 530 may group two or more transactions as a predictive set which share the time characteristic of being late, where the two or more transactions are received sequentially and with no intervening transactions having a different time characteristic. In some instances, a predictive weight may be applied to the predictive set. The predictive weight may be applied commensurate with the number of instances of communications data included within the predictive set.

The action score may be periodically updated in response to new items in the action history system 100 for updating the performance values. In some embodiments, the dynamic generation of the action score may be performed in real time by the scoring component 530 once the scoring component 530 receives a signal, from the generation component 520, indicating an update or modification of a performance value.

Returning to FIG. 6, in operation 640, the prediction component 540 of the action history system 100 determines an action probability for one or more of the entities. An action probability is the probability that the one or more entities perform a corresponding action within a specified time period. The action probability may be generated based on the action scores.

In some embodiments, the prediction component 540 incorporates one or more performance values for generating the set of predictions. The predictions may be generated based on a business intelligence engine, within the action history system 100, which may be included in the prediction component 540.

In some embodiments, the set of predictions may be generated from ratios of vendor data, the set of first transactions, and/or the set of second transactions. Ratios of vendor data may include debtor days, revenue growth rate, cash conversion cycle, or any other suitable ratios of vendor data. One or more of the predictions of the set of predictions may be generated to model certain aspects or assumptions of the vendor's business and to trial different combinations of data entered into the action history system 100 for the vendor. For example, different combinations may be used in different scenarios depending on the nature of the business of the vendor. Combinations may include revenue forecasting, cash flow forecasting, working capital forecasting, profit and loss forecasting, and other suitable forecasting models and combinations. The relevance or value of the different combinations may depend on the nature of the business or vendor.

In operation 650, the validation component 550 of the action history system 100 validates the action score by verifying the predictions based on prior communications data. The prior communications data may include email data, text data, financial transaction data, trends among the prior communications data, or any other suitable information. For example, in verifying the predictions, the action history system 100 may use data from previously entered sets of outflow financial transaction data and sets of inflow financial transaction data to test the quality of predictions, by determining whether the performance values, the previously entered set of outflow financial transaction data, and/or the previously entered set of inflow financial transaction data correspond to a model for expected values as defined by the set of predictions.

Further, the action history system 100 may validate the score by verifying the set of predictions for each additional set of outflow financial transaction data and set of inflow financial transaction data entered into the action history system 100 for an entity. In some embodiments, the prediction may be verified using one or more statistical analysis methods, thereby validating the score. An example statistical analysis method is decile analysis, where scores or probabilities may be grouped into ten equally sized groups. The predicted and actual performances of the scores or probabilities of each of the equally sized groups may then be compared to determine a relative confidence between the scores or probabilities within each group.

In some embodiments, verifying the predictions and validating the action scores further include operation 660. In operation 660, the action history system 100 determines an indication of validity for the set of outflow financial transaction data and the set of inflow financial transaction data. The indication of validity may represent a change in a pattern of behavior for the entity whose communications data was used to generate the action score and the action probabilities or predictions. In these embodiments, the action history system 100 may determine the indication of validity, taking into consideration when an entity attempts to optimize the action score by manipulating the manner, times, or the like, in which the entity enters financial transaction data into the action history system 100.

In operation 670, the validation component 550 of the action history system 100 determines patterns of behavior for the user. In some embodiments, certain patterns of behavior correspond to each of the outward communications data and the inward communications data. For example, the action history system 100 may determine patterns of behavior for the user by generating a model representative of corresponding times and types of financial transaction data, as well as other vendor data, entered into the action history system 100 by the entity. The patterns depicted by the model may indicate times or time intervals at which outflow financial transaction data and inflow financial transaction data are generally entered by the entity.

After modeling the set of patterns of behavior for the user, the action history system 100 may determine an attempt to optimize scoring by identifying variations in the patterns of behavior that fall outside of a predetermined threshold. For example, the action history system 100 may determine that the user enters outflow financial transaction data in weekly intervals, with a variance threshold of two days. The action history system 100 may determine that a potential change in pattern, or a potential attempt to optimize scoring, has occurred when the entity delays entry of outflow financial transaction data for five days, thereby exceeding the two-day threshold.

In operation 680, the presentation component 560 of the action history system 100 causes presentation of the action score on a user interface at a client device. For example, the action history system 100 may present the score for display on a screen connected to or otherwise in communication with the action history system 100. In some embodiments, the action history system 100 may present the action score for display by transmitting the action score or data indicative of the action score to a client device 480. Further, in some embodiments, the action history system 100 may present the action score for display by transmitting the action score or data indicative of the action score to the third-party server 470 or bank server 460. In some embodiments, the action history system 100 may also present a prediction or an action probability for display at operation 680, along with the action score.

In some embodiments, the method 600 may be performed by at least one processor of a single machine with one or more processors. In these embodiments, all of the operations 610-680 may be performed on or by the machine.

In some embodiments, the method 600 may be performed across multiple machines. In these embodiments, a first machine may be in communication with a second machine. In some of these embodiments, for example, the first machine may receive the set of outward communications data and the set of inward communications data, generate the set of performance values, generate the action score, generate the set of predictions or action probabilities, and present the score for display, while the second machine may validate the score by verifying the set of predictions. In some instances, the first machine may receive the set of outward communications data and the set of inward communications data, generate the set of performance values, generate the action score, generate the set of predictions or action probabilities and transmit the information to the second machine associated with an entity whose communications data was not used in generating the performance values, action score, or predictions. The second machine may cause presentation of the action score, the predictions, and the action probability in response to transmitting a request for one or more of a score, prediction, or action probability for one or more third-party entities (e.g., consumers or vendors of the entity requesting the scores and predictions). It will be understood by one skilled in the art that although an example is presented for dividing the operations of the method 600 between the first machine and the second machine, any suitable division of the operations of the method 600 may be performed.

Similarly, in some embodiments, the method 600 may be performed across multiple processors in a single machine (e.g., on a machine with a multi-core processor). Where performed on a machine with multiple processors, a first processor may perform some of the operations 610-680, while a second processor in the same machine may perform other of the operations 610-680.

FIG. 7 is a graphical user interface presenting action probabilities, according to some embodiments. The presentation component 560 may cause presentation of the action score and the action probability within a graphical user interface, as shown in the exemplary embodiment of FIG. 7. The action probability of each entity is classified among a set of categories. In this example, the action probabilities refer to the probability of paying an invoice on time (e.g., within 30 days or within another predetermined period). In some embodiments, the action probabilities may be presented along with an entity designation indicating the entity with which a specified action probability is associated.

As shown in FIG. 7, the action probabilities may be presented within a graphical user interface 700. In some embodiments, the action probabilities may initially be presented in a grouped presentation 710 according to the risk categories. The graphical user interface 700 may also include a probability legend 720 and a detail table 730.

As shown, the grouped presentation 710 divides the action probabilities into groups graphically. The horizontal axis includes time periods and each time period includes a stacked bar within the chart. The groups may be delineated by ranges of probabilities and may be presented with one or more probability group elements 712. For example, a high risk probability may represent entities that the action history system 100 has determined are sixty to eighty percent likely to perform an action late. In this example, the remaining groups may each occupy twenty percent ranges of probabilities of late action. The probability group elements 712 may be generated as selectable graphical user interface elements. Selection of a probability group element 712 may cause the presentation component 560 to generate and cause presentation of an entity listing for entities associated with an action probability within a probability range of the probability group element 712. In some embodiments, the entity listing may be presented in a separate graphical user interface, a window within the graphical user interface 700, in a pop-up window, or any other suitable presentation.

The probability legend 720 may include a set of probability group elements 721-725. Each of the probability group elements of the set of probability group elements 721-725 may be presented adjacent to a code indicating a pattern, color, or other graphical representation associated with the set of probability group elements 721-725. In some instances, selection of a probability group element 721-725 within the probability legend 720 highlights the probability group elements 721-725 within the grouped presentation 710 which correspond to the probability range indicated by the selected probability group element.

The detail table 730 may include one or more representations of the probability groups (e.g., probability buckets), in this case corresponding to risk categories: very high risk, high risk, medium risk, low risk, and very low risk. The second column 732 includes the numerical values as a breakdown of the value in the risk category of the expected late actions and the expected on-time actions. The percentages may be determined from the total set of transactions within a given time period. In some instances, the given time period may include a portion of pending transactions

The third column 734 includes a breakdown of the receivables amount. For example, for very-high-risk receivables, 60.47% are predicted to be late and 39.53% are expected to be on time.

Although presented in a specified graphical user interface 700, it should be understood that action scores and action probabilities may be generated and presented to include any suitable representation. For example, action probabilities may be displayed based on time ranges, within network diagrams, within financial reports, or any other suitable presentation. In some embodiments, where the communications data are financial transactions for accounts payable and accounts receivable, the presentation component 560 may generate and cause presentation of the action probabilities indicating an expected daily, weekly, monthly, quarterly, or yearly expected revenue. In some instances, time-based revenue is presented similarly to that shown in FIG. 7, such that the expected revenue of a given time period is broken up into action probability ranges and indicating a risk or likelihood of receiving portions of the total expected revenue for the time period. The expected revenue and probability ranges may be represented graphically, textually, or any combination thereof.

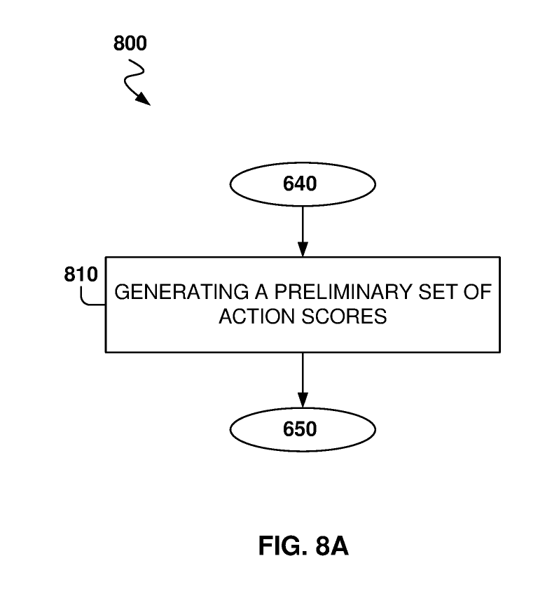

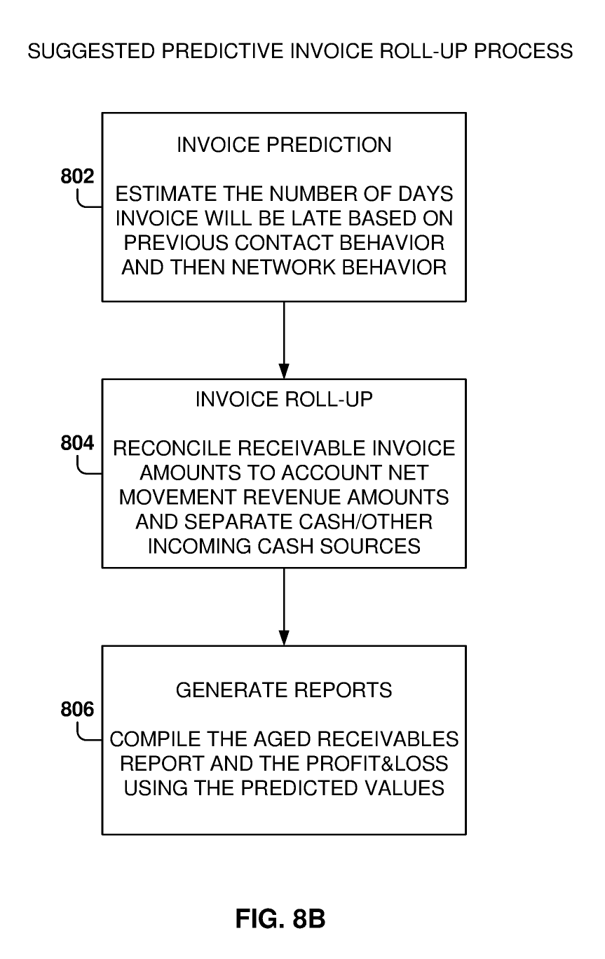

FIG. 8A is a flow chart of an example method 800 for generating action scores and determining action probabilities based on the action scores, such as by using the prediction system 144, according to some embodiments. In some embodiments, the method 800 may be performed in part by performing the operations 610-680 of method 600. The method 800 may further include operation 810.

In operation 810, the action history system 100 generates a preliminary set of action scores. In some example embodiments, each preliminary action score corresponds to a performance value. In some embodiments, the action score is an aggregate based on the preliminary set of action scores. For example, the action score may be generated as an average, a median, or other aggregation of the preliminary set of action scores.

In some embodiments, the action score is generated by aggregating the set of preliminary action scores after removing any action scores determined to be outliers, such as one or more preliminary action scores which are outside of a standard deviation of the rest of the preliminary action scores of the set of preliminary action scores, for example.

FIG. 8B is a flowchart of a method for suggested predictive invoice roll-up, according to some example embodiments. FIG. 8B illustrates the process for predicting invoice performance, such as the report illustrated in FIG. 7. At operation 802, the invoice prediction takes place, which includes estimating the number of days an invoice will be late based on previous contact behavior and network behavior.

From operation 802, the method flows to operation 804, for the invoice roll-up, which includes reconciling receivable invoice amounts to account net movement revenue amounts and separating cash and other incoming cash sources.

From operation 804, the method flows to operation 806 to generate reports by compiling the aged receivables report and the profit-and-loss report using the predicted values.

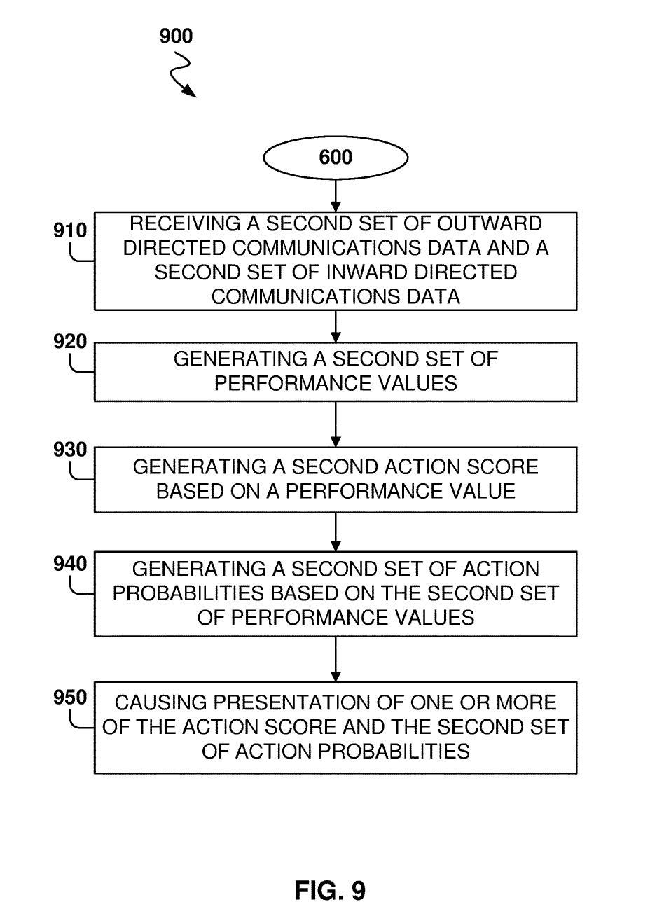

FIG. 9 is a flowchart of an example method 900 for generating action scores and determining action probabilities based on the action scores, according to some embodiments. In some embodiments, the method 900 may be initially performed by performing operations 610-650. Further, the method 900 may include operations 910-950. In operation 610 (as seen in FIG. 6), a first set of outward communications data and a first set of inward communications data are received.

In operation 910, the action history system 100 receives a second set of outward communications data and a second set of inward communications data. The second set of outward communications data and the second set of inward communications data may be received at a time subsequent to the first set of outward communications data and the first set of inward communications data.

In some embodiments, the second set of outward communications data and the second set of inward communications data may be received by the action history system 100 at or near the same time or at a first time and a second time, separated by a time span. For example, the second set of outward communications data may be received at the first time and the second set of inward communications data may be received at the second time, where both the first time and the second time are subsequent in time to the action history system 100 receiving the first set of outward communications data and the first set of inward communications data.

In operation 920, the action history system 100 generates a second set of performance values based on the first set of outward communications data, the second set of outward communications data, the first set of inward communications data, and the second set of inward communications data. In some embodiments, the second set of performance values may be similar to the performance values described above in reference to operation 620. Further, the second set of performance values may be generated similarly to the process described for generating the set of performance values in operation 620.

In operation 930, the action history system 100 generates a second action score based on the performance value of the second set of performance values. In some embodiments, the second action score may be generated similarly to the action score described in operation 630.

In operation 940, the action history system 100 generates a second set of predictions or action probabilities based on the second set of performance values. In some embodiments, the second set of predictions may be generated similarly to the set of predictions described in operation 640.

In operation 950, the action history system 100 causes presentation of one or more of the action score and the set of second action probabilities on a user interface of a machine (e.g., a client device). In this embodiment, the action score may be the second action score or a third action score. The third action score may be generated as a combination of the second action score of operation 940 and the action score of operation 640. The third action score, in some embodiments, may be generated by aggregating the second action score and the action score of operation 640, for example.

In some example embodiments, the HAS and the ITS may be combined in a staged approach, for example, by creating the ITS in the cousins segment and then staging the HAS, effectively combining both into one prediction. Combining HAS with the ITS enables predicting a late invoice better than a customer siblings ITS.

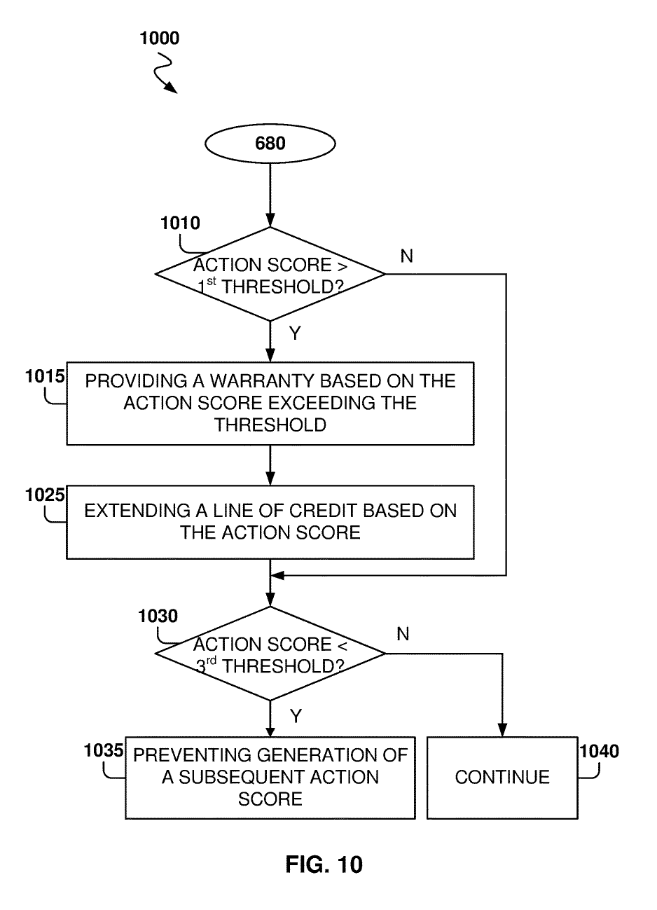

FIG. 10 is a flowchart of an example method 1000 for generating action scores and determining action probabilities based on the action scores, according to some embodiments. In some embodiments, the method 1000 may be performed in part by performing one or more of the operations 610-680 of method 600. The method 1000 may further include operations to provide a warranty based on the action score, extend a line of credit based on the action score, and prevent generation of a subsequent action score, based on the action score. The operations of the method 1000 may be performed by a mobile device, a desktop device, or other user device using components such as those shown in FIG. 5C. Although the operations of the method 1000 may be performed by various devices, for the sake of clarity, the method 1000 will be described with reference to the action history system 100. It should be understood that other types of operations, dependent on scores being above a threshold, may be employed. For example, altering the price or the payment terms of a draft invoice may be performed where the score or probability of an action has been calculated and displayed to a user prior to the invoice being sent or approved.

In operation 1010, a check is made to determine whether the action score is above a first predetermined threshold. The first predetermined threshold may be set or otherwise determined based on: the user's business; the market of the user's business; the set of performance values; the set of predictions (e.g., a set of action probabilities); performance values determined for a region in which an entity's business, about whom the action score was generated, operates or is located; an aggregate value based on action scores of competitors of the entity's business; and combinations thereof or any other suitable method.

If the action score is greater than the first predetermined threshold, the method 1000 flows to operation 1015; otherwise, the method 1000 flows to operation 1030. In operation 1015, the action history system 100 provides a warranty based on the action score exceeding the predetermined first threshold. For example, the action history system 100 may provide a warranty for third parties interacting with the user guaranteeing payment of funds which are the subject of one or more of the plurality of outflow financial transactions or outward communications data. In some embodiments, the action history system 100 provides a written guarantee of a warranty of funds prior to a third party conducting business with the user, based on the score exceeding the predetermined first threshold.

In operation 1025, the action history system 100, or a linked bank (e.g., linked via the bank server 460 and the banking application 465), may extend a line of credit based on the action score. For example, when the action history system 100 determines that the action score exceeds a predetermined first threshold in operation 1010, the action history system 100 may enable the user to apply for or increase a line of credit through the action history system 100. Similarly, the banking application 465, in conjunction with the bank server 460, may enable an entity for which an action score is to apply for or increase a line of credit through an associated bank, after a determination that the action score exceeds the predetermined first threshold. In these embodiments, extending the line of credit may be performed automatically once a user exceeds a current limit on a current line of credit, or upon request of the user, through the action history system 100 or the banking application 465.

In operation 1030, a check is made to determine if the action score is below a predetermined third threshold. If the action score is below a predetermined third threshold, the method 1000 flows to operation 1035; otherwise, the method 1000 flows to operation 1040 to continue operations. In operation 1035, the action history system 100 prevents the generation of a subsequent action score based on the action score being below the predetermined third threshold. For example, where the action history system 100 has failed to validate the action score by verifying the set of predictions, the action history system 100 may prevent the generation of a subsequent action score until such time as the action score is validated. Similarly, the action history system 100 may prevent release of the score or prevent presentation of the action score for display until the validation is complete.

In some embodiments, where the set of predictions is verified by determining an indication of validity, as in operation 660, the action history system 100 may prevent the generation of the subsequent action score based on a failure to determine the indication of validity, until the indication of validity is established for the set of outward communications data and the set of inward communications data. Further, where the indication of validity is indicative of a change in a pattern of behavior, as in operation 670, the action history system 100 may prevent the generation of a subsequent action score based on the change in the pattern of behavior. For example, where an entity, for which an action score is to be generated, enters inward direct communications data and outward communications data in a weekly pattern, the action history system 100 may prevent the generation of a subsequent action score where the user fails to enter the inward communications data or the outward communication data for two weeks. In these embodiments, the action history system 100 may further wait for a resumption of the pattern of behavior, an establishment of a new pattern of behavior, or a suitable explanation for the change in the pattern of behavior prior to generating a subsequent action score.

In some embodiments, the action history system 100 is built using a data modeling layer. The data modeling layer may contain a model or data object (i.e., data structures) for the action score. In some embodiments, an action score data model may be used to automatically, or more efficiently, link the action history system 100 with other components. In some embodiments, other data models or objects may be created for each component that communicates directly with the action score data model. For example, an invoice data model may be used to directly communicate action history system 100 information with invoices. In some embodiments, a financial institution data model may be implemented for more efficient and automated communication with the action history system 100. Moreover, a data model layer may contain any number of data models that connect to the action history system 100 to facilitate the functionality describe herein.

FIG. 11B is a health cycle stability chart, according to some example embodiments. Cycle analysis is used to view the rate of different outcomes over time. It may be used to understand if there are any large fluctuations in the proportions of customers over the sample period. In the examples of FIGS. 11B and 11C, the distributions of outcomes were quite constant over the sample period. Although the first month of the health data mart shows some fluctuation, the overall stability of the data adds to the confidence of the analysis.

The purpose of a target definition is to outline what the algorithms are actually targeting and predicting. The outcome of this exploratory phase is usually a definition of a target customer, definition of a non-target, definition of indeterminate instances of entities (entities that are neither a target nor a non-target and can be investigated further when the known algorithm is created) and exclusions to the sample. The data is divided according to four groups: good, bad, exclusions, and indeterminate.

Good entities are those entities that have demonstrated desirable payment/solvency behavior. Bad entities are those entities that have demonstrated undesirable payment/solvency behavior. Indeterminate entities are those entities that cannot be judged as good or bad. Exclusions are those entities that have an attribute that excludes them from being scored, which may be due to a state where it would be impossible or pointless to score, such as when there is no data about the entity or the entity is already known to be insolvent.

In some example embodiments, the purpose of the prediction model is to predict a binary outcome and separate the good entities from the bad entities as effectively as possible. This may be accomplished by ranking all the cases in the order of a score from most likely to be bad to most likely to be good. If the predicted ranking is perfect, then a cut-off point may be determined, which allows all the bad cases to be perfectly separated from the good cases.

With the target definition in place, it is possible to define which characteristics in the dataset may predict the defined outcome. This process of assessing predictive strength is sometimes referred to as characteristic investigation or feature design. The general process includes splitting each predictive variable (characteristic or feature) into groups called attributes. These groups can be ranges (e.g., 1-5 for a continuous variable) or combinations of categorical variables (e.g., grouping ‘US’ and ‘UK together’). These groupings are determined by statistical analysis and background knowledge.

For each characteristic, a table is constructed showing how the distribution of outcome states depends on the attribute values (groups identified in the classing process). From this table, a metric is derived to quantify the ability of the characteristic to separate the bad entities from the good entities. In some example embodiments, the Information Value (IV) is issued as a measurement of predictive strength. The IV of each characteristic can be informally interpreted as described in Table 1.

TABLE 1

| Information Value | Predictive strength |
|---|---|
| <0.05 | Too weak for use (may be useful if |
| | combined with other characteristics) |
| 0.05-0.1 | Weak |
| 0.1-0.5 | Moderate |
| >0.5 | Strong |

Table 2 below includes information values from health analysis ordered from strongest characteristics to weakest as defined by the IV. The top five are included below with highly similar variables removed.

TABLE 2

| Health Characteristic | IV | Strength |
|---|---|---|
| Net movement of revenue (average last 3 | 0.53 | High |
| months) | | |
| Net movement of revenue (average last 6 | 0.52 | High |
| months) | | |
| Net movement of current liabilities (over | 0.39 | Moderate |
| current month) | | |
| Net movement of expense (over current | 0.39 | Moderate |
| month) | | |
| Net movement of expense (average over | 0.36 | Moderate |
| last 3 months) | | |

FIG. 11C is a trade cycle stability chart, according to some example embodiments. In this case, the distributions of outcomes were also quite constant over the sample period. Table 3 below includes information values from the trade characteristic analysis ordered from strongest characteristics to weakest as defined by the IV. The top five are included below with highly similar variables removed.

TABLE 3

| Trade Characteristic | IV | Strength |
|---|---|---|
| Number of bad invoices (last 6 months) | 0.98 | High |
| Number of bad invoices (last 3 months) | 0.94 | High |
| Number of good invoices (last 3 months) | 0.42 | Moderate |
| Percentage of bad invoices (last 12 months) | 0.37 | Moderate |
| Invoice amount (average over last 9 months) | 0.07 | Weak |

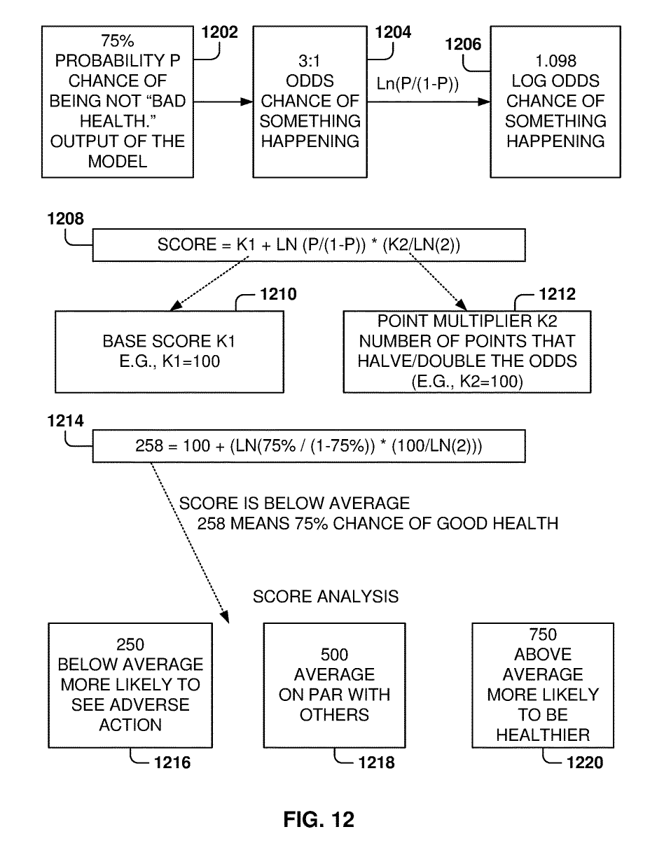

FIG. 12 is a depiction of a score-generation algorithm, according to some embodiments. FIG. 12 illustrates an example embodiment for calculating an action score, but other embodiments may utilize other functions based on the probability of an invoice being paid on time, or a group of invoices being paid on time. The embodiment illustrated in FIG. 12 should therefore not be interpreted to be exclusive or limiting, but rather illustrative.

In some example embodiments, the action score is calculated with the following equation 1208:

Score=K₁+Ln(P/(1−P))*(K₂/Ln(2)) (1)

P is the probability 1202 that an item (e.g., receivable) is not in bad health, or in other words, the probability that an item is in good health. This is an output of the model and is based on the probability that an item, or a group of items, have a good chance of being fulfilled on time. For example, in some example embodiments, the probability P is the probability that an invoice will be paid on time. In the example illustrated in FIG. 12, the probability P is 75%.

The probability P translates into the odds chance that something will happen 1204 (e.g., the invoice will be paid on time). In this example, the 75% probability is equal to 3:1 odds. K₁ is a base score 1210 and, in this example, K₁ is 100, but other base values are also possible. K₂ is a point multiplier 1212, which is the number of points that halve or double the odds (e.g., K₂=100).

The logs odds of something happening 1206 is Ln(P/(1−P), which in this example is equal to Ln(0.75/0.25) or 1.098. Thus the action score 1214 is equal to 258 in this example. In some example embodiments, the analysis of the score includes comparing to certain thresholds. A first threshold 1216 is 250, which means that action scores at 250 or less are at higher risk. A second threshold 1218 is 500, which means an average level of risks. A third threshold 1220 is 750 and indicates that action scores above the third threshold will have low risk and a high probability of being healthy. It is noted that other example embodiments, may utilize different scores and different thresholds. In this example, the score of 258 is below average (threshold of 500), which corresponds to the 75% probability of good health.

The action probability may be determined dynamically in real time. In these embodiments, upon receipt of new communications data, the generation component 520 regenerates the set of performance values based on the additional communications data. The generation component 520 may transfer the regenerated set of performance values to the scoring component 530, causing the scoring component 530 to generate a new action score (e.g., network predictive cash flow value) based on the regenerated performance values. In response to generating the new action score, the prediction component 540 updates the action probability based on the new action score. In some embodiments, the prediction component 540 updates, regenerates, or modifies the action probability in real time as changes to action scores, or additional action scores, are received. In some embodiments, the action probability is updated periodically, based on inquiry to the database or the action history system 100, or at predetermined intervals.

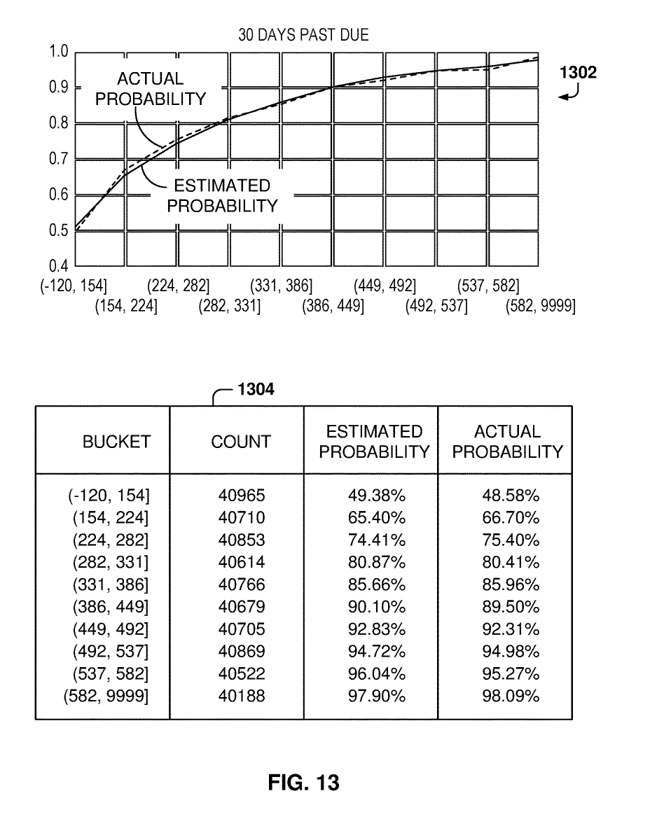

FIG. 13 is an example graphical depiction of candidate action probabilities, according to some embodiments. In some embodiments, the action history system 100 may provide the action probability of each entity where the action probability indicates one or more predictions of expected behavior. The predictions may be presented in the form of text or include graphical depictions (e.g., icons, graphs, or other graphical depictions).

Chart 1302 illustrates the probabilities, estimated and actual, that an invoice is paid late based on the estimated risk, which is represented in the horizontal axis in different buckets according to the action score for the risk of late payment. As seen in chart 1302, the estimated risk of late payment is very similar to the actual risk. Table 1304 is a table that holds the values utilized for chart 1302.

The action history system keeps track of all outstanding invoices of a user to provide an overall estimate on payment times for each of the invoices. Further, each invoice may have a different probability of payment (e.g., being paid on time) based on the payment history of the payer. Therefore, the action history system must track a large amount of outstanding invoices and the performance of the payers. The information may be summarized into action scores that may be shared with the user and with financial partners. The network implementation allows for quick and easy sharing of information in quasi real time.

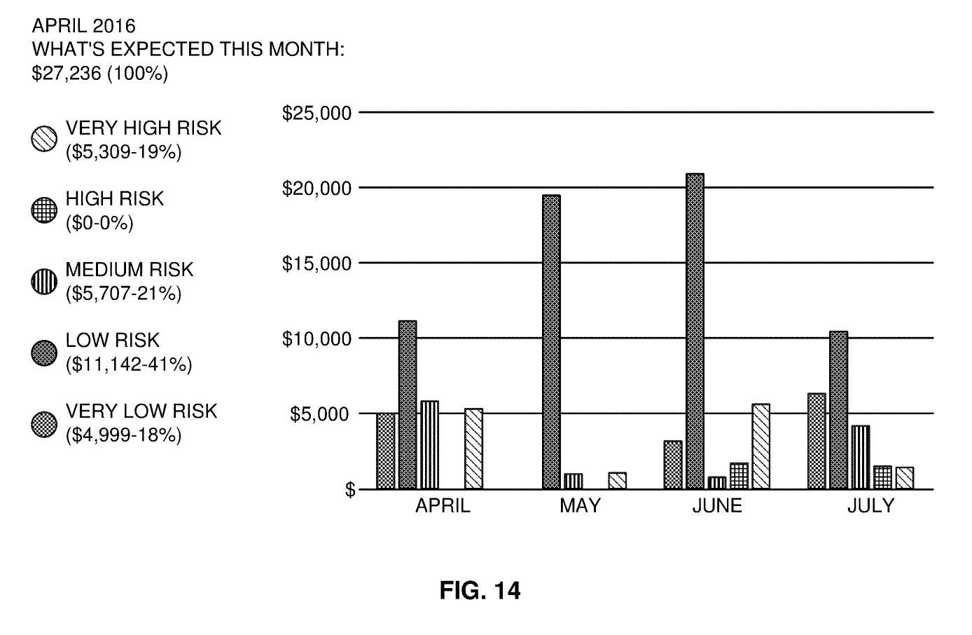

FIG. 14 is an example graphical depiction with a color-coded indication of the action probabilities, according to some embodiments. Action probabilities for a set of entities interacting with a given user of the action history system 100 may be represented using a combination of graphed data given date ranges and a color-coded or otherwise differentiated (e.g., textually and graphically) indication of the action probabilities, as shown in FIGS. 14-19.

In some embodiments, the action history system 100 may present the one or more predictions in a dashboard, ticker, a graph or set of graphs, or other portion of a graphical user interface. In providing the one or more predictions, the action history system 100 may determine which of the set of predictions to provide for display at the client device 480 based on the business of the user associated with the client device 480, the set of performance values which the entity requested, one or more performance indicators for the entity requesting the predictions or the entity with which the predictions are associated, a market determined for the entity, or other determinations. The action history system 100 may thereby determine the one or more predictions appropriate for the entity to convey information relating to the health, performance, credit-worthiness, or other aspects of the business of the user.

FIG. 14 is a histogram chart for expected revenue in a month broken down by risk categories. Each month includes five bars indicating the amount of revenue for each of the categories. The histogram provides an easy representation to quickly assess risk. For example, in April, there's a relatively high amount of revenue in the high risk category, while in May, the high risk category is much smaller while the low risk category constitutes most of the expected revenue. Additionally, revenue totals and percentages are provided on the left for each of the categories, together with the legend for the bars in the histogram.

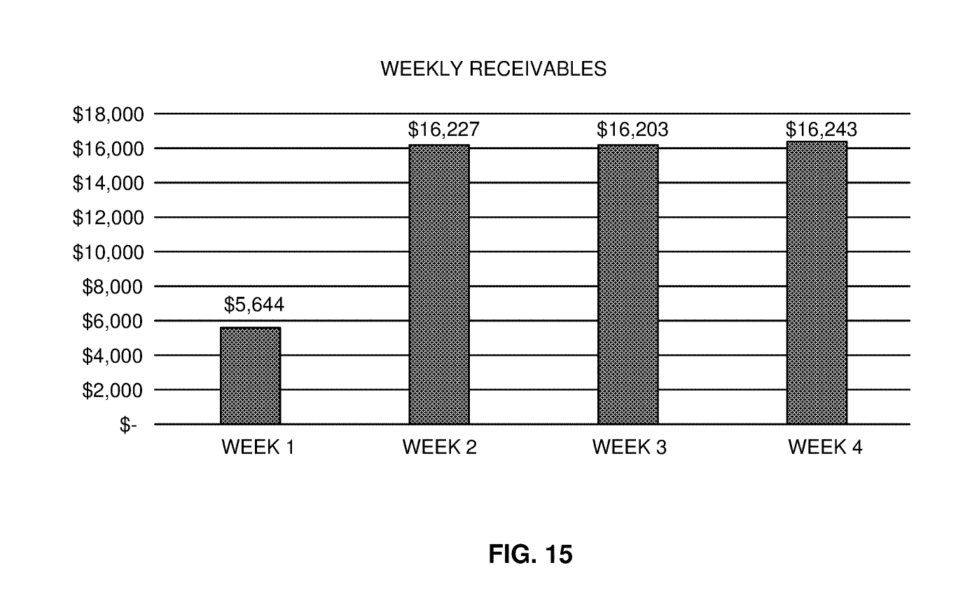

FIG. 15 is an example graphical depiction of action probabilities using a histogram for weekly receivables, according to some embodiments. Action probabilities may be represented with respect to receivables, where at least a portion of the communications data are financial transactions. For example, the weekly receivables may be presented in a histogram with one bar for each week, with a weekly total on top of the bar.

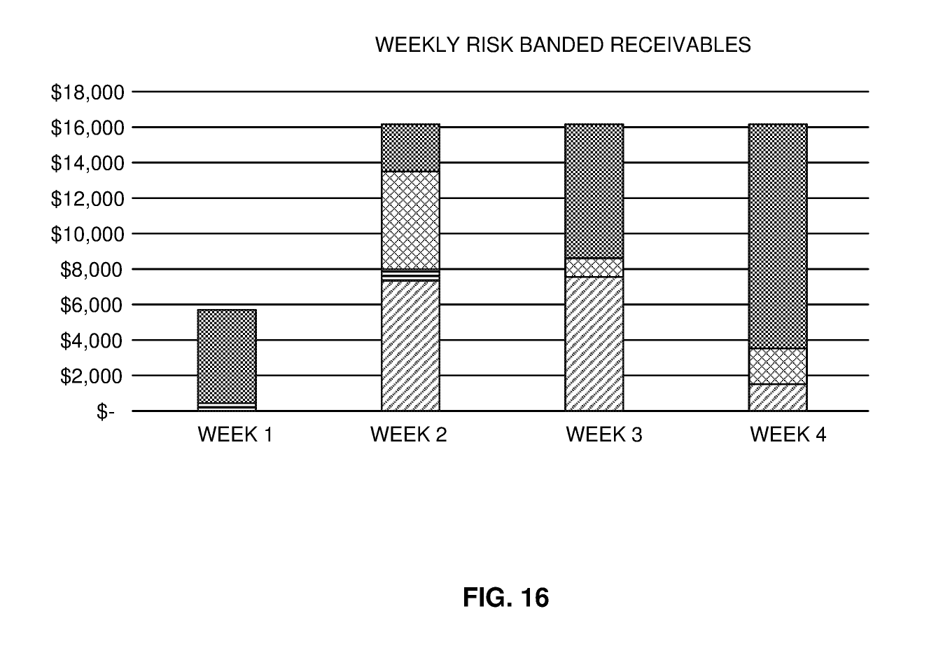

FIG. 16 is an example graphical depiction of action probabilities showing weekly risk banded receivables, according to some embodiments. The chart of FIG. 16 is a stacked-bar histogram showing weekly revenue, with the same risk categories as illustrated in FIG. 14.

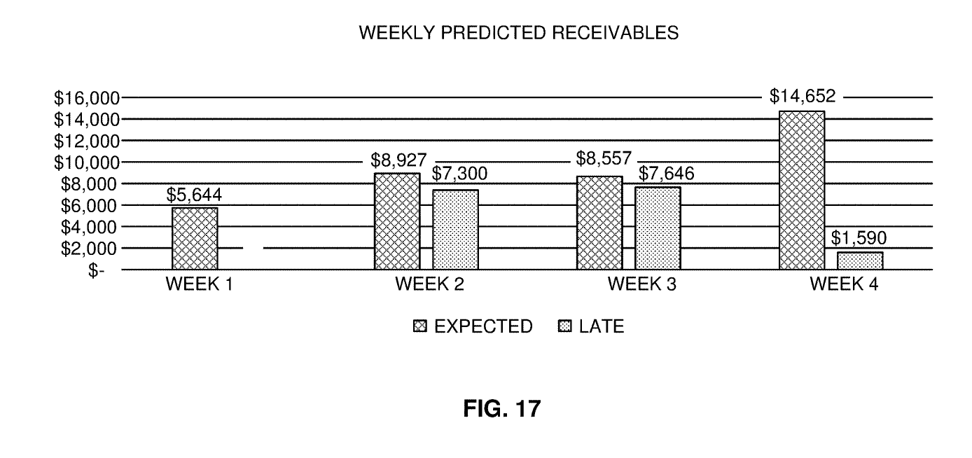

FIG. 17 is an example graphical depiction of action probabilities showing weekly predicted receivables, according to some embodiments. Receivables may also be depicted in another histogram with two categories: expected revenue and late revenue (e.g., expected late).

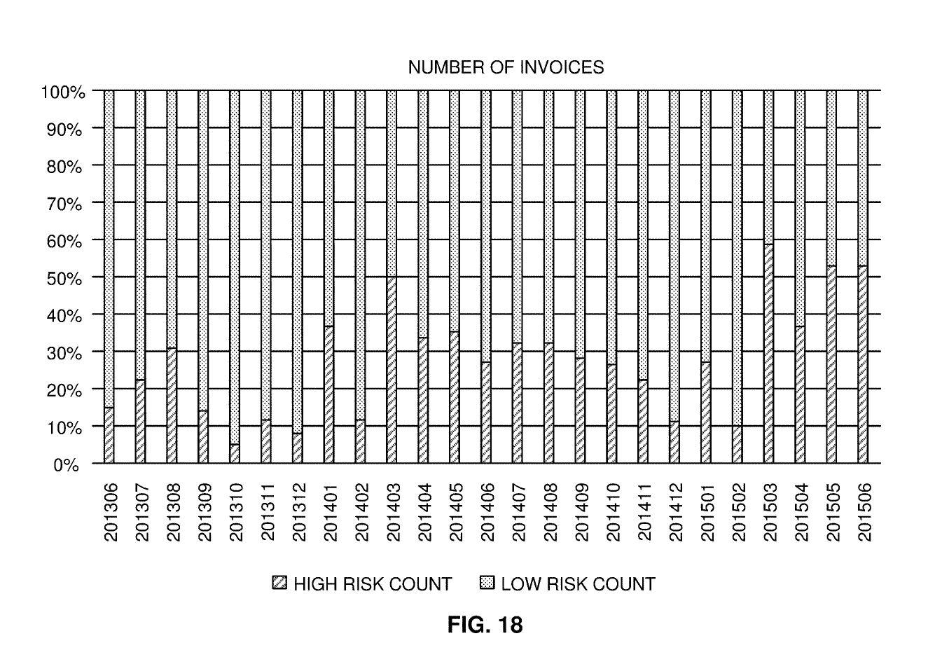

FIG. 18 is an example graphical depiction of action probabilities using a stacked histogram for high- and low-risk invoices, according to some embodiments. For each time period, a stacked bar indicates the percentage of invoices that are in the high-risk category versus the low-risk category. Thus, it can be easily seen that in some months, the high risk count of invoices is low (e.g., 201310), while in other months, the risk count is much higher (e.g., 201403).

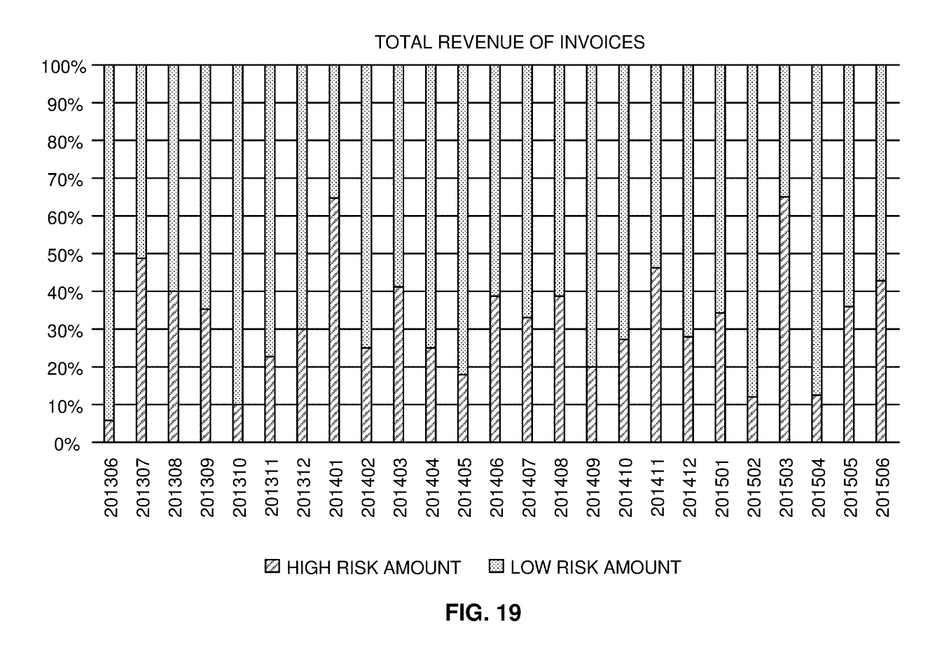

FIG. 19 is an example graphical depiction of action probabilities for the total number of invoices, according to some embodiments. FIG. 19 is also a stacked histogram, but for total revenue of invoices instead of the count of invoices as in FIG. 18. Thus, FIG. 19 illustrates the amount at risk instead of the number of invoices at risk.

The comparison of high risk and low risk may also be presented in tabular form. For example, Table 4 below shows the breakdown of the predicted revenue for high vs. low risk against on-time and late receivables.

TABLE 4

| | Low Risk | High Risk |
|---|---|---|
| On-time receivables | $447K | $147K |
| Late receivables | $79K | $93K |

Table 5 below shows a similar breakdown as Table 4, but showing percentages of receivables expected late.

TABLE 5

| | Low Risk | High Risk |
|---|---|---|
| Late receivables rate | 15% | 38% |
| Percentage of total | 46% | 54% |
| late receivables | | |

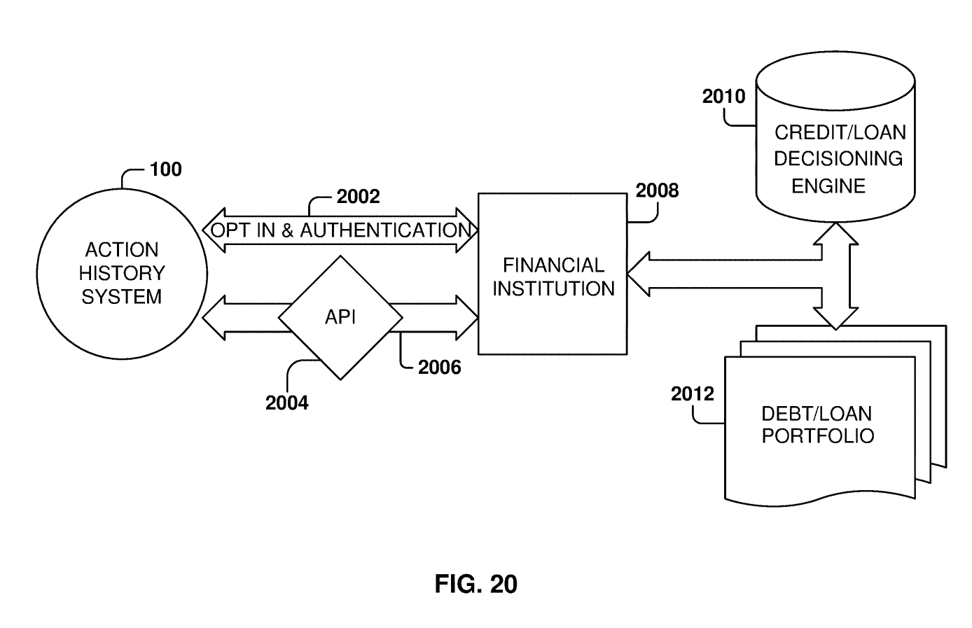

FIG. 20 illustrates a flow of an example method of analyzing lines of credit in response to generating an action score, according to some embodiments. In some instances, the action history system 100 may cooperate with one or more third parties to provide lines of credit or offers of lines of credit to users of the action history system 100. In some instances, the action history system 100 may interact with a system of the third party in an automated or semi-automated format.

The calculation and sharing of actions scores enables financial institutions and their customers to get a unique view of the financial situation of each customer. Traditional credit scores only paint an overall picture, created over a long period of time, of the history of companies paying bills on time. However, the action scores paint a live picture, in real-time, based on the expected cash flow and other financial parameters (e.g., receivables of a customer), as well as the level of risk associated with the cash flow.

The ability of the action history system to analyze the payment performance of a large number of companies provides new ways to understand the operation of ongoing businesses. Also, the action scores are able to identify alarms for possible payment problems on companies on real-time, allowing mitigating measures to be put in place quickly, as well as cutting possible losses by financial institutions due to bad loans given to companies unable to repay those loans.

The system is efficient because the different parties are interconnected, as illustrated in FIG. 4, and able to exchange information quickly, e.g., daily, hourly, or even instantly. The user of the accounting platform is able to allow financial partners to access their data. On the other hand, financial institutions are able to better assess risk of possible loans as well as provide better terms to those companies with healthy financials. Financial institutions may also get a pulse of the market by analyzing the action scores history of a plurality of companies in a market.

Users benefit by getting better terms for their short-term loans when companies are well managed and have healthy cash flows. Further, users may be able to provide the information to multiple financial partners and allow the financial partners to compete for their business.

Further yet, financial partners are able to monitor their client's ongoing financial position and work with their clients to make sure that they meet their financial obligations, or present financial instruments to cover for cash flow needs. FIGS. 20-29 illustrate some examples of the interactions among clients, the action platform, and financial institutions.

Trade credit is an important part of SMB business as it helps smooth the cash flow cycle. For B2B suppliers, it underpins sales and is one of the highest uses of capital. Understanding the risk of SMBs is important for supplier trade credit programs, which are typically unsophisticated in comparison to banks and lenders.

Larger-value credit suppliers typically rely on local relationships, with limits increasing with length of relationship (much like the local bank manager of 20 years ago). For lower-value credit suppliers, both new and existing customers may be eligible for trade credit. However, these programs typically have fee-bearing terms that price-in the perceived risk.

Credit reporting agencies collect trade credit data on SMBs and provide reports to other businesses. However, due to privacy concerns, there are limited regulations on the collection and sharing of commercial trade data, and if done, it must be with the explicit consent of the SMB.

One possible solution to getting better financial information from SMBs is to provide an API with access to the financial institution, but this requires express consent from the user. In some example embodiments, the accounting platform provides “value-added” data by making available the action scores, simplifying the decision-making for the financial institution because the data has already been processed and the financial institution does not have to create the predictions. Further, the accounting platform is able to generate statistical data comparing the entity to other similar entities, without having to share data from other companies that may not be authorized for sharing to third parties.

Of course, the data provided by the accounting platform complies with all required privacy requirements set by the government where the company operates, and often exceeding the privacy requirements set by the government. Thus, the accounting platform is able to provide a core-lending infrastructure that allows different lenders to offer targeted services across the spectrum of SMB sectors and geographies. SMB trade relationships with suppliers are a major source of business credit, playing an important role in smoothing the cash-flow cycle of SMBs. Integrating action scores with suppliers to support business trade terms is a compelling reason for a business to maintain a profile with the accounting-platform provider.

FIG. 20 illustrates how to share information with a financial institution 2008. At operation 2002, the financial institution 2008 authenticates with the action history system 100. After authentication is completed, the financial institution 2008 is able to exchange data 2006 with the action history system 100 via the API 2004.

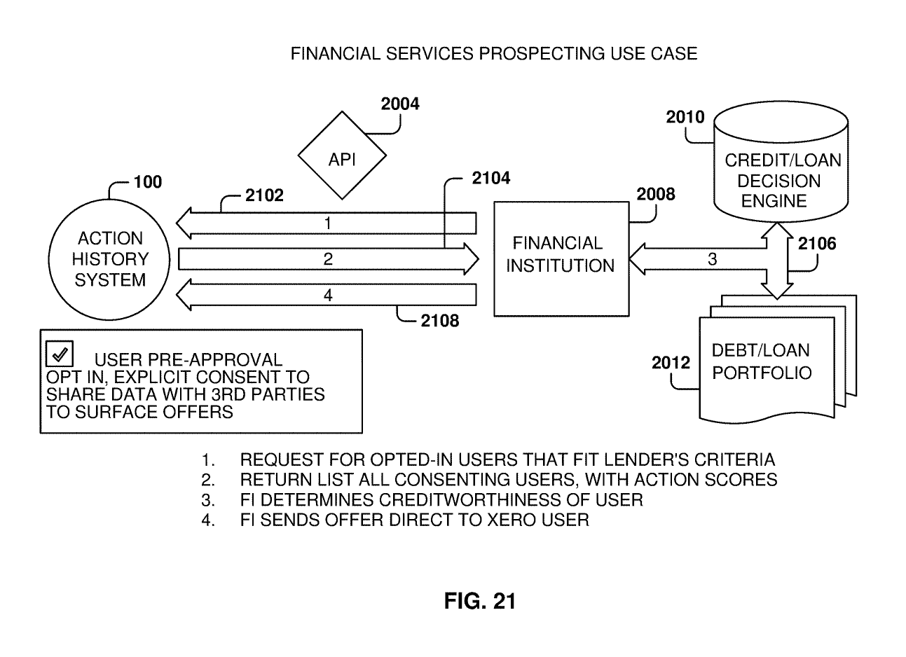

The financial institution 2008 manages the debt/loan portfolio 2012 and the credit/loan decision engine 2010 to determine the lending policies for each platform entity. The action history system 100 may provide at least a portion of user information (e.g., contact or identification information, the action score, the action probability, or one or more performance values) to the financial institution through an API 2004. The action history system 100 may provide a graphical user interface enabling a user of the action history system 100 to opt in to data sharing with the financial institution. For example, once the user has opted in, the action history system 100 may provide the action score to the financial institution 2008. The financial institution 2008 may perform one or more calculations using the action score within a credit/loan decision engine. In some instances, the financial institution 2008 compares the determination of the engine to the debt/loan portfolio to make a determination as to credit worthiness or other financing decision. The financial institution 2008 may then pass a credit offer to the action history system 100, such that the presentation component 560 causes presentation of at least a portion of the credit offer to the user. In some instances, as shown below, the financial institution 2008 provides financing offers to one or more users of the action history system 100. Further, the financial institution 2008 is able to provide loan offers directly to the customer via the action history system 100. Some detailed examples are provided below with reference to FIGS. 21-29.

FIG. 21 illustrates a flow of an example method for providing offers based on action scores, according to some embodiments. The financial institution 2008 may request identifications 2102 for opt in users fitting a specified criteria. The criteria may incorporate the action score, performance values, invoice scores (e.g., action scores for specific invoices), action probabilities, or any other suitable data. The users provide pre-approval to opt in to the program, with explicit consent to share data with third parties that provide offers, or specifically selecting which third parties may have access to their data.

The action history system 100 may provide 2104 a list of the consenting users and associated action scores or other pertinent data. The financial institution 2008 may then make a credit worthiness determination 2106 using the action score or other supplied data.

In some embodiments, once the credit determination is made, the financial institution 2008 may provide the credit offer 2108 and terms directly to the user. In some instances, using the API 2004 of the action history system 100, the financial institution 2008 may provide the offer to the action history system 100 for presentation to the user.

In some example embodiments, upon generating an invoice, the action history system 100 may access the action score of the user and provide the action score to the financial institution 2008. The financial institution 2008 may cause presentation of one or more loan products (e.g., one or more loan products having differing terms) to the action history system 100. The action history system 100 may incorporate a loan product or indication of the loan product (e.g., a portion of the terms and the financing institution identification) to the user. In some instances, the action history system 100 incorporates the loan product into the invoice generated by the user. In some instances, the invoice may be formed using a prediction model generating portions of the invoice based on one or more user input from the user of the action history system 100. An invoice model may interact with the prediction model to incorporate a loan offer or indication thereof within the invoice generated by the prediction model.

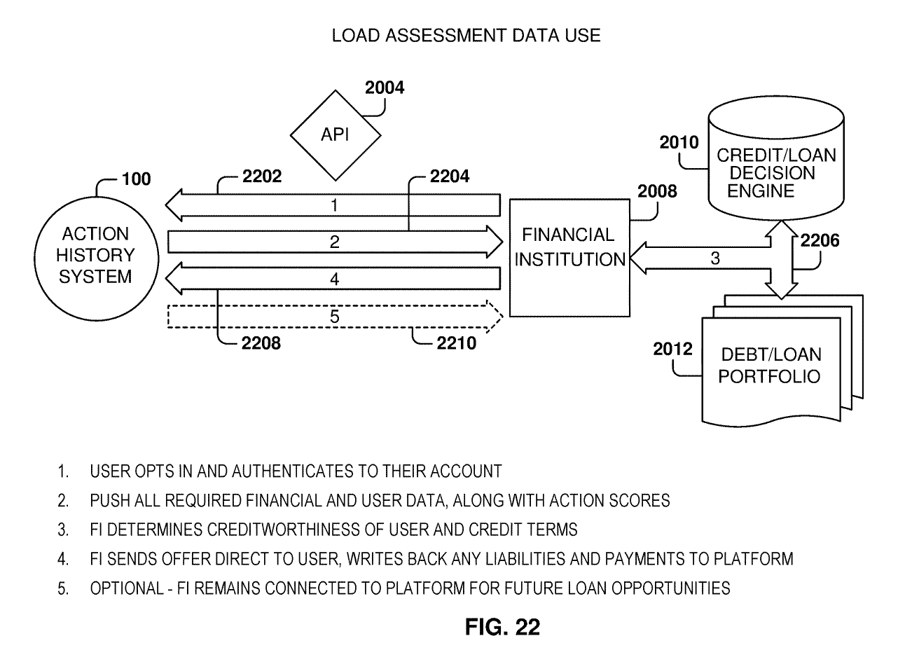

FIG. 22 illustrates a flow of an example method for performing an assessment in response to generating an action score, according to some embodiments. The user or entity of the action history system 100 may select one or more graphical interface elements to apply for a loan through the action history system 100 from the financial institution.

The user or entity may opt in 2202, based on the selections within the graphical user interface. For example, the user may select a graphical interface element requesting a loan. The action history system 100 may present the user with one or more graphical interface elements confirming details (e.g., contact information, invoice information, transaction or communications information).

Once the details have been confirmed, the action history system 100 passes at least a portion of the information 2204 to the financial institution 2008. The financial institution 2008 may receive or access the action score, or scores, of the user applying for the loan. The financial institution 2008 may perform one or more decision processing 2206, using the action score from the action history system 100, and generate a credit offer. In some instances, the financial institution 2008 may generate a loan offer from a set of predetermined loan products or types. The loan products or types may include differing terms for repayment, interest, and other servicing aspects.

The offer is then transmitted 2208 from the financial institution 2008 to the action history system 100, which then shares the offer with the user. In some instances, once the user accepts the loan, through the action history system 100, the financial institution 2008 may maintain connection 2210, through the action history system 100 API 2004, with the user data to monitor one or more aspects of the loan. For example, the action history system 100 API 2004 may enable monitoring of revenue, profitability or other aspects relating to communications data associated with the entity. The data associated with the action history system 100 may enable automated health determinations for the entity by the financial institution 2008 in servicing the loan.

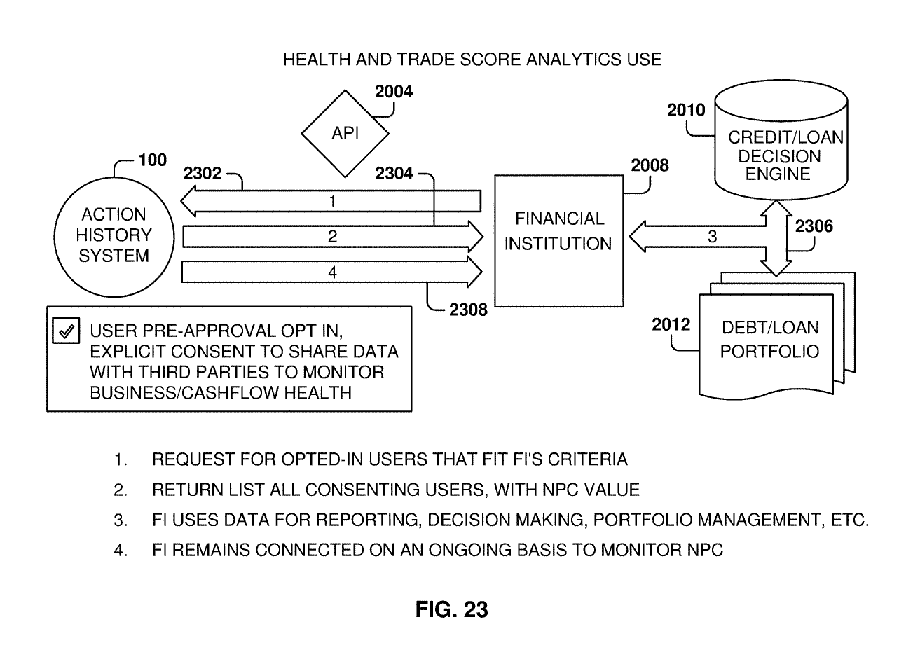

FIG. 23 illustrates a flow of an example method for enabling health and trade analysis of users of the action history system 100, according to some embodiments. In some example embodiments, the action history system 100 provides the action score to the financial institution 2008 to allow the financial institution 2008 to create a financial tool, such as a short-term loan or a line of credit.

The action score and additional user information may be packaged to enable the financial institution 2008 to identify indicators of future cash flow and other indicators (e.g., balance sheet, profit/loss, debtors) of health for the user. In some instances, the action history system 100 enables portfolio review of the financial institution 2008. For example, where a loan is provided to the user, the financial institution 2008 may access the NPC, performance values, and other communication information to determine loan-to-value ratio bands for continued servicing of the debt to the user.

It is noted that some embodiments are described with reference to the NPC, but other action scores may also be utilized. In some instances, the financial institution connects to the database of the action history system 100 through the API 2004 to identify invoice level action scores and user level action scores. The invoice level action scores may enable real-time invoice factoring and discounting, explained in more detail below. The NPC may aggregate a set of invoice action scores, enabling tracking of financial health of the user such as total future cash flow or likelihood of receiving or not receiving receipts or cash flows for a given period of time. Granularity of the action score being generated may be selected by the financial institution or automatically identified based on a relationship of the financial institution with the user.

In the example of FIG. 23, the financial institution 2008 requests 2302 for opt-in users that meet a certain criteria. The action history system 100 returns 2304 a list of all consenting users, with the respective NPC values. The financial institution 2008 uses the data provided by the action history system 100 for reporting, decision-making, portfolio management, etc.

The financial institution 2008 remains connected 2308 on an ongoing basis to monitor the NPC value. This way, the financial institution 2008 is able to provide loan offers, as well as take mitigation actions when the NPC indicates that the loan may be defaulted due to financial stress or a decrease in the expected cash flow.

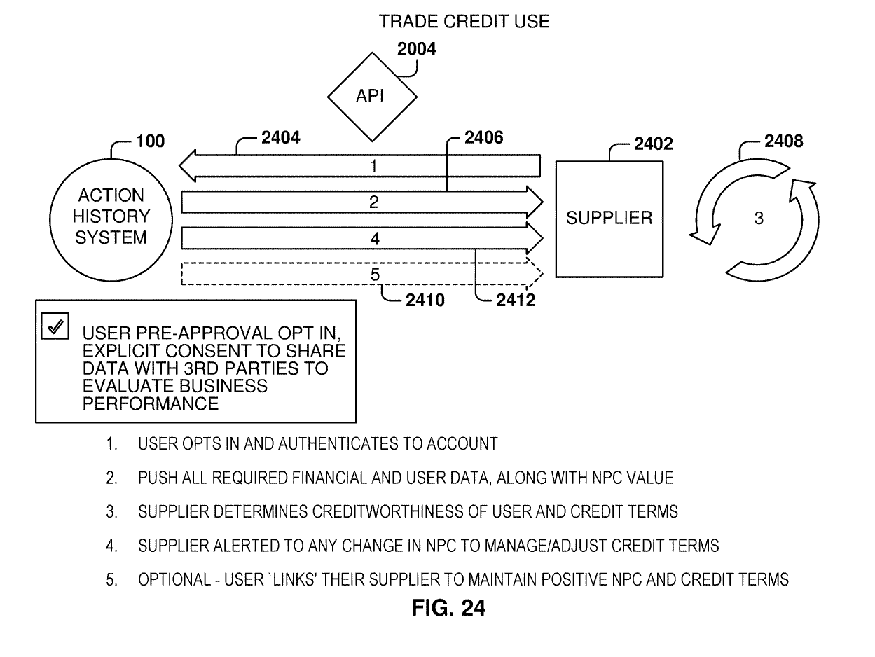

FIG. 24 illustrates a flow of an example method for trade credit use, according to some embodiments. As shown, the first user may opt in and initiate a relationship 2404 with a supplier 2402. The action history system 100 then pushes 2406 financial and user data (e.g., the NPC value) to supplier 2402.

The supplier 2402 then determines 2408 the creditworthiness of the user and the credit terms for financing. Whenever there is a change in the NPC, the supplier 2402 is alerted 2412 by the action history system 100. Optionally, the user may link 2410 the supplier 2402 to obtain NPC updates and maintain positive credit terms.

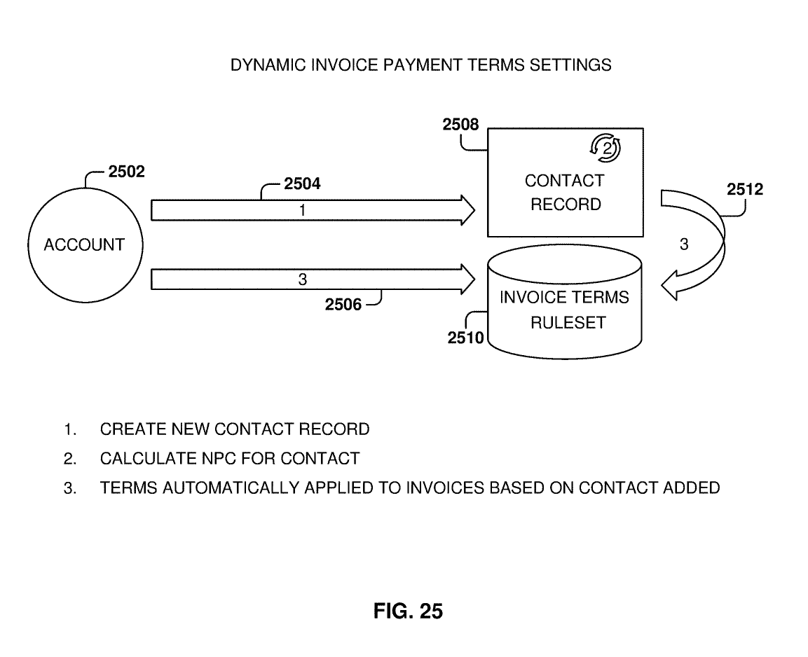

FIG. 25 illustrates a flow of an example method for providing dynamic terms based on the action score, according to some embodiments. In some example embodiments, the action history system 100 includes a set of invoice rules within the prediction model. Upon a first user of the action history system 100 interacting with a second user for a first time, the action history system 100 may generate an action score or provide a previously generated action score to the first user. In some instances, when the first user generates the invoice, using the prediction model, the prediction model may populate or suggest terms of the invoice (e.g., discounts, penalties, timing) in the invoice. The first user may accept the terms provided by the prediction model and generate the invoice for presentation to the second user.

In the example of FIG. 25, a user having an account 2502 creates 2504 a new contact record 2508. At operation 2512, the NPC is calculated for the contact record 2508. Based on the invoice terms rule set 2510, terms are automatically applied 2506 to newly generated invoices based on the contact added.

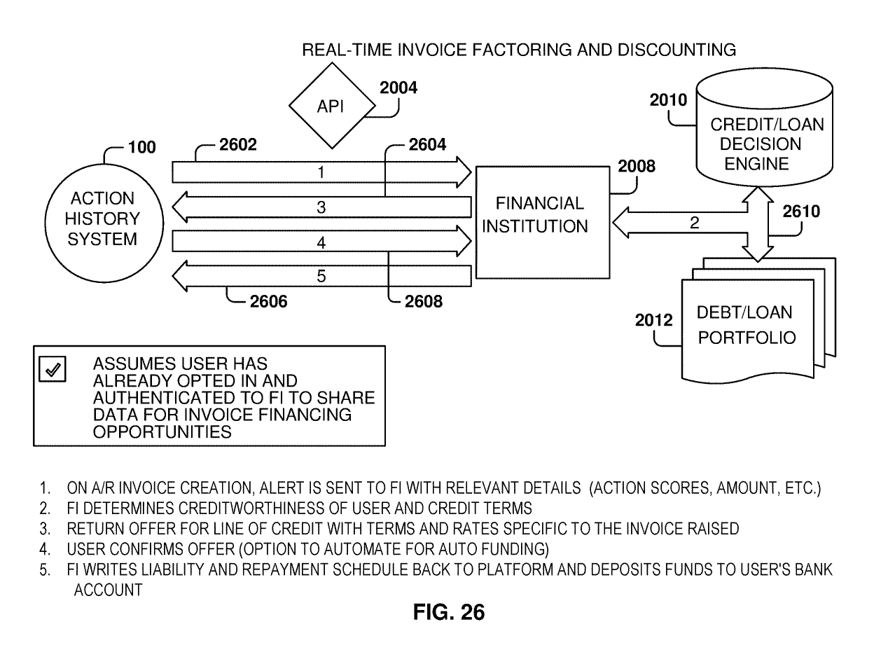

FIG. 26 illustrates a flow of an example for performing factoring and discounting, according to some embodiments. When an invoice is created, an alert is sent 2602 to the financial institution 2008 from the action history system 100. The alert includes relevant invoice details, such as amount and date issued, as well as one or more action scores.

The financial institution 2008 determines 2610 the creditworthiness of the user and the credit terms, and then the financial institution 2008 returns 2604 an offer for a line of credit, including terms and rates for the specific invoice just created.

The user confirms 2608 the offer to accept the terms from the financial institution 2008. In some example embodiments, an automatic option may be set for automatic funding by the financial institution 2008.

The financial institution 2008 writes the liability and repayment schedule back 2606 to the action history system 100 and deposits the funds in the user's bank account.

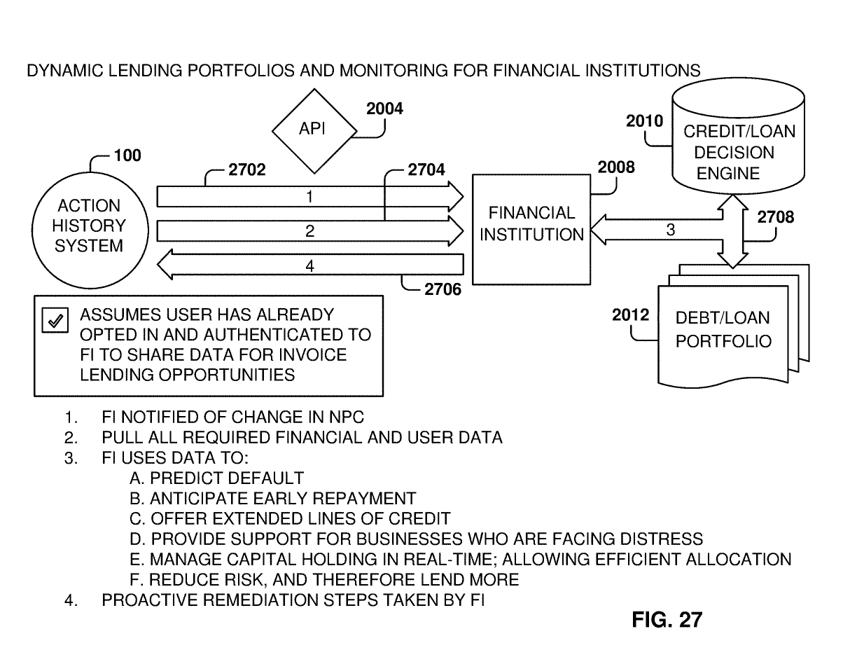

FIG. 27 illustrates a flow of an example for performing dynamic monitoring, according to some embodiments. The financial institution 2008 may receive 2702 a notification of change of the NPC. The financial institution 2008 pulls 2704 all the required financial and user data from the action history system 100.

Using the action scores of a set of users, the financial institution 2008 may predict 2708 the probability of possible actions, such as predicting likelihood of default, anticipating early repayment, offering extended lines of credit, providing support for businesses under financial distress, adjusting capital holdings, and performing other operations to reduce risk.

The financial institution 2008 may then take proactive rent remedies and communicate the actions to the users of the action history system 100.

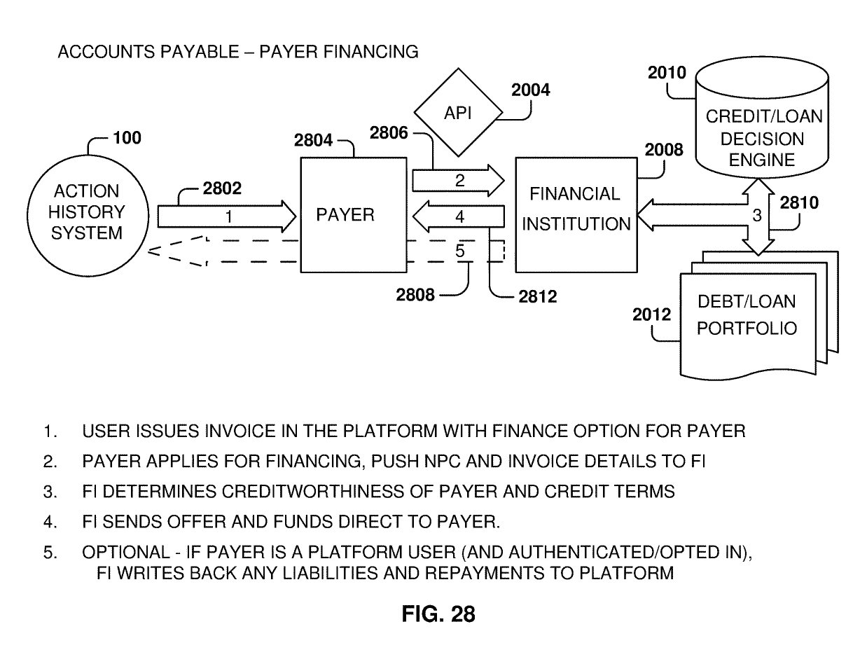

FIG. 28 illustrates a flow of an example method for offering financing choices to the user, according to some embodiments. The action history system 100 communicates 2802 to the payer 2804 when a user issues an invoice in the platform, the invoice including a finance option for the payer 2804.

The payer 2804 applies for financing 2806 with the financial institution 2008 by sending the NPC and invoice details to the financial institution 2008. The financial institution 2008 then determines 2810 the creditworthiness of the payer 2804 and the credit terms.

The financial institution responds by sending 2812 an offer for funds to the payer 2804. The payer 2804 may then approve or disapprove of the offer made by the financial institution 2008. Optionally, if the payer 2804 is a platform user and the payer 2804 has opted in to the program, the financial institution 2008 may communicate 2808 any liabilities and repayments to the action history system 100.

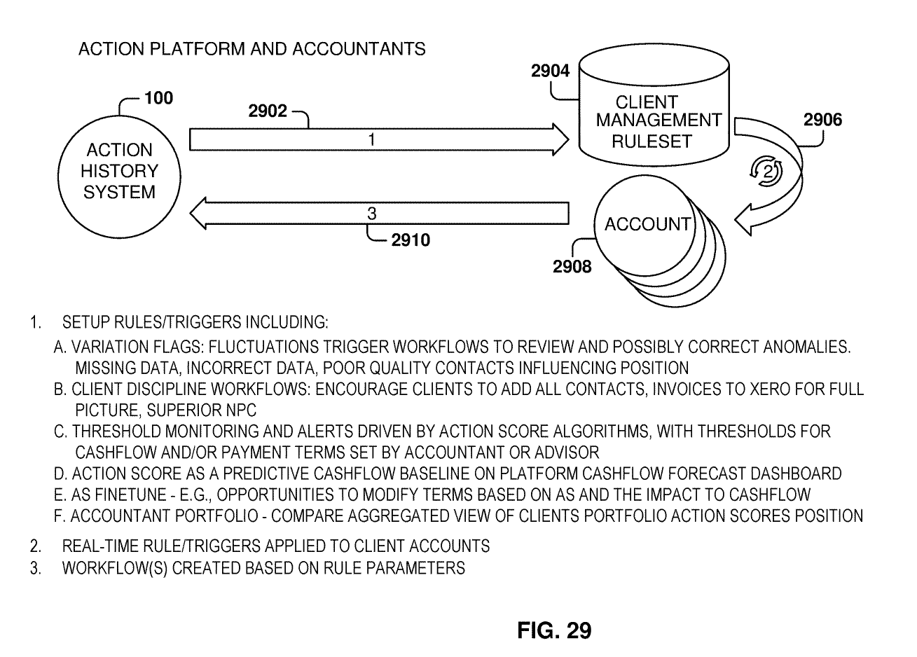

FIG. 29 illustrates a flow of an example method for setting rules and triggers to display information to the user, according to some embodiments. In some instances, the action history system 100 may enable administrators to monitor and facilitate actions of the users. The administrators may be presented with a specialized graphical user interface.

The user may set up rules and triggers in the action history system 100, which are stored 2902 in the client management ruleset database 2904. The rules and triggers may include: variation flags to review and possibly correct anomalies, missing data, incorrect data, poor quality contacts influencing position, etc.; client discipline workflows to encourage clients to add all contacts, invoices to the platform for a full financial picture, including the NPC; threshold monitoring and alerts driven by action score algorithms, with thresholds for cash flow and/or payment terms set by the accountant or advisor 2908; action score as a predictive cash flow baseline on platform cash flow forecast dashboard; financing fine tuning, e.g., opportunities to modify terms based on finances and the impact to cash flow; and accountant portfolio to compare aggregated view of clients portfolio action scores. The rules are applied 2906 in real time to the client accounts and workflows are created 2910 based on the rule parameters.

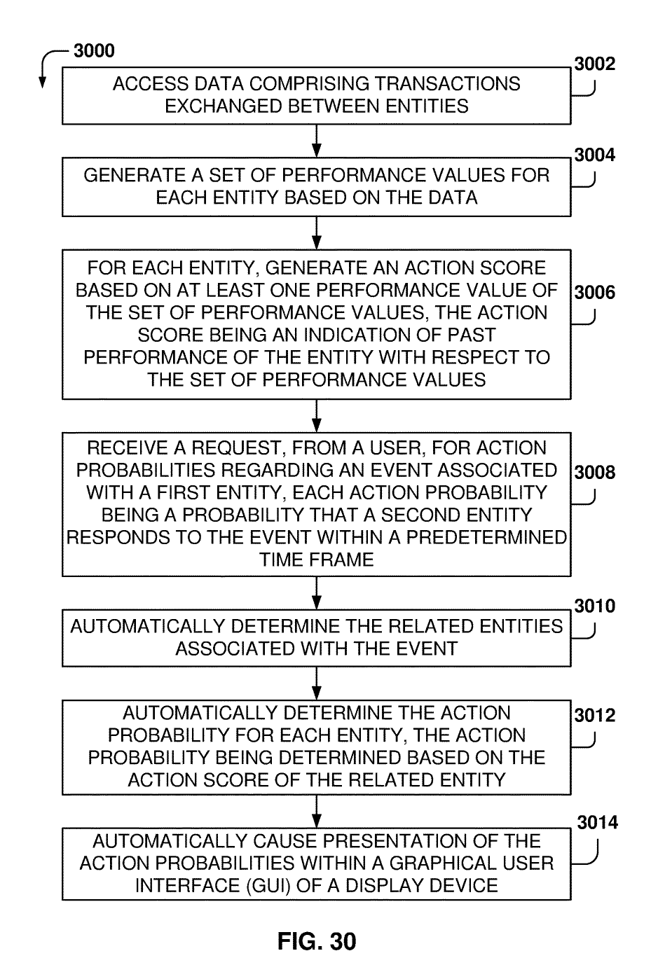

FIG. 30 is a flowchart of a method 3000 for generating action scores based on the performance of entities to determine action probabilities by these entities, according to some example embodiments. While the various operations in this flowchart are presented and described sequentially, one of ordinary skill will appreciate that some or all of the operations may be executed in a different order, be combined or omitted, or be executed in parallel.

Operation 3002 is for accessing, by one or more processors of an action history system and via a network connection, data stored on a database. The data includes transactions exchanged between a set of entities. From operation 3002, the method 3000 flows to operation 3004 for generating, by the action history system, a set of performance values for each entity based on the data.

At operation 3006, for each entity of the set of entities, an action score is generated based on at least one performance value of the set of performance values. The action score is an indication of past performance of the entity with respect to the set of performance values.

From operation 3006, the method 3000 flows to operation 3008 for receiving a request, from a user, for one or more action probabilities regarding an event associated with a first entity. Each action probability is a probability that a second entity responds to the event associated with the first entity within a predetermined time frame.

At operation 3010, the related entities associated with the event are automatically determined, and at operation 3012, the action probability is automatically determined for each entity of the related entities. The action probability is determined based on the action score of the related entity. At operation 3014, presentation of the action probabilities is automatically caused within a graphical user interface (GUI) of a display device.

In one example, generating the action score for the first entity further comprises tracking the transactions of the first entity with other entities, evaluating a performance of the first entity with reference to the event based on the transactions of the first entity with other entities, and calculating the action score for the event based on the evaluated performance.

In one example, the action score is a network predictive cashflow (NPC), where the transactions include payments made by the other entities, where evaluating the performance comprises analyzing a history of payments by the other entities, where calculating the NPC comprises predicting a cash flow for the first entity for a predetermined time period based on the history of payments of the other entities.

In one example, tracking the transactions of the first entity further comprises accessing, from an accounting platform providing accounting services, accounting data of the first entity, where evaluating the performance further comprises accessing, from the accounting platform providing accounting services, accounting data of the other entities.

In one example, causing presentation of the action probabilities further comprises identifying groups of related entities based on values of the action probabilities, and presenting the action probabilities according to the identified groups.

In one example, the method 3000 further comprises receiving a request from an institution for the action score of the first entity, and transmitting the action score to the institution, where the institution determines granting a loan to the first entity based on the action score of the first entity.

In one example, the method 3000 further comprises calculating a second action score for the first entity based on a second event, and calculating a third action score for the first entity based on the action score and the second action score.

In one example, the method 3000 further comprises generating a response recommendation based on the action probabilities, and causing presentation of the response recommendation in the GUI.

In one example, the transactions include a respective time deadline.

The specialized graphical user interface may provide a dashboard of tools and user interface options including alerts, notifications, workflow procedures, and other administrative operations to direct actions of the users. The users, operating in association with a specified administrator, may be synchronized and presented in real time to the administrator. The action history system 100 generates and updates the action score in real time, as described above, and causes presentation of one or more parameters and triggers for the administrator. The triggers may include score thresholds (e.g., triggering an action, notification, or report based on the action score of a user falling below the threshold), behaviors, performance value thresholds, and other triggers or parameters.

Certain embodiments are described herein as including logic or a number of components, modules, or mechanisms. A component is a tangible unit capable of performing certain operations and may be configured or arranged in a certain manner. In example embodiments, one or more computer systems (e.g., a standalone, client, or server computer system) or one or more components of a computer system (e.g., a processor or a group of processors) may be configured by software (e.g., an application or application portion) as a component that operates to perform certain operations as described herein.

In various embodiments, a component may be implemented mechanically or electronically. For example, a component may comprise dedicated circuitry or logic that is permanently configured (e.g., as a special-purpose processor, such as a field programmable gate array (FPGA) or an application-specific integrated circuit (ASIC)) to perform certain operations. A component may also comprise programmable logic or circuitry (e.g., as encompassed within a general-purpose processor or other programmable processor) that is temporarily configured by software to perform certain operations. It will be appreciated that the decision to implement a component mechanically, in dedicated and permanently configured circuitry, or in temporarily configured circuitry (e.g., configured by software) may be driven by cost and time considerations.

Accordingly, the term “component” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which components are temporarily configured (e.g., programmed), each of the components need not be configured or instantiated at any one instance in time. For example, where the components comprise a general-purpose processor configured using software, the general-purpose processor may be configured as respective different components at different times. Software may accordingly configure a processor, for example, to constitute a particular component at one instance of time and to constitute a different component at a different instance of time.

Components may provide information to, and receive information from, other components. Accordingly, the described components may be regarded as being communicatively coupled. Where multiple of such components exist contemporaneously, communications may be achieved through signal transmission (e.g., over appropriate circuits and buses) that connect the components. In embodiments in which multiple components are configured or instantiated at different times, communications between such components may be achieved, for example, through the storage and retrieval of information in memory structures to which the multiple components have access. For example, one component may perform an operation, and store the output of that operation in a memory device to which it is communicatively coupled. A further component may then, at a later time, access the memory device to retrieve and process the stored output. Components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Similarly, the methods described herein may be at least partially processor-implemented. For example, at least some of the operations of a method may be performed by one or more processors or processor-implemented components. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program, including processor executable instructions, tangibly embodied in an information carrier, e.g., in a non-transitory machine-readable storage medium for execution by, or to control the operation of, data processing apparatus, e.g., a programmable processor, a computer, or multiple computers.

A computer program may be written in any form of programming language, including compiled or interpreted languages, and it may be deployed in any form, including as a stand-alone program or as a component, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry (e.g., a FPGA or an ASIC).

The computing system may include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

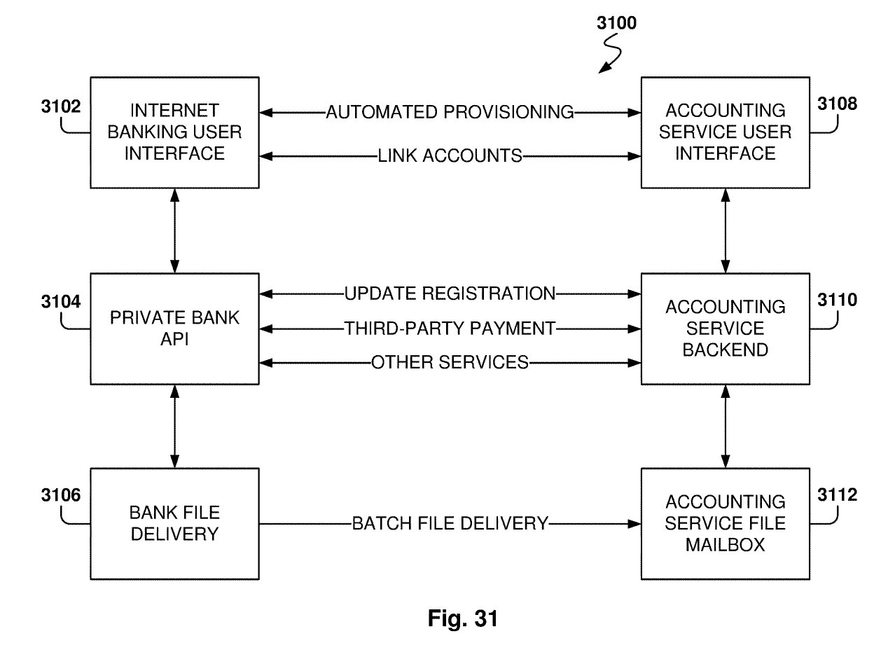

FIG. 31 is a block diagram 3100 depicting an example data flow for interactions between the banking platform and the accounting platform, according to some embodiments. A user (not shown) interacts with the internet banking UI 3102 to select one or more accounts to share with an accounting service provider. The internet banking UI 3102 redirects the user to the accounting service UI 3108.

Further, the accounting service UI 3108 authenticates the user and links the bookkeeping accounts of the user with the bank accounts at the internet banking service. The accounting service UI 3108 further communicates with the accounting service backend 3110 to store the account linkage data, and the accounting service backend 3110 communicates with the bank using the private bank API 3104.

Features provided by the private bank API 3104 include updating the registration for a bank account, making a third party payment drawn from a registered bank account, and other services. The bank file delivery 3106 provides a bank record feed for a registered account via a batch file delivery to the accounting service file mailbox 3112, based on registration of the account via the private bank API 3104. The accounting service file mailbox 3112 provides the received batch file to the accounting service backend 3110, which processes the batch to generate records for the bookkeeping account that correspond to the reported transactions in the received feed file. Additional details of example processes are discussed in more detail below.

Overview of Example Financial Services

According to one example embodiment, there is provided a method and a system for establishing links to bank accounts automatically and for providing a number of complementary services. The example method and system may include three parts, namely:
Automated provisioning of accounts via Internet banking.
Bank-provided services called by the accounting software system via a private application programming interface (API).
Delivery of file data via secure transfer (e.g., Account Feed Service).

Automated provisioning, according to one example embodiment, enables a mutual customer to establish a connection between the accounting software system and the financial institution. This may be achieved by allowing a financial institution customer to opt in to make their feeds from their bank accounts available to the accounting software system within financial Internet software (e.g., hosted and operated by the customer's financial institution). Once a customer selects the bank account they want to share with the accounting software system, the accounting software system links the selected bank account with an account in the accounting software system.

Once these accounts are connected, the accounting software system will register the feed via a private API with the financial institution and request the data to be included in a periodic data feed (e.g., a nightly feed, but other periods are also possible, such as hourly, every 10 minutes, etc.).

If the connected account supports automatic payments, and the customer has requested the service, the customer may also pass payment instructions back from the accounting software system into the Internet banking software of a financial institution for authorization. A variety of services provided by Internet banking software may be connected with the accounting software system.

### Example of Automated Provisioning

Automated provisioning, according to an example embodiment, may include multiple functions, two of which are:
The activation/deactivation of services on the financial institution account for use with the accounting software system.
The management (e.g., mapping) of the financial institution accounts against accounts in the accounting software system.

Activation is the process by which a user identifies, within Internet banking software, which bank accounts the user would like to share with the accounting software system. All accounts may be deactivated by default. An authenticated user of online services may be required to explicitly activate accounts that are to be used with the accounting software system, and optionally select any additional services that they want to use.

Once an account is activated, statement data relating to the account is marked as pending for batched retrieval to the accounting software system, which will later be confirmed by an “UpdateRegistration” service, further details of which are provided below.

### Example of Management of Accounts

Once a financial institution account is activated, the financial institution account can then be connected. Services are not fully enabled against the accounting software account until the financial institution account is connected and the feed registration confirmed.

An authenticated Internet banking user may opt to connect one or more activated accounts. From here, the user is redirected to the accounting software system, which will request the user to authenticate with the accounting software system. After authentication, the user may be requested to select which bookkeeping accounts of the accounting software system they would like to connect their bank accounts that the financial institution.

Once a bank account with the feed service is connected to an accounting software system account, the accounting software system calls the “UpdateRegistration” service. The service registers the account, allowing the latest data for this account to be retrieved on a schedule and loaded into the accounting software system account via a feed. The accounting software system processes the feed data from the financial institution to create or suggest corresponding entries in the single-ledger accounting system. For example, suggested entries can be presented to a user to confirm or modify before the entries in the single-ledger accounting system are created.

When a bank account providing a third party payment service is connected to an accounting software system account, batch payments can be submitted directly to the bank for approval from this account, using the third-party payment service.

Account activation, according to one example embodiment, is a method for the assignation of available accounting software system services against the financial institution accounts. All accounts may be deactivated by default.

A single method, UpdateAS Services, can take a map of accounts and requested accounting system (AS) services and update the active AS services against all of the user's accounts. This method UpdateAS Services updates the AS services activated against a user's set of the financial institution accounts. For example, an execution of UpdateAS Services on the financial system server may cause the transmission of data for each of the user's accounts to the requesting AS. The data may be incremental (e.g., reflect only changes since the last data transmission) or complete for a predetermined time period (e.g., last month, current month, last six months, this year, etc.). Activation may occur within the financial institution's services platform. An authenticated online services user can change the activation status of their financial institution accounts.

A user is presented with a list of accounts available in their online services. Each account has a list of available services that that user can activate against each account. Term deposits may have no services available, credit cards may have Account Feed Service available, and current accounts may have the Account Feed Service and Third Party Payment Service available, depending on which accounts are capable of supporting feeds or batch payments.

Upon making changes to the services against accounts, a map of accounts and services requested to be activated against them are posted to the server. If there are terms and conditions that may be agreed to before data can be shared, such agreement may be obtained before the changes are committed.

Activation creates or assigns a unique identifier for the account (e.g., an AccountID), which is used for all services, and also when connecting the account to an accounting software system account. An AccountID is guaranteed to be unique and to persist, and is always the same for a given account (e.g., even if it's disconnected and reconnected). An AccountID may be included in the feed of transactions and may be allowed in the payment batch file format as the primary key. The AccountID may be an identifier that is already in use at the financial institution (including the account number), but security concerns recommend against using a credit card number or sensitive information as the AccountID.

Activation may be performed by a user authenticated by the financial institution with access to presented accounts. The new map of activated AS services may be saved against the user's list of accounts—assigning new AS services and deactivating ones that have been removed.

No service is activated against an account unless those services are listed within the account's available AS services. If an account has had the Account Feed Service added as part of the update, the account is marked as pending for inclusion in the nightly batch file. If an account has had the Account Feed Service removed as part of the update, it is removed from the batch file. If this is the first time an account has been activated, a unique AccountID is assigned or generated.

Account connection and disconnection is handed over to the accounting software system to complete. For example, transfer to the accounting software system may be done via an HTTPS POST, triggered by the user from within the online financial software.

In some embodiments, the online financial customer clicks submit and the form post is intercepted, an AJAX request retrieves the above information in encrypted form and inserts it into the form's variables, the form is then posted. In order to complete the connection or disconnection, the user authenticates with the accounting software system with a valid user account.

### Example Data Structures and Algorithms

Described next is the format, according to an example embodiment, of the data transferred from the financial institution to the accounting software system via the user's browser, when initiating or managing account feeds.

The data transferred may be sent from the financial institution to the accounting software system, according to some example embodiments. The data may be transferred via the user's web browser client, as an encrypted, signed binary large object (BLOB) contained within a JavaScript object notation (JSON) data structure.

The financial institution assembles a BLOB of data (e.g., the AccountMapMessage, discussed in more detail below) containing information about the bank accounts that the user has opted to connect to the accounting software system. This BLOB contains unique identifiers, account numbers, balances, and other sensitive information, and hence can be encrypted so the data within is opaque to the client browser transferring the data.

The AccountMapMessage data may be transferred by first encrypting the data, and then generating a message authentication code (MAC) for the encrypted data. This may be referred to as the “encrypt then MAC” pattern. For example, a symmetric key is randomly generated, and used to encrypt the AccountMapMessage data. The financial institution, sending the data, has the accounting software system's public RSA key that they use to encrypt the symmetric key. The accounting software system, receiving the data, uses its private RSA key to decrypt the symmetric key and in turn uses it to decrypt the message.

The financial institution has a private RSA key used to sign messages sent to the accounting software system. The accounting software system uses the financial institution's public RSA key to verify that the signature is valid. In example embodiments, various cryptographic algorithms may be used, such as advanced encryption standard (AES) for symmetric encryption, the RSA algorithm (named after Ron Rivest, Adi Shamir, and Leonard Adleman) for asymmetric encryption, and the secure hash algorithm (SHA) RSA-SHA2 for signing.

For cryptographic keys generated and used in the system, minimum key sizes may be specified. For example, an AES or SHA key may be a minimum of 256 bits, and an RSA key may be a minimum of 2048 bits. Cryptographic systems may make use of nonce and initialization vector values. The nonce is a value used once for a particular message and then discarded. The nonce generation algorithm may ensure that the nonce is unique among messages sent with the same timestamp, unique among messages from the same party, or use another criterion for selection of the nonce. In one example embodiment, a random nonce is generated and compared to previously-used values. If the nonce is acceptable, it is used. If the nonce is not acceptable, a new random nonce is generated and the process is repeated.

An initialization vector is an input to the cryptographic system. Typically, the initialization vector is generated randomly. In some example embodiments, the initialization vector is generated using the nonce as an input to the initialization vector generation algorithm.

Nonce and initialization vectors may be generated from a cryptographically secure random number generator. This ensures that the symmetric encryption will be strong and prevent brute force attacks against the encrypted data byes in the message. As the generation of nonce and initialization vector is performed by the financial institution, the accounting software system may request confirmation of the method used in order to confirm that the generation process is sufficiently random.

For example, a number of default random number generators are not cryptographically secure. Instead, a cryptographically secure algorithm may be chosen (e.g. in C#, the System. Security.Cryptography.RandomNumberGenerator class should be used instead of the System.Random class).

Example data structures that may be used by the financial institution to implement the discussed cryptographic features include:

| Identifier | Description | Usage |
|---|---|---|
| FI_PrivKey | Financial | A private RSA key issued and held |
| | institution's | only by the financial institution. |
| | private key | |
| X_PubKey | The accounting | A public RSA key issued by the |
| | software system | accounting software system. |
| | public key | (Provided to financial institution by the |
| | | accounting software system when the |
| | | integration is set up) |

Example data structures that may be used by the accounting software to implement the discussed cryptographic features include:

| Identifier | Description | Usage |
|---|---|---|
| X_PrivKey | The accounting | A private RSA key issued and held |
| | software system's | only by the accounting software |
| | private key | system. |
| FI_PubKey | financial | A public RSA key issued by the |
| | institution's | financial institution. |
| | public key | (Provided to the accounting software |
| | | system by financial institution when |
| | | the integration is set up) |

The financial institution may use the following example algorithm to package a message for receipt by the accounting software system. In the pseudo-code below, the JSON AccountMapMessage, containing the sensitive data, is encrypted and signed, and then the resulting MessageContainer is sent to the accounting software system as a JSON data structure via the user's browser.

| | |
|---|---|
| PlainTextDataString = | Base64Encode(AccountMapMessage) |
| IVBytes = | GenerateRandomIV( ) |
| EncryptedIV = | RSAEncrypt(IVBytes, X_PubKey) |
| RandomKeyBytes = | GenerateRandomKey( ) |
| EncryptedRandomKey = | RSAEncrypt(RandomKeyBytes, X_PubKey) |
| EncryptedDataBytes = | AESEncrypt(PlainTextDataString, |
| | RandomKeyBytes, IVBytes) |
| SignatureBytes = | CalculateSHA2Signature( |
| | EncryptedIV + EncryptedRandomKey + |
| | EncryptedDataBytes, |
| | FI_PrivKey) |
| MessageContainer.PC = | “PROVIDER/BANKXYZ” |
| MessageContainer.EIV = | Base64Encode(EncryptedIV) |
| MessageContainer.ERK = | Base64Encode(EncryptedRandomKey) |
| MessageContainer.Data = | Base64Encode(EncryptedDataBytes) |
| MessageContainer.S = | Base64Encode(SignatureBytes) |
| MessageContainer.SM = | “RSA-SHA2” |

Verifying and unpackaging a message upon receipt by the accounting software system may be performed as follows. Upon the receipt of a message from the financial institution, the accounting software system may decrypt and unpack the message to ensure it has come from the financial institution, and has not been tampered with. The following algorithm, shown as pseudo-code, may be used to unpack the MessageContainer and receive the AccountMapMessage.

| EncryptedIV = | Base64Decode(MessageContainer.EIV) |
|---|---|
| EncryptedRandomKey = | Base64Decode(MessageContainer.ERK) |
| EncryptedDataBytes = | Base64Decode(MessageContainer.Data) |
| SignatureBytes = | Base64Decode(MessageContainer.S) |
| (Check MessageContainer.SM == “RSA-SHA2”) | |
| VerifySignatureBytes = | CalculateSHA2Signature( |
| | EncryptedIV + EncryptedRandomKey + |
| | EncryptedDataBytes, |
| | FI_PubKey) |
| (Check VerifySignatureBytes == SignatureBytes) | |
| IVBytes = | RSADecrypt(EncryptedIV, X_PrivKey) |
| RandomKeyBytes = | RSADecrypt(EncryptedRandomKey, |
| | X_PrivKey) |
| PlainTextDataString = | AESDecrypt(EncryptedDataBytes, |
| | RandomKeyBytes, IVBytes) |
| AccountMapMessage = | Base64Decode(PlainTextDataString) |

The accounting software system may then validate the internals of the AccountMapMessage to check whether it has integrity. Validating the origin of the message may be performed by verifying that the Check AccountMapMessage.ProviderID matches MessageContainer.PC. Validating that the message is current may be performed by verifying that TimeStampUTC is within the tolerance for valid messages, and the message has not expired. Validating that the message is not a replay attempt may be performed by verifying that the (TimeStampUTC, Nonce) pair have not been used for this provider. Other validation of message contents that may be performed

If all of these verification and unpackaging operations succeed, then in certain embodiments, the user is shown screens allowing them to continue the activation process within the accounting software system.

The message encryption and packaging described above may be implemented to allow messages to pass from the financial institution to the accounting software system over an untrusted communication mechanism (e.g., over the Internet via the user's browser).

The encryption and signing may provide guarantees that the message was legitimately generated by the financial institution, not tampered with or viewed in transit, and cannot be replayed. The financial institution can also be assured that only the accounting software system will be able to decrypt the data. Various security threats are discussed in more detail below.

With regards to spoofing, it is not possible for anyone other than the financial institution to generate a valid message, due to the use of the public/private key pair shared between the accounting software system and the financial institution.

With regards to repudiation, the financial institution signs the data using their private key, which is kept secret and held only by them. When the accounting software system receives the message and checks the signature using the financial institution's public key, they can be assured that the financial institution originally generated the message.

With regards to tampering, the signature check also prevents tampering in transit. If the IV, key or data is altered, then the signature check will fail.

With regards to Information Disclosure, the AccountMapMessage may contain some sensitive information, such as bank account balances or account numbers. This is encrypted using a one-time-use encryption key. The encryption key is transmitted in the message, but is encrypted asymmetrically using the accounting software system's public key, which only the accounting software system can decrypt.

With regards to Replay, Replay attacks are prevented by a timestamp and nonce value, which allows the accounting software system to guarantee it will receive and process a given message only once. If a message arrives with the same timestamp and nonce, the accounting software system will reject the message.

With regards to Man-in-the-middle attacks, it is possible for an attacker to intercept the generated JSON from the financial institution, and forward it to the accounting software system before the legitimate user is able to. This is mitigated by SSL/TLS connections being used in the user's browser, preventing MiTM on the client side, and the use of a short expiration against the message timestamp. As the user is not required to perform any action between the message generation and the immediate POST to the accounting software system, the expiration can be kept short.

With regards to Denial of Service attacks, this protocol does not provide protection against denial of service—an attacker could send large, malformed, or numerous messages to the accounting software system endpoint and incur a costly signature check or decryption process to occur. This will be mitigated by using the accounting software system's standard brute force detection mechanisms.

With regards to Elevation of Privilege, the message transferred from the financial institution to the accounting software system does not convey privileges from one environment to the other. The user still has to authenticate independently with both the financial institution's site and with the accounting software system.

### Financial Institution Data Examples

Data provided by the financial institution may indicate an account type for each financial account of the user. For example, the C# class below can be used to implement an account type indicator. Similarly, the JSON example below may be used to indicate that an account is a current account.

### Sample C# Class:

```
public enum AccountType
{
    CreditCard = 1,
    Current = 2,
    Savings = 3,
    Loan = 4,
    Investment = 5,
    Foreign = 6,
    Other = 7,
}
```

### Sample JSON Value:

{
“AccountType”: 2
}

Data provided by the financial institution may indicate one or more services provided for each financial account of the user. For example, the C# class below can be used to implement a service type indicator. Similarly, the JSON example below may be used to indicate that both an account feed service and a third party payment service are available for an account.

### Sample C# Class:

```
public enum ASService
{
    AccountFeedService = 1,
    ThirdPartyPaymentService= 2,
}
```

### Sample JSON Value:

```
{
    “ServicesAvailable”: [
        1,
        2
    ]
}
```

Data stored at the AS system can reflect information about a financial account at the financial institution, including services available for that financial account. Below is a table of data types and descriptions for values that can be used in a C# class to store such account-specific data.

| Name | Type | Description |
|---|---|---|
| AccountID | String(50) | Financial institution's account |
| | | identifier. |
| | | Globally unique. |
| AccountNumber | String(50) | Financial institution's supplied |
| | | account number. |
| | | Masked to last 4 digits if credit |
| | | card PAN. |
| AccountDescription | String(50) | Financial institution's supplied |
| | | account description. |
| ServicesAvailable | ASService | The services that can be activated |
| | (0 . . . 1) | on this account. |
| ServicesActivated | ASService | The services that are activated on |
| | (0 . . . 1) | this account. |
| CurrentBalance | Signed | Financial institution's supplied |
| | Decimal | account balance. |
| AccountType | AccountType | The type of account. |
| Currency | Char(3) | ISO4217 currency code for the |
| | | account. |

### Sample C# Class:

```
public class ActiveAccountServiceMap
{
    public string AccountID;
    public string AccountNumber;
    public string AccountDescription;
    public ASService[ ] ServicesAvailable;
    public ASService[ ] ServicesActivated;
    public decimal CurrentBalance;
    public AccountType AccountType;
    public string Currency;
}
```

### Sample JSON Value:

```
{
    “AccountID”: “1123451111111100”,
    “AccountNumber”: “1123451111111100”,
    “AccountDescription”: “My Current Account”,
    “ServicesAvailable”: [
        1,
        2
    ],
    “ServicesActivated”: [
        1
    ],
    “CurrentBalance”: 213.97,
    “AccountType”: 2,
    “Currency”: “NZD”
}
```

Another example data type is the AccountMapMessage, containing the complete message indicating activated accounts to be sent from the financial institution to the accounting software system.

| Name | Type | Description |
|---|---|---|
| ProviderID | String(50) | Accounting system's identifier for |
| | | the financial institution |
| UserID | String(50) | Identifier that is unique to the |
| | | online services user. |
| ActiveAccountServiceMaps | ActiveAccountServiceMap | A list of maps, each containing |
| | (1 . . . *) | details for one account at the |
| | | financial institution. |
| TimestampUTC | DateTime | The time that the message was |
| | (e.g. | constructed by the caller. |
| | “2000-12- | Used to expire messages that have |
| | 29T00:00:00Z”) | passed a timeout threshold. |
| Nonce | String(255) | The Nonce value should be unique |
| | | for all requests with that |
| | | TimestampUTC. |
| | | The nonce allows the server to |
| | | verify that a request has never |
| | | been made before and helps |
| | | prevent replay attacks. |
| | | The server will cache all |
| | | (ProviderID, TimestampUTC, |
| | | Nonce) tuples until after the |
| | | expiration of the messages, and |
| | | reject any |
| | | un-expired messages that have |
| | | already been received. |
| ReturnURL | String(255) | A url to redirect the user to, upon |
| | (well-formed absolute | completion of the mapping |
| | url) | process. |
| | | If absent/null, then the user will |
| | | remain on the accounting software |
| | | system website. |
| | | Non-null urls must begin with http |
| | | or https://, use the default port, |
| | | and may be checked against a list |
| | | of valid domain names for the |
| | | provider bank. |

### Sample C# Class:

```
public class AccountMapMessage
{
    public string ProviderID;
    public string UserID;
    public ActiveAccountServiceMap[ ] ActiveAccountServiceMaps;
    public DateTime TimestampUTC;
    public string Nonce;
    public string ReturnURL;
}
```

### Sample JSON Value:

```
{
    “ProviderID”: “PROVIDER/BANKXYZ”,
    “UserID”: “user@bank”,
    “ActiveAccountServiceMaps”: [
        {
            ...
        },
        {
            ...
        }
    ],
    “TimestampUTC”: “2012-12-10T00:00:00”,
    “Nonce”: “A7813747-C47A-496E-8DE6-682D16A457D2”,
    “ReturnURL”: “https://www.xyz.com/”
}
```

Another example data type is the MessageContainer, containing the message that is sent from the financial institution to the accounting software system via the user's browser. Each Byte[ ] is transmitted as a Base 64 encoded string when rendered as JSON.

| Name | Type | Description |
|---|---|---|
| PC | String(50) | The accounting software system's identifier for the |
| | | financial institution |
| Data | Byte[ ] | An encrypted blob of data |
| ERK | Byte[ ] | Encrypted Random Key |
| | | The key used to encrypt/decrypt the data blob. |
| | | Should be encrypted with the accounting software |
| | | system's public key. |
| EIV | Byte[ ] | Initialization Vector used when encrypting data. |
| | | Should be encrypted with the accounting software |
| | | system's public key. |
| S | Byte[ ] | The signature calculated when running the request |
| | | signing method over the Encrypted IV, Encrypted |
| | | Random Key and Data fields. |
| SM | String(50) | The method used to calculate the message signature. |
| | | If not specified, the default of “RSA-SHA2” is |
| | | assumed. |

### Sample C# Class:

```
public class MessageContainer
{
    public string PC;
    public byte[ ] Data;
    public byte[ ] ERK;
    public byte[ ] EIV;
    public byte[ ] S;
    public string SM;
}
```

### Sample JSON Value:

{
“PC”: “PROVIDER/BANKXYZ”,
“Data”: “qas43...==”,
“ERK”: “Rxut...==”,
“EIV”: “QEDF...==”,
“S”: “zyw...==”,
“SM”: “RSA-SHA2”
}

(Base 64 encoded values elided)

### Example of User Account Management

Once the user has been redirected from the financial institution to the accounting software system, and the appropriate information passed, the accounting software system can associate each AccountID with a user's accounting software system account. If an account is connected, then the active AS services are provided to that account.

The user can manage accounts that have already been connected. In this case, they can be shown the status of the connection and be enabled to disconnect the accounts if they wish. If an account is disconnected, then the active AS services are removed from that account.

In embodiments, prior to allowing a user to manage an account, one or more of the following preconditions is verified.
The user is authenticated with the accounting software system.
The ProviderCode is recognized.
The random key can be decrypted with the accounting software system's private key.
The request data can be decrypted with the random key.
The signature is verified with financial institution's public key.
The ProviderID is a valid provider.
The nonce has not been used before.
The data is able to be parsed and all required elements are included.
At least one AccountServiceMap with an Active Service is included in the list of ActiveAccountServiceMaps.
The timestamp is within a valid timeout period.

### Example Private Financial API

In some embodiments, in order for the accounting software system to share services with the financial institution, the financial institution exposes a number of services to the accounting software system. These allow the accounting software system to perform actions against the financial institution when instructed by the customer. Additional services may also be supported.

The financial institution may implement a small web service that accepts and responds to JSON POST requests. The specifications for expected requests and responses are below.

Access to the financial services endpoint may be secured by VPN and usable only by the accounting software system. The complete URL for the service is unique to the providing financial institution, but the endpoints may be the same for all participating financial institutions. Example endpoints are given below with each service.

With respect to third party payments, once the financial institution account has been activated and connected with a third party payment service, a batch payment against that account can be submitted to the financial institution. If an account has the third party payment service against it, when an accounting software system user creates a batch payment as part of their management of accounts payable, they have the option to directly submit that batch to the financial institution for authorization and completion.

A representational state transfer (REST) architecture may support a RESTful interface between a client and a server. The RESTful interface may be stateless (e.g., no client context may be stored on the server between requests). The RESTful interface may be cacheable (e.g., responses from the server may indicate if they are cacheable). A client may cache the cacheable responses, reducing network traffic and latency. The RESTful interface may be layered (e.g., the client may connect to an intermediate server rather than an end server). The RESTful interface may identify the resources involved in each request in order to allow the client to modify the resources it possesses. Furthermore, in a stateless RESTful interface, each REST message may be self-contained and include enough information to describe how to process the message. Some clients may track their own state and make state transitions only through hypermedia (e.g., hyperlinks).

The third-party payment request may be a RESTful HTTP request that posts a JSON message and expects a JSON response. The format of example JSON requests and responses are provided below.

Third Party Payment Request—Request that a payment or batch of payments be made from an account of the user to a third party. The request is made by the AS to the financial institution. In some example embodiments, the bank executes the payment based on the payment request, without further intervention from the account holder. In other example embodiments, after receiving the payment request from the accounting application, the bank holds the payment for authorization from the account holder. For example, the bank may present a list of requested payments to the account holder via a mobile application or web interface, and execute the payments only after receiving an authorization from the account holder.

### Endpoint: /Thirdpartypayment

Each item in a batch describes a single transaction. Example elements of a batch item:

| Element Name | Type | Description |
|---|---|---|
| AccountNumber | String(20) | This is the account number for the account |
| | | to which the payment is being made. |
| Amount | Signed | This represents the amount of payment |
| | Decimal | being made to the recipient account. |
| Name | String(50) | Name of the Payee |
| Particulars | String(50) | These are the Particulars, Code and |
| Code | String(50) | Reference details pertaining to the |
| Reference | String(50) | payment recipient account |
| | | AccountNumber. These values may be |
| | | used by the financial institution. |

### Example Elements of a Third Party Payment Request:

| Element Name | Type | Description |
|---|---|---|
| ProviderCode | String(50) | Name of the provider (e.g. “Xero”) |
| UserID | String(50) | This is the financial institution's customer |
| | | number/unique identifier for the user making |
| | | the payment. The UserID was passed to the |
| | | accounting software system through the |
| | | linking service. |
| AccountID | String(20) | This is the financial institution's account ID |
| | | for the account from which the payment is |
| | | made. The AccountID was passed to the |
| | | accounting software system through the |
| | | linking service. |
| FromParticulars | String(50) | These are the Particulars, Code, and Reference |
| FromReference | String(50) | details pertaining to the AccountID, for use by |
| FromCode | String(50) | the financial institution. |
| PaymentDate | Date | The date the payment is due to go out of the |
| | | ‘FromAccount’. It should adhere to ISO 8601. |
| BatchItems | Array(1 . . . *) | Array of batch items that construct the |
| | | payment batch including at least one element. |
| | | A single payment will be an array of one |
| | | element. |
| TotalAmount | Signed | This is the total of the Amount fields of the |
| | Decimal | payment line items contained within the |
| | | payment batch. |

### Sample Request:

### Header:

```
POST /thirdpartypayment
Content-Type: application/json
Message:
{
    “ProviderCode” : “Xero”,
    “UserID” : “12312323”,
    “AccountID” : “060158390390200”,
    “FromParticulars” : “PayerName”,
    “fromReference” : “PayerReference”,
    “fromCode” : “PayerCode”,
    “PaymentDate” : “2012-12-13”,
    “BatchItems” : [
    {
        “AccountNumber” : “040932093021903”,
        “Amount” : “323.00”,
        “Name” : “Payee”,
        “Particulars” : “PayeeName”,
        “Reference” : “PayeeReference”
        “Code” : “PayeeCode”,
    }
    ],
    “TotalAmount” : “323.00”,
}
```

Third Party Payment Response—The financial institution provides a response to the third party payment request.

The response returns HTTP status to report the success of the request. If there is a server error, the message will include a JSON packet that contains a non-empty array of error messages. The batch should be processed in full, returning a 200 status, or not processed at all, returning a 500 error and the relevant error messages.

Example Elements of an Error Message Type:

| Element | | |
|---|---|---|
| Name | Type | Description |
| ErrorMessage | Array of | Error message details provided by the |
| | String(250) | financial institution. These are then |
| | | displayed as ‘error notifications’ to the |
| | | accounting software system user so should |
| | | be user readable. |

Sample Response:

### Header:

### HTTP/1.1 200 OK

Sample Error Response:

### Header:

### HTTP/1.1 500 Server Error

### Message:

```
{
    “ErrorMessage”: [
        “Human readable error message”,
        “Can be multiple lines”
    ],
}
```

Update Registration Request is a request to update the registration data at the financial institution for an account already registered. The request is made from the accounting software system to the financial institution. Updating the registration data for a financial account may include registering a feed for the account with the bank, disconnecting the financial account from the corresponding the accounting software system account, or otherwise changing the registration of the account.

The accounting software system may implement a periodic job to identify disconnected accounts and verify that they meet certain criteria (e.g., time period for which they have been disconnected, etc.), prior to updating their status to show that they have been deregistered. The requests may be submitted in a batch.

Endpoint: /Updateregistration

Each item in a batch request indicates a single account to update. Example elements of a request for update of a single account:

| Element | | |
|---|---|---|
| Name | Type | Description |
| UserID | String(50) | Financial institution's customer |
| | | number/unique identifier. |
| AccountId | String(50) | Financial institution's account identifier. |
| | | Unique within the financial institution. |
| AccountStatus | String(50) | Valid values are “Register” or |
| | | “Deregister”. Indicates whether an |
| | | account's data should be included in the |
| | | nightly feed provided to the accounting |
| | | software system. Typically an account will |
| | | be registered once connected to the |
| | | accounting software system account, and |
| | | deregistered on customer instruction, on the |
| | | deletion of their subscription or if they have |
| | | been removed from an organisation. |

Example Elements of an Update Registration Request:

| Element Name | Type | Description |
|---|---|---|
| ProviderCode | String(50) | Name of the provider |
| | | (e.g. “Xero”) |
| AccountsToUpdate | Array(1 . . . *) | Array of accounts that |
| | | will be registered or |
| | | deregistered for feeds |

### Header:

### POST/Updateregistration

### Content-Type: Application/Json

### Message:

```
{
    “ProviderCode” : “Xero”,
    “AccountsToUpdate” : [
        {
            “UserID” : “234324324”,
            “AccountID” : “23432432432”,
            “AccountStatus” : “Register”
        }
    ]
}
```

With regards to the Update Registration Response, the financial institution provides a response to the Update Registration Request. Additionally, upon receiving a registration or deregistration request, the financial institution may add or remove the account from the list of accounts used in the feed provided to the accounting software system.

The update registration request may be processed in full, returning a 200 status, or not processed at all, returning a 500 error and the relevant error messages for the accounts that could not be registered or deregistered.

Example Elements of an Error Response from the Financial Institution:

| Element | | |
|---|---|---|
| Name | Type | Description |
| UserID | String(50) | This is the financial institution's customer |
| | | number/unique identifier |
| AccountID | String(50) | Financial institution's Account identifier. |
| | | Unique within the financial institution. |
| ErrorMessage | Array of | Error message details provided by the |
| | String(250) | financial institution. |

Sample Success Response:

### Header:

### HTTP/1.1 200 OK

### Sample Error Response:

### Header:

### HTTP/1.1 500 Server Error

### Message:

```
{
    “ErrorResults”: [
        {
            “UserID” : “234324324”,
            “AccountId” : “23432432432”,
            “ErrorMessage” : [
                “Human readable error message”,
                “Can be multiple lines”
            ]
        }
    ],
}
```

### Other Data Types

The table below contains additional data types that are used in various embodiments at either or both of the accounting service and the financial institution.

| Name | Source | Type | Description |
|---|---|---|---|
| ASService | Shared | Enum | Indicates a type of service, such as |
| | | | AccountFeed or ThirdPartyPayment. |
| AccountType | Shared | Enum | Indicates a type of account such as |
| | | | CreditCard, Current, Savings, Loan, |
| | | | Investment, Foreign, or Other. |

The table below contains additional data that is used in various embodiments at the financial institution.

| | | | |
|---|---|---|---|
| Name | Source | Type | Description |

Global

| | | | |
|---|---|---|---|
| ProviderCode | Accounting | String(50) | Used so that accounting |
| | System | | software can recognize |
| | | | partner before decryption. |
| ProviderID | Accounting | String(50) | Used so that the |
| | System | | accounting software |
| | | | system can confirm |
| | | | recognition of partner |
| | | | after decryption. |
| FI Private Key | Financial | Byte[ ] | Private key of the |
| | Institution | | financial institution for |
| | | | encryption/decryption. |
| AS system Public Key | Accounting | Byte[ ] | Public key of the AS |
| | System | | system for |
| | | | encryption/decryption. |

For each financial institution user

| | | | |
|---|---|---|---|
| UserID | Financial | String(50) | Identifier that is unique to |
| | Institution | | the online services user. |
| Accounts | Financial | Account(0 . . . *) | All accounts the user has |
| | Institution | | access to. |

For each financial institution account

| | | | |
|---|---|---|---|
| AccountID | Financial | String(50) | Should be unique to |
| | Institution | | account, persistent to |
| | | | user, even if disconnected/ |
| | | | reconnected. Should be |
| | | | used when connecting |
| | | | and in nightly feed file. |
| | | | Will be used to submit |
| | | | batch payments. |
| MaskedAccountNumber | Financial | String(50) | Credit card numbers |
| | Institution | | should be masked up |
| | | | until the last four digits. |
| AccountDescription | Financial | String(50) | Description for the |
| | Institution | | account. |
| ServicesAvailable | Financial | ASService | The services that can be |
| | Institution | (0 . . . *) | activated on this account. |
| ServicesActivated | Financial | ASService | The services that are |
| | Institution | (0 . . . *) | activated on this account. |
| CurrentBalance | Financial | Signed Decimal | Balance of the account |
| | Institution | | |
| AccountType | Financial | AccountType | The type of account |
| | Institution | (1) | |
| Currency | Financial | Char(3) | ISO standard currency |
| | Institution | | code for account balance |
| | | | (ISO 4217) |

The table below contains additional data that is used in various embodiments at the accounting system.

| | | | |
|---|---|---|---|
| Name | Source | Type | Description |

Global

| | | | |
|---|---|---|---|
| Providers | Accounting | Providers(1 . . . *) | Used so that the |
| | System | | accounting software |
| | | | system can |
| | | | recognize partner |
| | | | before decryption. |
| FI Public Key | Financial | Byte[ ] | The public key of |
| | Institution | | the financial |
| | | | institution for |
| | | | encryption/decryption. |
| AS Private Key | Accounting | Byte[ ] | The private key of |
| | System | | the accounting |
| | | | system for |
| | | | encryption/decryption. |

For each financial institution

| | | | |
|---|---|---|---|
| ProviderCode | Accounting | String(50) | Used so that the |
| | System | | accounting software |
| | | | system can |
| | | | recognize partner |
| | | | before decryption. |
| ProviderID | Accounting | String(50) | Used so that the |
| | System | | accounting software |
| | | | system can confirm |
| | | | recognition of |
| | | | partner after |
| | | | decryption. |

For each financial account

| | | | |
|---|---|---|---|
| AccountID | Accounting | GUID | Accounting software |
| | System | | system's account |
| | | | identifier |
| ProviderAccountID | Financial | String(50) | Financial |
| | Institution | | institution's account |
| | | | identifier |
| ProviderAccountNumber | Financial | String(50) | Financial |
| | Institution | | institution's supplied |
| | | | account number |
| ProviderAccountDescription | Financial | String(50) | financial institution's |
| | Institution | | supplied account |
| | | | description |
| ProviderServicesActivated | Financial | ASService | financial institution's |
| | Institution | (0 . . . *) | supplied account's |
| | | | activated services |
| ProviderCurrentBalance | Financial | Signed | financial institution's |
| | Institution | Decimal | supplied account's |
| | | | balance |
| ProviderAccountType | Financial | AccountType | financial institution's |
| | Institution | | supplied account's |
| | | | type |
| ProviderCurrency | Financial | Char(3) | financial institution's |
| | Institution | | supplied account's |
| | | | currency |

Example Account Feed Service with File Delivery

Batched Supply of Statement Data

The financial institution can submit data to the accounting software system in a batch. In some embodiments, the financial system verifies that each account has been activated, registered, and confirmed prior to adding data for the account to the batch.

The financial institution may post the latest transactions for all active and confirmed accounts via a periodic (e.g., nightly) batch file over secure file transfer protocol (SFTP). The batch contains statement data for all accounts that are marked as activated, or a subset thereof. The batch file may be keyed by AccountID. If the accounting software system encounters an AccountID that is not recognized (e.g., activated but not connected), the data is ignored. Otherwise the data is loaded into the accounting software system account associated with that AccountID. The accounting software system processes the feed data from the financial institution to create corresponding entries in the single-ledger accounting system.

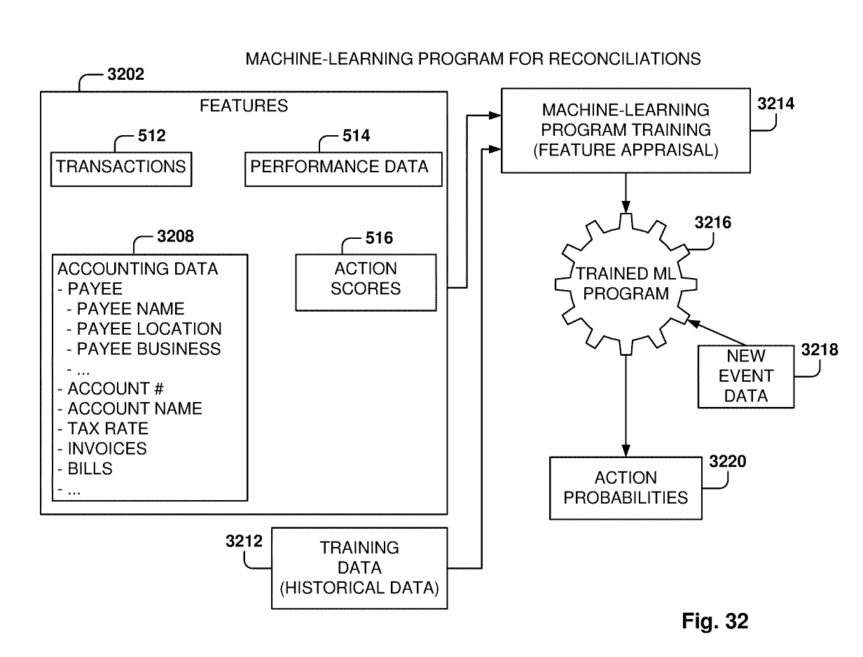

FIG. 32 illustrates the process for training and using the machine-learning program, according to some example embodiments. In some example embodiments, machine-learning programs, also referred to as machine-learning algorithms or tools, are utilized to perform operations associated with the action history system, such as to calculate action probabilities for one or more events.

Machine learning is a field of study that gives computers the ability to learn without being explicitly programmed. Machine learning explores the study and construction of algorithms, also referred to herein as tools, which may learn from existing data and make predictions about new data. Such machine-learning tools operate by building a model from example training data 312 in order to make data-driven predictions or decisions expressed as outputs or assessments (e.g., reconciliation suggestions 320). Although example embodiments are presented with respect to a few machine-learning tools, the principles presented herein may be applied to other machine-learning tools.

In various example embodiments, different machine-learning tools are used. For example, Multinomial Naive Bayes (MNB), Support Vector Machines (SVM), multinomial Logistic Regression (LR), Random Forest (RF), neural networks (NN), matrix factorization, and other tools may be used for generating reconciliations.

In general, there are two types of problems in machine learning: classification problems and regression problems. Classification problems aim at classifying items into one of several categories (for example, is this object an apple or an orange?). Regression algorithms aim at quantifying some items, for example, by providing a value that is a real number (e.g., what is the probability that this bank entry reconciles to a given payee). In some embodiments, example machine-learning algorithms provide action probabilities 3220 associated with an event (e.g., payment of an invoice on time). The machine-learning algorithms utilize the training data 3214 to find correlations among identified features 3202 that affect the outcome.

In one example embodiment, the features 3202 may be of different types and may include one or more of transaction features 512, performance data 514, accounting data features 3208, and action scores 516. Other embodiments may also utilize additional features.

The transaction features 512 includes data about bank transactions, such as description of the transaction, amount, and date. The performance data 514 includes evaluated performance metrics, as described above with reference to FIG. 5A. The accounting data features 3208 include information about the accounting system and includes information about payees (e.g., payee name, payee location or locations, payee business, payee address, payee contact name, etc.), account numbers, account names, tax rates, invoices, bills, and so forth.

In some example embodiments, the training data 312 includes historical values (e.g., previous data) for the features 3202, such as a history of payments and when the payments are made for invoices.

With the training data 3212 and the identified features 3202, the machine-learning tool is trained at operation 3214. The machine-learning tool appraises the value of the features 3202 as they correlate to the training data 3212. The result of the training is the trained machine-learning program 3216.

When the machine-learning program 3216 is used to perform an assessment, new data 3218 (e.g., a new invoice or a new loan application) is provided as an input to the trained machine-learning program 3216, and the machine-learning program 3216 generates one or more action probabilities 3220 as output.

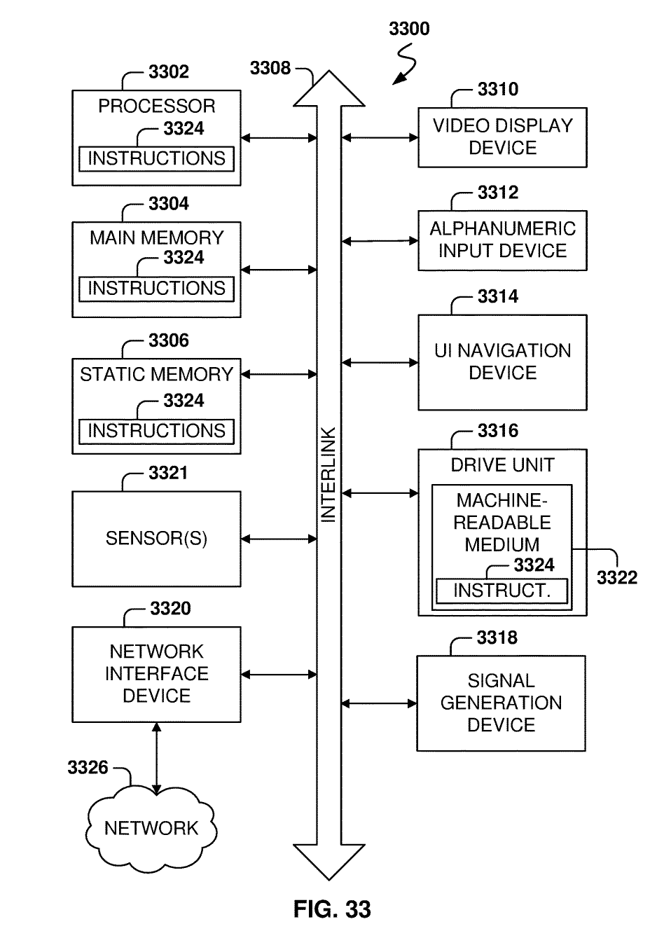

FIG. 33 is a block diagram of a machine in the example form of a computer system 3300 within which instructions 3324 may be executed for causing the machine to perform any one or more of the methodologies discussed herein, according to some embodiments. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 3300 includes a processor 3302 (e.g., a central processing unit (CPU), a graphics processing unit (GPU), or both), a main memory 3304, and a static memory 3306, which communicate with each other via a bus 3308. Computer system 3300 may further include a video display device 3310 (e.g., a liquid crystal display (LCD) or a cathode ray tube (CRT)). Computer system 3300 also includes an alphanumeric input device 3312 (e.g., a discrete keyboard or keyboard implemented using a touch screen of the video display device 3310), a user interface navigation device 3314 (e.g., a mouse or touch sensitive display), a disk drive unit 3316, a signal generation device 3318 (e.g., a speaker), and a network interface device 3320.

Disk drive unit 3316 includes a non-transitory machine-readable storage medium 3322 on which is stored one or more sets of instructions 3324 and data structures (e.g., software, processor executable instructions, etc.) embodying or utilized by any one or more of the methodologies or functions described herein. Instructions 3324 may also reside, completely or at least partially, within main memory 3304, within static memory 3306, and/or within processor 3302 during execution thereof by computer system 3300, main memory 3304 and processor 3302 also constituting machine-readable media.

While non-transitory machine-readable storage medium 3322 is shown in an example embodiment to be a single medium, the term “machine-readable medium” may include a single medium or multiple media (e.g., a centralized or distributed database, and/or associated caches and servers) that store the one or more instructions (e.g., instructions 3324) or data structures. The term “non-transitory machine-readable storage medium” shall also be taken to include any tangible medium that is capable of storing, encoding or carrying instructions for execution by the machine and that cause the machine to perform any one or more of the methodologies of the present technology, or that is capable of storing, encoding or carrying data structures utilized by or associated with such instructions. The term “non-transitory machine-readable storage medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

Instructions 3324 may further be transmitted or received over a communications network 3326 using a transmission medium. Instructions 3324 may be transmitted using network interface device 3320 and any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., WiFi and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the technology. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method, comprising:
accessing, by one or more processors of an action history system and via a network connection, data stored on a database, the data comprising transactions exchanged between a set of entities;
generating, by the action history system, a set of performance values for each entity based on the data;
for each entity of the set of entities, generating an action score based on at least one performance value of the set of performance values, the action score being an indication of performance of the entity with respect to the set of performance values;
receiving a request, from a user, for one or more action probabilities regarding an event associated with a first entity, each action probability being a probability that a second entity responds to the event associated with the first entity within a predetermined time frame;
automatically determining related entities associated with the event;
automatically determining the action probability for each entity of the related entities, the action probability being determined based on the action score of the related entity; and
automatically causing presentation of the action probabilities within a graphical user interface (GUI) of a display device.

2. The method of claim 1, wherein generating the action score for the first entity further comprises:
tracking the transactions of the first entity with other entities;
evaluating a performance of the first entity with reference to the event based on the transactions of the first entity with other entities; and
calculating the action score for the event based on the evaluated performance.

3. The method of claim 2, wherein the action score is a network predictive cashflow (NPC), wherein the transactions include payments made by the other entities, wherein evaluating the performance comprises analyzing a history of payments by the other entities, wherein calculating the NPC comprises predicting a cash flow for the first entity for a predetermined time period based on the history of payments of the other entities.

4. The method of claim 2, wherein tracking the transactions of the first entity further comprises accessing, from an accounting platform providing accounting services, accounting data of the first entity, wherein evaluating the performance further comprises accessing, from the accounting platform providing accounting services, accounting data of the other entities.

5. The method of claim 1, wherein causing presentation of the action probabilities further comprises:
identifying groups of related entities based on values of the action probabilities; and
presenting the action probabilities according to the identified groups.

6. The method of claim 1, further comprising:
receiving a request from an institution for the action score of the first entity; and
transmitting the action score to the institution, wherein the institution determines granting a loan to the first entity based on the action score of the first entity.

7. The method of claim 1, further comprising:
calculating a second action score for the first entity based on a second event; and
calculating a third action score for the first entity based on the action score and the second action score.

8. The method of claim 1, further comprising:
generating a response recommendation based on the action probabilities; and
causing presentation of the response recommendation in the GUI.

9. The method of claim 1, wherein the transactions include a respective time deadline.

10. A system comprising:
a memory comprising instructions; and
one or more computer processors, wherein the instructions, when executed by the one or more computer processors, cause the one or more computer processors to perform operations comprising:
accessing, by an action history system via a network connection, data stored on a database, the data comprising transactions exchanged between a set of entities;
generating, by the action history system, a set of performance values for each entity based on the data;
for each entity of the set of entities, generating an action score based on at least one performance value of the set of performance values, the action score being an indication of performance of the entity with respect to the set of performance values;
receiving a request, from a user, for one or more action probabilities regarding an event associated with a first entity, each action probability being a probability that a second entity responds to the event associated with the first entity within a predetermined time frame;
automatically determining related entities associated with the event;
automatically determining the action probability for each entity of the related entities, the action probability being determined based on the action score of the related entity; and
automatically causing presentation of the action probabilities within a graphical user interface (GUI) of a display device.

11. The system as recited in claim 10, wherein generating the action score for the first entity further comprises:
tracking the transactions of the first entity with other entities;
evaluating a performance of the first entity with reference to the event based on the transactions of the first entity with other entities; and
calculating the action score for the event based on the evaluated performance.

12. The system as recited in claim 11, wherein the action score is a network predictive cashflow (NPC), wherein the transactions include payments made by the other entities, wherein evaluating the performance comprises analyzing a history of payments by the other entities, wherein calculating the NPC comprises predicting a cash flow for the first entity for a predetermined time period based on the history of payments of the other entities.

13. The system as recited in claim 11, wherein tracking the transactions of the first entity further comprises accessing, from an accounting platform providing accounting services, accounting data of the first entity, wherein evaluating the performance further comprises accessing, from the accounting platform providing accounting services, accounting data of the other entities.

14. The system as recited in claim 10, wherein causing presentation of the action probabilities further comprises:
identifying groups of related entities based on values of the action probabilities; and
presenting the action probabilities according to the identified groups.

15. The system as recited in claim 10, wherein the instructions further cause the one or more computer processors to perform operations comprising:
receiving a request from an institution for the action score of the first entity; and
transmitting the action score to the institution, wherein the institution determines granting a loan to the first entity based on the action score of the first entity.

16. A non-transitory machine-readable storage medium including instructions that, when executed by a machine, cause the machine to perform operations comprising:
accessing, by an action history system via a network connection, data stored on a database, the data comprising transactions exchanged between a set of entities;
generating, by the action history system, a set of performance values for each entity based on the data;
for each entity of the set of entities, generating an action score based on at least one performance value of the set of performance values, the action score being an indication of performance of the entity with respect to the set of performance values;
receiving a request, from a user, for one or more action probabilities regarding an event associated with a first entity, each action probability being a probability that a second entity responds to the event associated with the first entity within a predetermined time frame;
automatically determining related entities associated with the event;
automatically determining the action probability for each entity of the related entities, the action probability being determined based on the action score of the related entity; and
automatically causing presentation of the action probabilities within a graphical user interface (GUI) of a display device.

17. The machine-readable storage medium as recited in claim 16, wherein generating the action score for the first entity further comprises:
tracking the transactions of the first entity with other entities;
evaluating a performance of the first entity with reference to the event based on the transactions of the first entity with other entities; and
calculating the action score for the event based on the evaluated performance.

18. The machine-readable storage medium as recited in claim 17, wherein the action score is a network predictive cashflow (NPC), wherein the transactions include payments made by the other entities, wherein evaluating the performance comprises analyzing a history of payments by the other entities, wherein calculating the NPC comprises predicting a cash flow for the first entity for a predetermined time period based on the history of payments of the other entities.

19. The machine-readable storage medium as recited in claim 17, wherein tracking the transactions of the first entity further comprises accessing, from an accounting platform providing accounting services, accounting data of the first entity, wherein evaluating the performance further comprises accessing, from the accounting platform providing accounting services, accounting data of the other entities.

20. The machine-readable storage medium as recited in claim 16, wherein causing presentation of the action probabilities further comprises:
identifying groups of related entities based on values of the action probabilities; and
presenting the action probabilities according to the identified groups.
